(19) United States
(12) Patent Application Publication
(10) Pub. No.: US 2007/0243370 A1
(43) Pub. Date: Oct. 18, 2007

(54) Optical film, polarizing plate and image display device

(75) Inventors: Daiki Wakizaka, Minami-Ashigara-shi (JP); Hiroyuki Yoneyama, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/730,894

(22) Filed: Apr. 4, 2007

(30) Foreign Application Priority Data
Apr. 5, 2006 (JP) 2006-104093

(51) Int. Cl. B32B 5/16; B32B 27/30; B32B 27/18

(52) U.S. Cl. 428/313.3; 428/323; 428/421; 428/522; 428/447

(57) ABSTRACT

An optical film including a support and a layer provided by applying a coating composition as an outermost layer, wherein the coating composition contains a fluorine-containing compound having a fluorine content of 40% by weight or more, and a particle having a particle size of from 5 to 120 nm, and the outermost layer has a refractive index of from 1.20 to 1.38.

### FIELD OF THE INVENTION

The present invention relates to an optical film, a polarizing plate using the optical film, and an image display device using the optical film or the polarizing plate.

### BACKGROUND OF THE INVENTION

In an image display device such as cathode ray tube display (CRT), plasma display panel (PDP), electroluminescent display (ELD) and liquid crystal display (LCD), an optical film, particularly, an antireflection film is generally disposed on the outermost surface of the display so as to reduce the reflectance by utilizing the principle of optical interference and thereby prevent the reduction in contrast due to reflection of outside light or prevent the reflection of an image.

The antireflection film can be produced by forming, on a support, a low refractive index layer having a refractive index lower than that of the support to have an appropriate thickness. In order to realize a low reflectance, a material having a refractive index as low as possible is preferably used for the low refractive index layer. Also, the antireflection film is used on the outermost surface of a display and therefore, required to have high scratch resistance. For realizing high scratch resistance in a thin film with a thickness of around 100 nm, strength of the film itself and firm adhesion to the underlying layer are necessary. Furthermore, since the antireflection film is used on the outermost surface of a display device, it is demanded that this film has resistance against attachment of various stains including a fingerprint in exhibition or daily use and even when stained, exhibits excellent stain wiping property (hereinafter both properties are collectively referred to as an antifouling property).

For reducing the refractive index of a material, a method of introducing a fluorine atom has been heretofore known and a technique using a fluorine-containing crosslinking material has been proposed (see, JP-A-8-92323 (the term “JP-A” as used herein means an “unexamined published Japanese patent application”), JP-A-2003-222702 and JP-A-2003-26732). Also, from the standpoint of satisfying both low refractive index and scratch resistance, an attempt to use a hollow silica particle has been made. With respect to the antireflection performance, in JP-A-8-92323, JP-A-2003-222702 and JP-A-2003-26732, a fluorine-containing compound having a high fluorine content is used. However, use of a crosslinking material having a high fluorine content tends to incur decrease of the coating strength or adhesion at the interface and in turn, decrease of the scratch resistance. In particular, when the film is stored for a long time, the scratch resistance is sometimes worsened. Furthermore, despite the increased fluorine content, the antifouling property is also sometimes worsened and this tendency is prominent particularly when a fluorine-containing compound having a high fluorine content and a hollow silica particle are used in combination. In this way, it is difficult to decrease the refractive index and at the same time, satisfy the scratch resistance, scratch resistance after long-term storage and antifouling property. Improvement of these properties is demanded.

### SUMMARY OF THE INVENTION

One aspect of the present invention is to provide an optical film (preferably antireflection film) using a material with a high fluorine content so as to more reduce the refractive index of the low refractive index layer and being excellent in properties of low reflectance, scratch resistance and marker wiping durability. Another aspect of the present invention is to provide an optical film (preferably antireflection film) using a material with a high fluorine content and exhibiting good stability without worsening the scratch resistance when stored for a long time. Still another aspect of the present invention is to provide a polarizing plate and an image display device each using such an optical film.

As a result of intensive studies to solve those problems, the present inventors have found that the problems can be solved and the above-described objects can be attained by the following constitutions. The present invention has been accomplished based on this finding. That is, those objects of the present invention have been attained by the following constitutions.

(1) An optical film comprising a support having thereon, as an outermost layer, a layer provided by applying a coating composition, wherein the coating composition comprises (A) a fluorine-containing compound having a fluorine content of 40% by mass (% by weight) or more and (B) a fine particle having a particle size of 5 to 120 nm, and the refractive index of the outermost layer is from 1.20 to 1.38.

(2) The optical film as described in 1 above, wherein the (A) has a hydroxyl group.

(3) The optical film as described in 1 or 2 above, wherein the (A) has a (meth)acrylate group.

(4) The optical film as described in any one of 1 to 3 above, wherein the fluorine content of the (A) is 45% by mass or more.

(5) The optical film as described in 1 to 4 above, wherein at least one species out of the particles of the (B) is a fine particle of 40 to 100 nm.

(6) The optical film as described in any one of 1 to 5 above, wherein at least one particle out of the particles of the (B) has a refractive index of 1.15 to 1.30.

(7) The optical film as described in any one of 1 to 6 above, wherein at least one species out of the particles of the (B) is a particle having a void in the inside.

(8) The optical film as described in any one of 1 to 7 above, wherein the coating composition further comprises, as a component (C), a compound having a (meth)acryloyl group.

(9) The optical film as described in 8 above, wherein the (C) has a plurality of (meth)acryloyl groups within one molecule.

(10) The optical film as described in 8 or 9 above, wherein the (C) has an organosiloxane structure.

(11) The optical film as described in any one of 8 to 10 above, wherein the (C) has fluorine.

(12) The optical film as described in any one of 1 to 11 above, wherein the coating composition further comprises (D) a compound containing, within one molecule, a plurality of functional groups capable of forming a chemical bond with the (A) fluorine-containing compound.

(13) The optical film as described in 12 above, wherein the (D) is aminoplasts.

(14) The optical film as described in any one of 1 to 13 above, wherein the coating composition further comprises (E) a polymerization initiator.

(15) The optical film as described in 14 above, wherein the molecular weight of the (E) polymerization initiator is 280 or more.

(16) The optical film as described in any one of 1 to 15 above, wherein the refractive index of the outermost layer is from 1.20 to 1.35.

(17) The optical film as described in any one of 1 to 16 above, wherein the surface haze value of the optical film is 10% or less.

(18) A polarizing plate comprising a polarizing film and protective films provided on both sides of the polarizing film above, wherein at least one of the protective films is the optical film described in any one of 1 to 17.

(19) An image display device having the optical film described in any one of 1 to 17 above or the polarizing plate described in 18 above.

In the optical film of the present invention, a fluorine-containing compound having a fluorine content of 40% or more and a fine particle having a specific particle size are used, whereby an optical film having a low refractive index and at the same time, being improved in the scratch resistance can be provided. In a certain embodiment, the optical film of the present invention is improved in the film strength and the reduction of adhesion at the interface and excellent in both the scratch resistance and the long-term storability. The polarizing plate using the optical film of the present invention is assured of low reflectance and excellent scratch resistance. Furthermore, the display device comprising the optical film or polarizing plate of the present invention is reduced in the reflection of outside light or scenery and assured of remarkably high visibility and excellent scratch resistance.

### DETAILED DESCRIPTION OF THE INVENTION

The present invention is described in detail below. Incidentally, the term “from (numerical value 1) to (numerical value 2)” as used in the present invention for expressing a physical value, a characteristic value or the like means “(numerical value 1) or more and (numerical value 2) or less”. Also, the term “(meth)acrylate” as used in the present invention means “at least either acrylate or methacrylate”. The same applies to “(meth)acrylic acid” and the like.

In one aspect, the present invention is an optical film comprising a support having thereon, as an outermost layer, a layer provided by applying a coating composition comprising the following (A) and (B) (in the specification, sometimes referred to as the “film of the present invention” or the “optical film of the present invention”), wherein the refractive index of the outermost layer is from 1.20 to 1.38:

(A) a fluorine-containing compound having a fluorine content of 40% or more, and

(B) a fine particle having a particle size of 5 to 120 nm.

### 1. Constituent Components Used in Low Refractive Index Layer of the Present Invention

### 1-(1) Compound having a Fluorine Content of 40% or More [Sonstituent Component (A) of the Low Refractive Index Layer of the Present Invention]

In the present invention, the compound having a fluorine content (mass %) of 40% or more is not particularly limited in its structure as long as it contains a reactive functional group and the coating composition prepared using the compound can form a low refractive index layer. From the standpoint of forming the layer without causing volatilization at the coating and curing, the molecular weight is preferably from 300 to 300,000.

In the present invention, the fluorine content of the fluorine-containing compound used as the component (A) is from 40 to 65 mass %, preferably from 45 to 65 mass %, more preferably from 50 to 65 mass %. If the fluorine content is less than 40 mass %, the desired reduction of refractive index may not be achieved. It is preferable that it is not more than 65 mass % in view of the solubility in general-purpose solvents. The fluorine-containing compound used as the component (A) is not particularly limited, but a polyfunctional polymer having a molecular weight of 1,000 or more is preferred. The refractive index of the fluorine-containing polymer is preferably from 1.34 to 1.40, more preferably from 1.35 to 1.38, and most preferably from 1.35 to 1.37. The fluorine-containing polymer is described in detail below.

In the coating composition of the present invention, the components (A) and (B) are preferably contained such that the component (A) accounts for 5 to 75 mass % and the component (B) accounts for 25 to 80 mass %, based on the entire amount of the coating composition. When the amount of the component (A) is in this range, a coating solution excellent in stability and solubility can be prepared. Also, if the content of the component (B) is less than 25 mass %, the effects of the present invention can be hardly obtained, whereas if it exceeds 90 mass %, the coating quality is greatly deteriorated due to generation of an aggregate or the like at the coating and this is not preferred.

### [Fluorine-Containing Polymer]

The fluorine-containing polymer which can be used in the present invention include those having the following structure.

(MF1)a-(MF2)b-(MF3)c-(MA)d-(MB)e Formula 1

In formula 1, a to e are the molar fraction of respective constituent components and each represents a value satisfying the relationships of 30≦a+b≦70, 0≦c≦50, 5<d≦50 and 0≦e≦20.

In formula 1, (MF1) represents a constituent component polymerized from a monomer represented by the following formula [1-1]:

(CF₂═CF—Rf1) Formula [1-1]

wherein Rf1 represents a perfluoroalkyl group having a carbon number of 1 to 5.

(MF2) represents a constituent component polymerized from a monomer represented by the following formula [1-2]:

(CF₂═CF—ORf12) Formula [1-2]

wherein Rf12 represents a fluorine-containing alkyl group having a carbon number of 1 to 30.

(MF3) represents a constituent component polymerized from a monomer represented by the following formula [1-3]:

(CH₂═CH—ORf13) Formula [1-3]

wherein Rf13 represents a fluorine-containing alkyl group having a carbon number of 1 to 30.

(MA) represents a constituent component containing at least one or more reactive group capable of participating in the crosslinking reaction. (MB) represents an optional constituent component.

Each constituent component of formula 1 is described in detail below.

(CF₂═CF—Rf1) Formula [1-1]

wherein Rf1 represents a perfluoroalkyl group having a carbon number of 1 to 5. The compound of formula [1-1] is preferably perfluoropropylene or perfluorobutylene in view of polymerization reactivity, more preferably perfluoropropylene in view of availability.

(CF₂═CF—ORf12) Formula [1-2]

wherein Rf12 represents a fluorine-containing alkyl group having a carbon number of 1 to 30 and is preferably a fluorine-containing alkyl group having a carbon number of 1 to 20, more preferably from 1 to 10. A perfluoroalkyl group having a carbon number of 1 to 10 is still more preferred. The alkyl fluoride group may have a substituent. Specific examples of Rf12 include:

—CF₃ {M2-(1)},

—CF₂CF₃ {M2-(2)},

—CF₂CF₂CF₃ {M2-(3)}, and

—CF₂CF(OCF₂CF₂CF₃)CF₃ {M2-(4)}.

(CH₂═CH—ORf13) Formula [1-3]

wherein Rf13 represents a fluorine-containing alkyl group having a carbon number of 1 to 30 and is preferably a fluorine-containing alkyl group from 1 to 20, more preferably from 1 to 15, which may be linear {e.g., —CF₂CF₃, —CH₂(CF₂)ₐH, —CH₂CH₂(CF₂)ₐF (wherein a is an integer of 2 to 12)}, may have a branched structure {e.g., CH(CF₃)₂, CH₂CF(CF₃)₂, —CH(CH₃)CF₂CF₃, —CH(CH₃)(CF₂)₅CF₂H} or an alicyclic structure (preferably a 5- or 6-membered ring, for example, a perfluorocyclohexyl group, a perfluorocyclopentyl group or an alkyl group substituted by such a group), or may have an ether bond (e.g., —CH₂OCH₂CF₂CF₃, —CH₂CH₂OCH₂(CF₂)_{b}H, —CH₂CH₂OCH₂(CF₂)_{b}F (wherein b is an integer of 2 to 12), CH₂CH₂OCF₂CF₂OCF₂CF₂H). Incidentally, the substituent represented by Rf13 is not limited to these substituents.

The monomer represented by formula [1-3] can be synthesized, for example, by a method of causing a fluorine-containing alcohol to act on leaving group-substituted alkyl vinyl ethers (e.g., vinyloxyalkyl sulfonate, vinyloxyalkyl chloride) in the presence of a base catalyst described in Macromolecules, Vol. 32 (21), page 7122 (1999) and JP-A-2-721; a method of mixing a fluorine-containing alcohol with vinyl ethers (e.g., butyl vinyl ether) in the presence of a palladium catalyst, thereby effecting exchange of the vinyl group described in International Application No. 92/05135, pamphlet; or a method of reacting fluorine-containing ketone with dibromoethane in the presence of a potassium fluoride catalyst and then performing an HBr-removing reaction with use of an alkali catalyst described in U.S. Pat. No. 3,420,793.

Preferred examples of the constituent component represented by formula [1-3] are set forth below, but the present invention is not limited thereto.

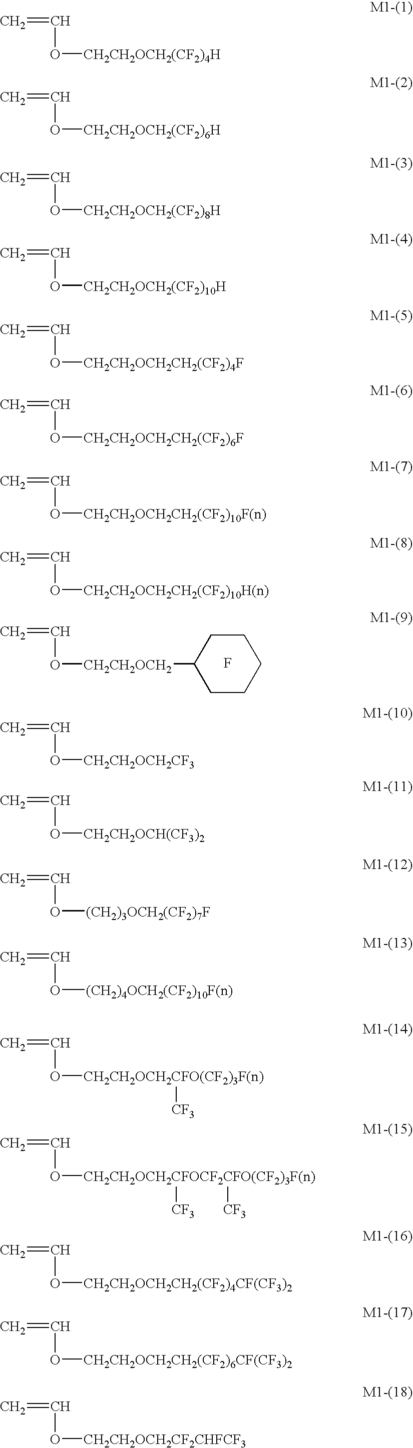

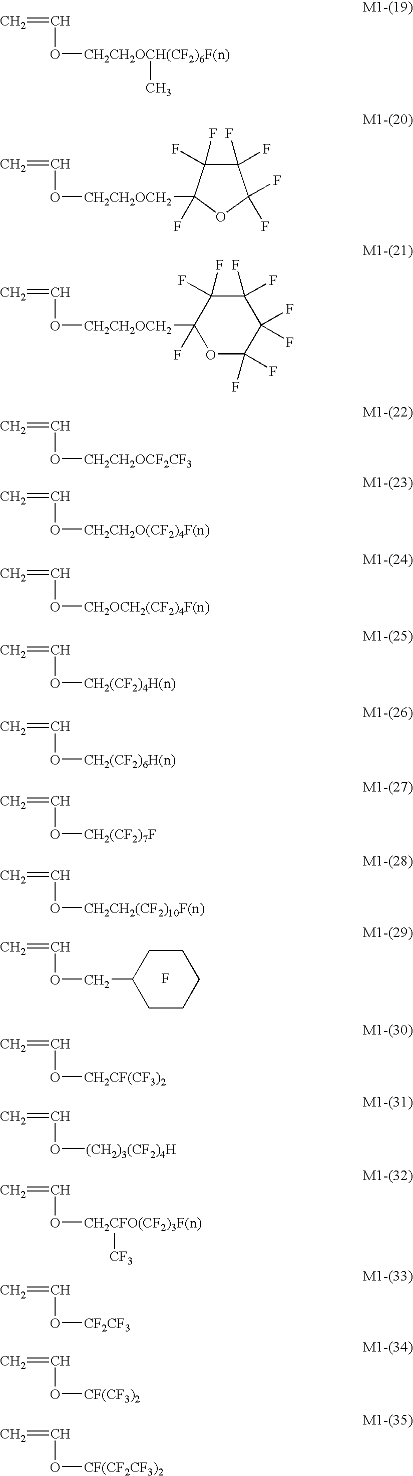

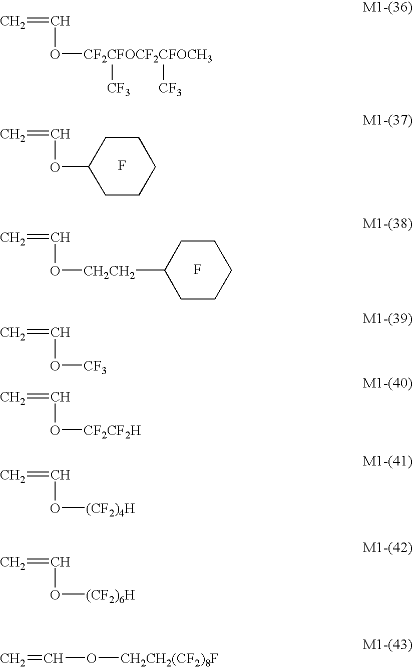

In formula 1, (MA) represents a constituent component containing at least one or more reactive group capable of participating in a crosslinking reaction. Examples of the reactive group capable of participating in a crosslinking reaction include a silyl group having a hydroxyl group or a hydrolyzable group, such as alkoxysilyl group and acyloxysilyl group; a group having a reactive unsaturated double bond, such as (meth)acryloyl group, allyl group and vinyloxy group; a ring-opening polymerization reactive group such as epoxy group, oxetanyl group and oxazolyl group; a group having an active hydrogen atom, such as hydroxyl group, carboxyl group, amino group, carbamoyl group, mercapto group, β-ketoester group, hydrosilyl group and silanol group; and a group capable of being substituted by an acid anhydride or a nucleophilic agent, such as active halogen atom and sulfonic acid ester.

Among these reactive groups, preferred is a group having polymerization activity by itself, more preferred are a hydrolyzable silyl group, a group having a reactive unsaturated double bond, and a ring-opening polymerization reactive group, and still more preferred are a hydrolyzable silyl group, a (meth)acryloyl group, an allyl group and an epoxy group. The particularly preferred embodiment of (MA) includes formulae 4 to 8.

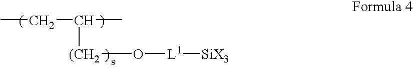

In formula 4, L¹ represents an alkylene group having a carbon number of 1 to 20, which may have a substituent (for example, an alkyl group, an alkoxy group or a halogen atom) or may have an aliphatic ring structure (for example, a cyclohexane ring), and is preferably an alkylene group having a carbon number of 1 to 5, more preferably an ethylene group or a propylene group. s represents 0 or 1 and in view of polymerization reactivity, s is preferably 0. X represents a hydroxyl group or a hydrolyzable group (for example, an alkoxy group such as methoxy group and ethoxy group, a halogen atom such as chloro and bromo, or an acyloxy group such as acetoxy group and phenoxy group) and is preferably a methoxy group or an ethoxy group. The constituent component represented by formula 4 can be synthesized, for example, by a method using a hydrosilylation reaction as described in JP-A-48-62726.

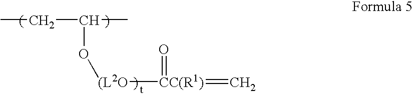

In formula 5, L² represents an alkylene group having a carbon number of 1 to 20, which may have a substituent (for example, an alkyl group, an alkoxy group or a halogen atom) or may have an aliphatic ring structure (for example, a cyclohexane ring), and is preferably an alkylene group having a carbon number of 1 to 10, more preferably an alkylene group having a carbon number of 2 to 5. t represents 0 or 1, and t is preferably 1. R¹ represents a hydrogen atom or a methyl group and is preferably a hydrogen atom. The unsaturated double bond in formula 5 may be introduced, for example, by a method of synthesizing a polymer having a hydroxyl group and causing an acid halide (e.g., (meth)acrylic acid chloride) or an acid anhydride (e.g., (meth)acrylic anhydride) to act thereon, or may be formed in a usual manner, for example, by polymerizing a vinyl monomer having a 3-chloropropionic acid ester moiety and then performing dehydrochlorination.

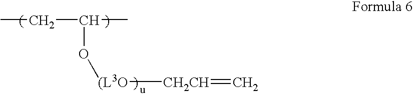

In formula 6, L³ and u have the same meanings respectively as L² and t in formula 5. The allyl group in the constituent component represented by formula 5 may be introduced, for example, similarly to the constituent component of formula 5, by a method of synthesizing a polymer having a hydroxyl group and then causing an allyl halide to act thereon.

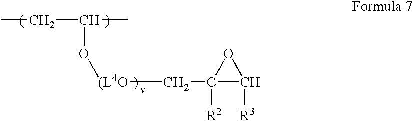

In formula 7, L⁴ has the same meaning as L² in formula 5. v represents 0 or 1. R² and R³ each represents a hydrogen atom or a methyl group and is preferably a hydrogen atom. The constituent component represented by formula 7 can be obtained by polymerizing an epoxy group-containing vinyl ether which is synthesized, for example, by a method of causing an epoxy compound (e.g., epichlorohydrin) to act on a vinyl ether having a hydroxyl group or a method of causing glycidol to act on butyl vinyl ether in the presence of a catalyst and thereby effecting transetherification.

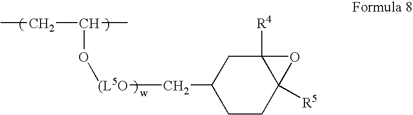

In formula 8, L⁵, w, R⁴ and R⁵ have the same meanings respectively as L⁴, v, R² and R³ in formula 7. The constituent component represented by formula 8 can also be synthesized in the same manner as the constituent component represented by formula 7.

A functional group other than those described above as preferred examples of the constituent component (MA) may be introduced during the monomer stage or after synthesizing a polymer having a reactive group such as hydroxyl group.

Preferred examples of the constituent component (MA) in the polymer represented by formula 1 are set forth below, but the present invention is not limited thereto.

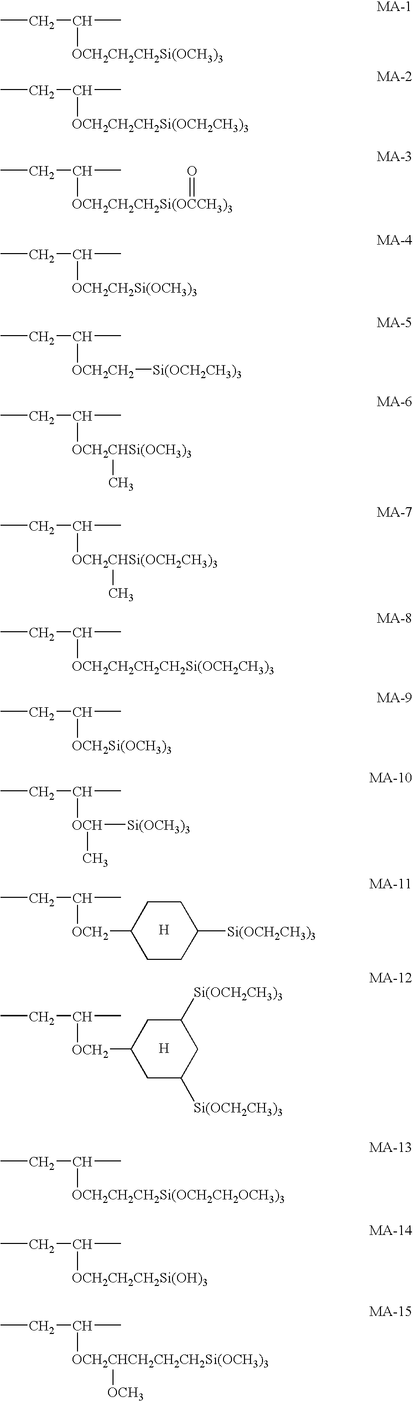

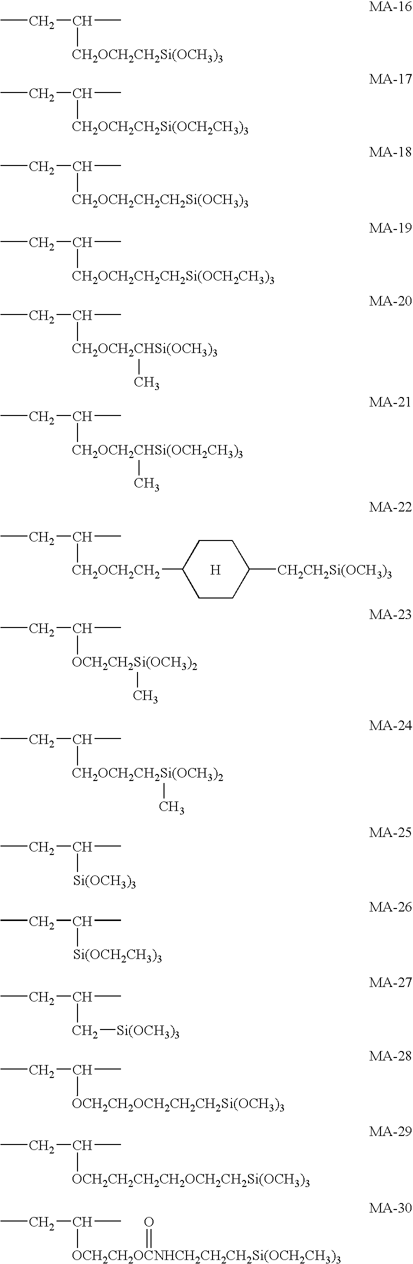

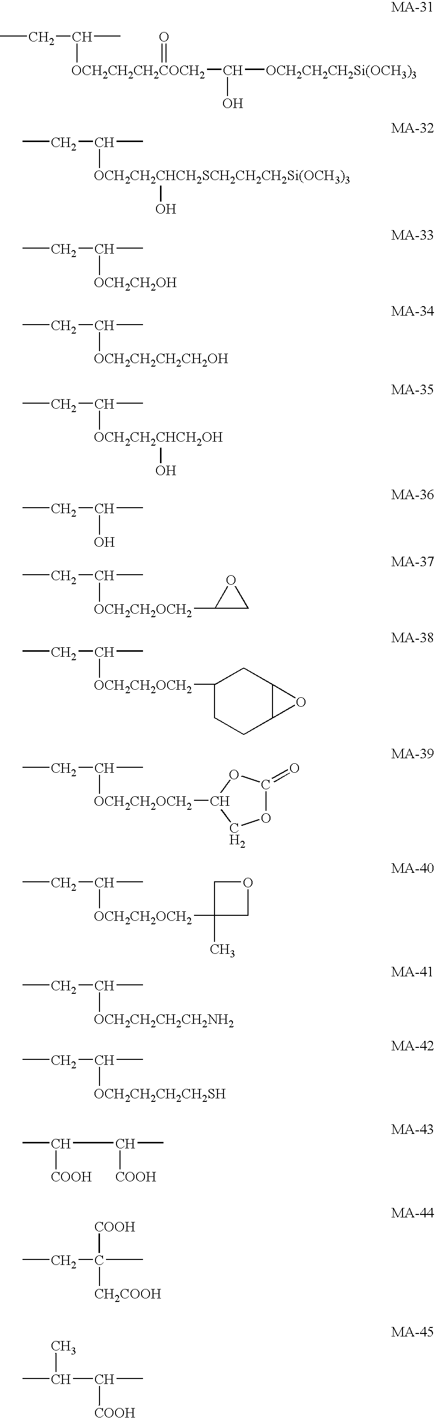

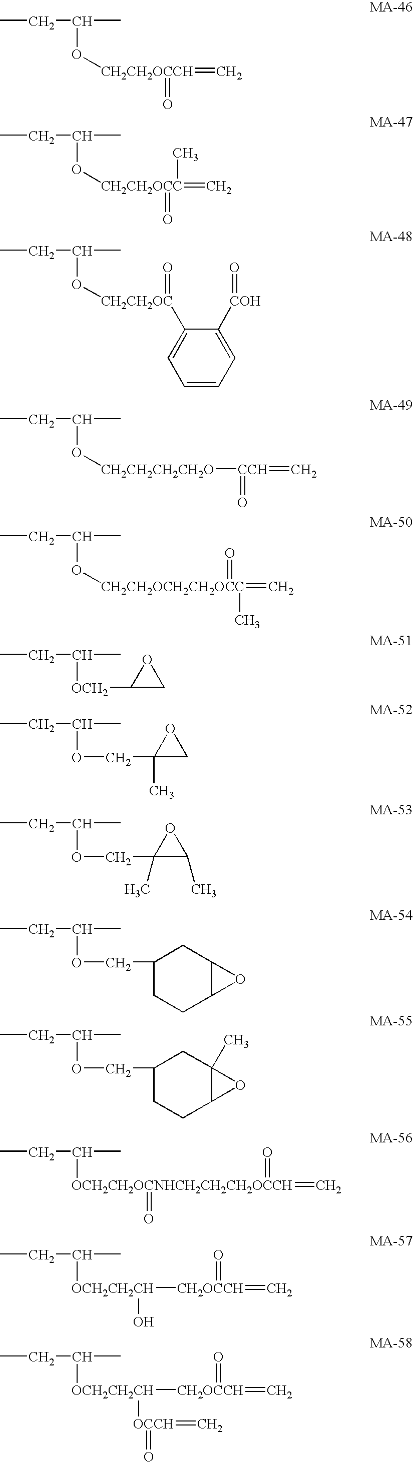

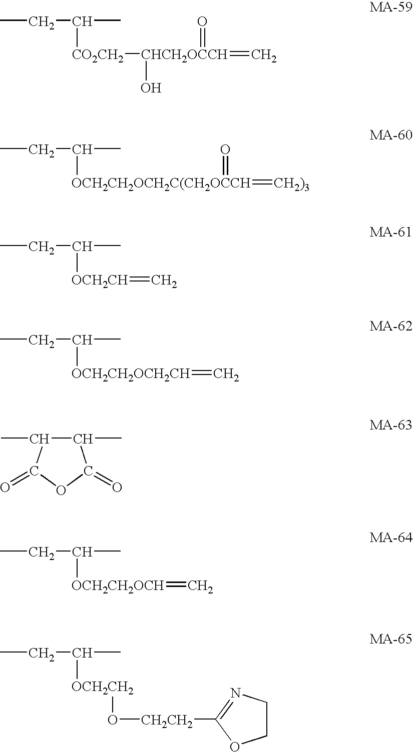

In formula 1, (MB) represents an optional constituent component and is not particularly limited as long as it is a constituent component monomer copolymerizable with the monomers represented by (MF1) and (MF2) and the monomer forming the constituent component represented by (MA). This constituent component may be appropriately selected from various standpoints such as adhesion to substrate, Tg (contributing to film hardness) of polymer, solubility in solvent, transparency, slipperiness, dust protection and antifouling property.

Examples thereof include vinyl ethers such as methyl vinyl ether, ethyl vinyl ether, n-butyl vinyl ether, cyclohexyl vinyl ether and isopropyl vinyl ether; and vinyl esters such as vinyl acetate, vinyl propionate, vinyl butyrate and vinyl cyclohexanecarboxylate.

Particularly, in view of slipperiness and antifouling property, the component represented by (MB) preferably uses a constituent unit having a polysiloxane structure described below.

### (Constituent Unit Having Polysiloxane Structure)

A polysiloxane repeating unit represented by the following formula 2 may be contained in the main or side chain.

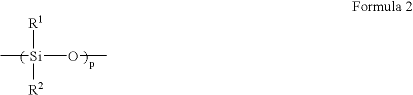

In the formula, R¹ and R² may be the same or different and each represents an alkyl group or an aryl group. The alkyl group is preferably an alkyl group having a carbon number of 1 to 4, and examples thereof include a methyl group, a trifluoromethyl group and an ethyl group. The aryl group is preferably an aryl group having a carbon number of 6 to 20, and examples thereof include a phenyl group and a naphthyl group. Among these, a methyl group and a phenyl group are preferred, and a methyl group is more preferred. p represents an integer of 2 to 500 and is preferably an integer of 5 to 350, more preferably from 8 to 250.

The polymer having a polysiloxane structure represented by formula 2 in the side chain can be synthesized by a method of introducing a polysiloxane (for example, Silaplane Series (produced by Chisso Corp.)) having, at one terminal, a corresponding reactive group (for example, an amino group, a mercapto group, a carboxyl group or a hydroxyl group for an epoxy group or an acid anhydride group) into a polymer having a reactive group such as epoxy group, hydroxyl group, carboxyl group or acid anhydride group, through a polymer reaction described, for example, in J. Appl. Polym. Sci., 2000, 78 (1955) and JP-A-56-28219; or a method of polymerizing a polysiloxane-containing silicon macromer. Either method may be preferably used.

The method for introducing a polysiloxane partial structure into the main chain is not particularly limited and examples thereof include a method using a polymer-type initiator such as azo group-containing polysiloxane amide (as the commercial product, VPS-0501 and VPS-1001 (trade names, produced by Wako Pure Chemicals Industries, Ltd.)) described in JP-A-6-93 100, a method of introducing a polymerization initiator and a chain transfer agent-derived reactive group (e.g., mercapto group, carboxyl group, hydroxyl group) into the polymer terminal and reacting it with a polysiloxane containing a reactive group (e.g., epoxy group, isocyanate group) at one terminal or both terminals, and a method of copolymerizing a cyclic cyclohexane oligomer such as hexamethylcyclotrisiloxane by anionic ring-opening polymerization. Among these, a method using an initiator having a polysiloxane partial structure is easy and preferred.

In view of reducing the refractive index, it is also preferred that the component represented by (MB) is a fluoro-cycloalkyl group-containing block copolymer unit described in JP-A-2005-76006.

In formula 1, a to e are the molar fraction of respective constituent components and each represents a value satisfying the relationships of 30≦a+b≦70, 0≦c≦50, 5<d<50 and 0≦e≦20. For reducing the refractive index of a material, it is preferred to increase the molar fraction (%) a+b of the (MF1) and (MF2) components, but in view of polymerization reactivity, introduction to a molar fraction of approximately from 50 to 70% is limit in the general solution-type radical polymerization reaction and a higher molar fraction is difficult. In the present invention, a+b is preferably 40% or more, more preferably 45% or more.

In the present invention, in addition to the (MF1) and (MF2) components, an (MF3) component is introduced as means for reducing the refractive index. The molar fraction c of the (MF3) component is preferably in the range of 10≦c≦50, more preferably 20≦c≦40. Also, the sum of molar fractions of these fluorine-containing monomer components is preferably in the range of 60≦a+b+c≦90, more preferably 60≦a+b≦75.

If the proportion of the polymer unit represented by (MA) is too small, the strength of the cured film becomes weak. In the present invention, the molar fraction of the (MA) component is preferably in the range of 5≦d≦40, more preferably 15≦d≦30.

The molar fraction (%) e of the optional constituent component represented by (MB) is preferably in the range of 0≦e≦20, more preferably 0≦d≦10%.

The number average molecular weight of the fluorine-containing polymer used for forming the low refractive index layer in the present invention is preferably from 1,000 to 1,000,000, more preferably from 5,000 to 500,000, still more preferably from 10,000 to 100,000.

Here, the number average molecular weight is a molecular weight determined by differential refractometer detection with a solvent THF in a GPC analyzer using a column of TSKgel GMHxL, TSKgel G400HxL or TSKgel G200HxL (trade names, all produced by Tosoh Corp.), and expressed in terms of polystyrene.

The polymer obtained as a reaction solution may be used directly in the usage of the present invention or may be used after purifying it by reprecipitation or liquid separation.

Examples of the polymer represented by formula 1 of the present invention are shown below, but the present invention is not limited thereto. Incidentally, in Table 1, the polymer is denoted by a combination of monomers (MF1), (MF2), (MF3), (MA) and (MB) forming the fluorine-containing constituent components of formula 1 after polymerization. In the Table, a to e show the molar ratio (%) of monomers of respective components. Also, in the Table, “wt %” of the (MB) component indicates the mass % of the component in the entire polymer.

TABLE 1

| | | | | | | | | | | | | Molecular |
|---|---|---|---|---|---|---|---|---|---|---|---|---|
| | | | | | | | | | | | Fluorine | Weight |
| | (MF1) | (MF2) | (MF3) | (MA) | (MB) | a | b | c | d | e | Content | (ten thousand) |
| P-1 | HEP | — | — | (MA-33) | EVE/VPS-1001 | 50 | 0 | 0 | 20 | 30/4 wt % | 47.9 | 3.0 |
| P-2 | HFP | FPVE | — | (MA-33) | EVE/VPS-1001 | 35 | 15 | 0 | 20 | 30/4 wt % | 49.9 | 3.0 |
| P-3 | HFP | — | M1-(43) | (MA-33) | EVE/VPS-1001 | 50 | 0 | 20 | 20 | 10/2 wt % | 60.3 | 2.5 |
| P-4 | HFP | FPVE | M1-(43) | (MA-33) | EVE/VPS-1001 | 35 | 15 | 20 | 25 | 5/2 wt % | 60.4 | 2.5 |
| P-5 | HFP | FPVE | M1-(43) | (MA-33) | EVE/FM-0721 | 35 | 15 | 20 | 25 | 5/2 wt % | 60.4 | 2.5 |
| P-6 | HFP | FPVE | M1-(1) | (MA-33) | EVE/VPS-1001 | 40 | 10 | 20 | 25 | 5/2 wt % | 53.9 | 3.0 |
| P-7 | HFP | FPVE | — | (MA-33) | EVE/VPS-1001/NE-30 | 35 | 15 | 0 | 20 | 30/2 wt %/0.7 wt % | 50.6 | 3.0 |
| P-8 | HFP | FPVE | M1-(43) | (MA-33) | EVE/VPS-1001/NE-30 | 35 | 15 | 20 | 20 | 10/2 wt %/0.7 wt % | 60.2 | 2.3 |
| P-9 | HFP | FPVE | M1-(1) | (MA-33) | EVE/FM-0721/NE-30 | 35 | 15 | 20 | 20 | 10/2 wt %/0.7 wt % | 54.1 | 3.5 |
| P-10 | HFP | FPVE | — | (MA-33) | EVE/NE-30 | 40 | 10 | 0 | 30 | 20/0.7 wt % | 50.4 | 3.5 |
| P-11 | HFP | — | — | (MA-34) | EVE/FM-0721 | 50 | 0 | 0 | 30 | 20/4 wt % | 47.3 | 3.5 |
| P-12 | HFP | FPVE | M1-(43) | (MA-33)/(MA-46) | EVE/VPS-1001 | 35 | 15 | 20 | 2/23 | 10/2 wt % | 57.1 | 3.0 |
| P-13 | HFP | FPVE | M1-(43) | (MA-46) | EVE/VPS-1001 | 35 | 15 | 20 | 25 | 10/2 wt % | 56.8 | 3.5 |
| P-14 | HFP | FPVE | M1-(43) | (MA-56) | EVE/VPS-1001 | 35 | 15 | 20 | 25 | 10/2 wt % | 51.2 | 3.4 |
| P-15 | HFP | FPVE | M1-(1) | (MA-35)/(MA-58) | EVE/VPS-1001 | 35 | 15 | 20 | 2/23 | 10/2 wt % | 51.8 | 3.3 |
| P-16 | HFP | FPVE | M1-(43) | (MA-33)/(MA-46) | EVE/FM-0721 | 35 | 15 | 20 | 2/23 | 10/2 wt % | 57.1 | 3.5 |
| P-17 | HFP | FPVE | M1-(43) | (MA-46) | EVE/FM-0721 | 35 | 15 | 20 | 25 | 10/2 wt % | 56.8 | 3.5 |
| P-18 | HFP | FPVE | M1-(43) | (MA-56) | EVE/FM-0721 | 35 | 15 | 20 | 25 | 10/2 wt % | 51.2 | 3.5 |
| P-19 | HFP | FPVE | M1-(1) | (MA-33)/(MA-46) | EVE/FM-0721/NE-30 | 35 | 15 | 20 | 2/18 | 10/2 wt %/0.7 wt % | 51.3 | 3.0 |
| P-20 | HFP | FPVE | M1-(1) | (MA-46) | EVE/FM-0721/NE-30 | 35 | 15 | 20 | 20 | 10/2 wt %/0.7 wt % | 51.0 | 3.0 |
| P-21 | HFP | FPVE | M1-(1) | (MA-56) | EVE/FM-0721/NE-30 | 35 | 15 | 20 | 20 | 10/2 wt %/0.7 wt % | 46.0 | 4.2 |
| P-22 | HFP | — | — | (MA-56) | EVE/VPS-1001 | 50 | 0 | 0 | 15 | 35/2 wt % | 40.8 | 5.1 |
| P-23 | HFP | FPVE | — | (MA-56) | EVE/VPS-1001 | 40 | 10 | 0 | 15 | 35/2 wt % | 42.7 | 4.5 |
| P-24 | HFP | FPVE | — | (MA-56) | EVE/VPS-1001 | 35 | 15 | 0 | 15 | 35/2 wt % | 43.5 | 3.0 |
| P-25 | HFP | FPVE | M1-(43) | (MA-56) | EVE/VPS-1001 | 40 | 10 | 15 | 15 | 20/2 wt % | 52.5 | 3.5 |
| P-26 | HFP | FPVE | M1-(43) | (MA-56) | EVE/VPS-1001/NE-30 | 40 | 10 | 15 | 15 | 20/2 wt %/0.7 wt % | 52.1 | 4.0 |
| P-27 | HFP | FPVE | M1-(43) | (MA-37) | EVE/VPS-1001 | 35 | 15 | 20 | 25 | 10/2 wt % | 56.7 | 4.0 |

The abbreviations in the Table indicate the followings.
(MF1) component: HFP: hexafluoropropylene
(MF2) component: FPVE: perfluoro(propyl vinyl ether)
(MB) component: EVE: ethyl vinyl ether

VPS-1001 (azo group-containing polydimethylsiloxane, molecular weight of polysiloxane moiety: about 10,000, produced by Wako Pure Chemicals Industries, Ltd.)
FM-0721 (methacryloyl-modified dimethylsiloxane, average molecular weight: 5,000, produced by Chisso Corp.)

NE-30 (reactive nonionic emulsifier, containing an ethylene oxide moiety, produced by Asahi Denka Co., Ltd.)

The polymer represented by formula 1 of the present invention can be synthesized by various polymerization methods such as solution polymerization, suspension polymerization, precipitation polymerization, bulk polymerization and emulsion polymerization. At this time, the synthesis can be performed by a known operation such as batch system, semi-continuous system and continuous system.

Examples of the method for initiating the polymerization include a method using a radical initiator and a method of irradiating light or radiation. These polymerization methods and polymerization-initiating methods are described, for example, in Teiji Tsuruta, Kobunshi Gosei Hoho (Polymer Synthesis Method), revised edition, Nikkan Kogyo Shinbun Sha (1971), and Takayuki Ohtsu and Masaetsu Kinoshita, Kobunshi Gosei no Jikken Ho (Test Method of Polymer Synthesis), pp. 124-154, Kagaku Dojin (1972).

Among those polymerization methods, a solution polymerization method using a radical initiator is preferred. Examples of the solvent for use in the solution polymerization include various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol and 1-butanol, and one of these solvents may be used alone, or a mixture of two or more thereof may be used. A mixed solvent with water may also be used.

The polymerization temperature needs to be set according to the molecular weight of copolymer produced, the kind of initiator, and the like, and a polymerization temperature from 0° C. or less to 100° C. or more may be used, but the polymerization is preferably performed in the range from 50 to 100° C.

The reaction pressure may be appropriately selected but is usually from 1 to 100 kg/cm², preferably on the order of 1 to 30 kg/cm². The reaction time is approximately from 5 to 30 hours.

In the coating composition of the present invention, a curing catalyst, a curing agent and the like may be appropriately blended and a known compound may be used therefor. The coating composition of the present invention comprises a fluorine-containing polymer, a curing catalyst and a solvent and in addition, may contain additives, adjuvants and the like for accelerating the curing or enhancing the performance required in the usage of the polymer.

For example, when the curing reactive moiety in the polymer of formula 1 is a hydrolyzable silyl group, a known acid or base catalyst may be blended as the sol-gel reaction catalyst. Examples thereof include inorganic Brønsted acids such as hydrochloric acid, sulfuric acid and nitric acid; organic Brønsted acids such as oxalic acid, acetic acid, formic acid, methanesulfonic acid and para-toluenesulfonic acid; Lewis acids such as dibutyltin dilaurate, dibutyltin diacetate, dibutyltin dioctate, triisopropoxy aluminum and tetrabutoxy zirconium; inorganic bases such as sodium hydroxide, potassium hydroxide and ammonia; and organic bases such as triethylamine, pyridine and tetramethylethylenediamine. In particular, an acid catalyst is preferred and among acid catalysts, organic Brønsted acids such as para-toluenesulfonic acid and Lewis acids such as dibutyltin dilaurate are preferred.

The amount of such a curing catalyst added is arbitrary depending on the kind of the catalyst or the difference of the curing reactive moiety but in general, the amount added is preferably on the order of 0.1 to 15 mass %, more preferably on the order of 0.5 to 5 mass %, based on the entire solid content of the coating composition.

### 1-(2) Fine Particle [Constituent Component (B) of the Low Refractive Index Layer of the Present Invention]

The fine particle which can be used in the low refractive index layer of the present invention is described below. In the present invention, a fine particle is preferably used in the low refractive index layer so as to reduce the refractive index and improve the scratch resistance. From the standpoint of reducing the refractive index, the fine particle is preferably an organic or inorganic fine particle and preferably an organic or inorganic low-refractive-index fine particle.

As for the size of the fine particle, the average particle size is from 5 to 120 nm, preferably from 10 to 100 nm, more preferably from 40 to 100 nm. Out of the particles of (B), at least one species preferably has a particle size of 40 to 100 nm.

The refractive index of the fine particle is preferably from 1.10 to 1.40, more preferably from 1.15 to 1.35, and most preferably from 1.15 to 1.30. The refractive index used here indicates a refractive index of the particle as a whole. The refractive index of at least one particle out of the fine particles is preferably from 1.15 to 1.30.

The organic (low-refractive-index) fine particle includes a silicone-based particle and a particle having a void in the inside. Examples of the organic fine particle having a vacancy by itself include a porous particle having a polymer layer and a hole-filling layer described in JP-A-2002-256004, in which the hole-filling layer is a fugitive substance, a substitution gas or a combination thereof and the glass transition temperature of the polymer layer is from 10 to 50° C.

It is also preferred to use a hollow organic particle described in JP-A-2005-213366 and JP-A-2005-215315.

The inorganic (low-refractive-index) fine particle includes an inorganic fine particle such as magnesium fluoride and silica. Particularly, in view of refractive index, dispersion stability and cost, a silica fine particle is preferred.

If the particle diameter of the inorganic fine particle is too small, the effect of improving the scratch resistance decreases, whereas if it is excessively large, fine irregularities are generated on the low refractive index layer surface and the appearance (e.g., dense black) or integrated reflectance may be deteriorated. The inorganic fine particle may be crystalline or amorphous and may be a monodisperse particle or may be even an aggregate particle as long as the predetermined particle diameter is satisfied. The shape is most preferably spherical but even if infinite form, there arises no problem.

The amount of the low refractive index particle coated is preferably from 1 to 100 mg/m², more preferably from 5 to 80 mg/m², still more preferably from 10 to 60 mg/m². If the coated amount is too small, the effect of improving the scratch resistance decreases, whereas if it is excessively large, fine irregularities are generated on the low refractive index layer surface and the appearance (e.g., dense black) or integrated reflectance may be deteriorated.

In order to reduce the refractive index, at least one species out of fine particles used is preferably a porous or hollow-structure fine particle. The void percentage of such a particle is preferably from 10 to 80%, more preferably from 20 to 60%, and most preferably from 30 to 60%. The void percentage of the hollow fine particle in the above-described range is preferred from the standpoint of reducing the refractive index and maintaining the durability of the particle.

In the case where the porous or hollow particle is silica, the refractive index of the fine particle is preferably from 1.10 to 1.40, more preferably from 1.15 to 1.35, and most preferably from 1.15 to 1.30. The refractive index used here indicates a refractive index of the particle as a whole and does not indicate a refractive index of only silica in the outer shell forming the silica particle.

The production method of the porous or hollow silica is described, for example, in JP-A-2001-233611 and JP-A-2002-79616. In particular, a particle where a cavity is present inside the shell and pores of the shell are closed is preferred. Incidentally, the refractive index of such a hollow silica particle can be calculated by the method described in JP-A-2002-79616.

The amount of the porous or hollow silica coated is preferably from 1 to 100 mg/m², more preferably from 5 to 80 mg/m², still more preferably from 10 to 60 mg/m². If the coated amount is too small, the effect of reducing the refractive index or improving the scratch resistance decreases, whereas if it is excessively large, fine irregularities are generated on the low refractive index layer surface and the appearance (e.g., dense black) or integrated reflectance may be deteriorated.

The average particle diameter of the porous or hollow silica is preferably from 30 to 150%, more preferably from 35 to 80%, still more preferably from 40 to 60%, of the thickness of the low refractive index layer. In other words, when the thickness of the low refractive index layer is 100 nm, the particle diameter of the hollow silica is preferably from 30 to 150 nm, more preferably from 35 to 100 nm, still more preferably from 40 to 65 nm. In the present invention, the void-containing fine particle may have a size distribution and the coefficient of variation thereof is preferably from 60 to 5%, more preferably from 50 to 10%. Also, two kinds or three or more kinds of particles differing in the average particle size may be mixed and used.

If the particle diameter of the silica fine particle is too small, the proportion of the void part decreases and reduction of the refractive index cannot be expected, whereas if it is excessively large, fine irregularities are generated on the low refractive index layer surface and the appearance (e.g., dense black) or integrated reflectance may be deteriorated. The silica fine particle may be crystalline or amorphous and is preferably a monodisperse particle. The shape is most preferably spherical but even if infinite form, there arises no problem.

Two or more kinds of hollow silica particles differing in the average particle size may be used in combination. The average particle diameter of the hollow silica can be determined from an electron micrograph.

In the present invention, the specific surface area of the hollow silica is preferably from 20 to 300 m²/g, more preferably from 30 to 120 m²/g, and most preferably from 40 to 90 m²/g. The surface area can be determined by the BET method using nitrogen.

In the present invention, a void-free silica particle may be used in combination with the hollow silica. The particle size of the void-free silica is preferably from 30 to 150 nm, more preferably from 35 to 100 nm, and most preferably from 40 to 80 nm.

### [Preparation Method of Porous or Hollow Fine Particle]

A preferred production method of a hollow fine particle is described below. The first stage is the formation of a core particle which can be removed by an after-treatment, the second stage is the formation of a shell layer, the third stage is the dissolution of the core particle, and if desired, the fourth stage is the formation of an additional shell layer. Specifically, the hollow particle can be produced according to the production method of a hollow silica fine particle described, for example, in JP-A-2001-233611.

A preferred production method of the porous particle is a method where in the first stage, a porous core particle is produced by controlling the degree of hydrolysis or condensation of an alkoxide or the kind or amount of the coexisting substance, and in the second stage, a shell layer is formed on the surface of the core particle. Specifically, the porous particle can be produced by the method described, for example, in the publications such as JP-A-2003-327424, JP-A-2003-335515, JP-A-2003-226516 and JP-A-2003-238140.

In the present invention, the adsorbed water amount of the inorganic fine particle, which is described later, is preferably decreased. The adsorbed water amount can be controlled by changing the particle size or shell thickness or selecting the hydrothermal treatment conditions or the like and may also be decreased by firing the particle.

### (Coated Particle)

The adsorbed water amount can be decreased by increasing the shell thickness and thereby decreasing the adsorption site on the particle surface, and this is preferred. Furthermore, when the shell is formed of an electrically conducting component, electrical conductivity can also be advantageously imparted. In particular, a combination using a silica-based porous or hollow particle as the core particle and using ZnO₂, Y₂O₃, Sb₂O₅, ATO, ITO or SnO₂ as the shell is preferred. An antimony oxide-coated silica-based fine particle which is particularly preferred, is described below.

In the antimony oxide-coated silica-based fine particle for use in the present invention, a porous silica-based fine particle or a silica-based fine particle having a cavity in the inside is coated with an antimony oxide coat layer.

The porous silica-based fine particle includes a porous silica fine particle and a composite oxide fine particle mainly comprising silica, and a low-refractive-index nanometer-size composite oxide fine particle obtained by coating the surface of a porous inorganic oxide fine particle with silica or the like disclosed in JP-A-7-133105 can be suitably used.

Also, as for the silica-based fine particle having a cavity in the inside, a low-refractive-index nanometer-size silica-based fine particle comprising silica and an inorganic oxide other than silica and having a cavity in the inside disclosed in JP-A-2001-233611 can also be suitably used.

The porous silica-based fine particle or the silica-based fine particle having a cavity in the inside preferably has an average particle diameter of 4 to 100 nm, more preferably from 10 to 90 nm. When the average particle is 4 nm or more, the silica-based fine particle can be obtained without incurring a problem at the production, the particle obtained is satisfactorily stable and there is not caused a trouble that a monodisperse antimony oxide-coated silica-based fine particle cannot be obtained, which may occur in the case of using a small-size particle. When the average particle diameter is 100 nm or less, this is preferred because the average particle diameter of the obtained antimony oxide-coated silica-based fine particle can be reduced to 120 nm or less and problems such as reduction of transparency or increase of haze, which may occur in the case of forming a transparent film by using a large-size antimony oxide-coated silica-based fine particle, can be eliminated.

The refractive index of the porous silica-based fine particle or the silica-based fine particle having a cavity in the inside is preferably not more than 1.45 which is the refractive index of silica, more preferably 1.40 or less. Incidentally, a non-porous silica fine particle having a refractive index of 1.45 to 1.46 may be used alone, but in view of antireflection performance, it is preferred to use a porous silica-based fine particle or a silica-based fine particle having a cavity in the inside.

The silica-based fine particle is preferably coated with antimony oxide such that the average thickness of the coat layer is from 0.5 to 30 nm, preferably from 1 to 10 nm. When the average thickness of the coat layer is 0.5 nm, this is preferred because the silica-based fine particle can be completely coated and the obtained antimony oxide-coated silica-based fine particle can exhibit satisfactory electrical conductivity. When the thickness of the coat layer is 30 nm or less, this is preferred because a sufficiently high effect of enhancing the electrical conductivity can be obtained and problems such as insufficient refractive index, which may occur in the case where the average particle diameter of the antimony oxide-coated silica-based fine particle is small, can be eliminated.

The antimony oxide-coated silica-based fine particle for use in the present invention preferably has an average particle diameter of 5 to 120 nm, more preferably from 10 to 100 nm. When the average particle diameter of the antimony oxide-coated silica-based fine particle is 5 nm or more, this is preferred because the fine particle can be obtained without incurring a problem at the production and aggregation of obtained particles can be suppressed and also because there is not incurred a problem, which may occur in the case of a small particle, that due to poor dispersibility, when the particle is used for the formation of a transparent film, the transparency, haze, film strength, adhesion to substrate, and the like are not satisfied. When the average particle diameter of the antimony oxide-coated silica-based fine particle is 120 nm, this is preferred because the formed transparent film can have satisfactory transparency, the haze can be reduced and insufficient adhesion to the substrate does not occur.

The refractive index of the antimony oxide-coated silica-based fine particle is preferably from 1.25 to 1.60, more preferably from 1.30 to 1.50. When the refractive index is 1.25 or more, this is preferred because the particle can be obtained without incurring a problem at the production and the strength of the obtained particle can be sufficiently high. On the other hand, when the refractive index is 1.60 or less, the transparent film can exhibit satisfactory antireflection performance and this is preferred.

The volume resistance value of the antimony oxide-coated silica-based fine particle is preferably from 10 to 5,000 Ω/cm, more preferably from 10 to 2,000 Ω/cm. When the volume resistance value is 10 Ω/cm or more, this is preferred because the particle can be obtained without incurring a problem at the production and also because the refractive index of the obtained particle can be 1.6 or less and the transparent film can exhibit satisfactory antireflection performance. On the other hand, when the volume resistance value is 5,000 Ω/cm or less, the transparent film obtained can exert satisfactory antistatic performance and this is preferred.

The antimony oxide-coated silica-based fine particle for use in the present invention may be, if desired, surface-treated with a silane coupling agent in a usual manner before use.

### (Adsorbed Water Amount of Fine Particle)

In the present invention, in view of dispersibility in coating solution, hardness of coating film, and antifouling property, the particle which can be used in the low refractive index layer preferably has an adsorbed water amount of 6.1 mass % or less.

### (Measurement of Adsorbed Water Amount of Void-Containing Fine Particle)

In the present invention, the adsorbed water amount of the void-containing fine particle can be determined by the following measuring method.

The particle as a powder is dried for 1 hour by using a rotary pump under the conditions of 20° C. and about 1 hPa and then stored for 1 hour at 20° C. and 55% RH. Using “DTG-50” manufactured by Shimadzu Corp., about 10 mg of the sample after drying was weighed in a platinum cell and the temperature was elevated from 20° C. to 950° C. at a heating rate of 20° C./min. The adsorbed water amount is calculated as the mass decrement percentage when the temperature is elevated to 200° C., according to the following formula.

Adsorbed water amount (%)=100×(W₂₀−W₂₀₀)/W₂₀₀

wherein

W₂₀: the initial mass when the temperature starts elevating, and

W₂₀₀: the mass when the temperature is elevated to 200° C.

In the case where the particle is in the state of a liquid dispersion, the solvent is distilled off by an evaporator (25° C., pressure-reduced to 10 hPa) and after grinding the residue into a powder in an agate mortar, the adsorbed water amount can be measured by the above-described process.

In the present invention, the adsorbed water amount is preferably 6.1 mass % or less, more preferably 5.5 mass % or less, and most preferably 5.0 mass % or less. Particularly, in the case of a particle having a void in the particle surface or inside, the adsorbed water amount can be decreased by increasing the thickness or density of the shell in the particle surface or coating the surface with a different component as in the above-described antimony oxide-coated particle. The decrease of the adsorbed water amount is effective in improving the scratch resistance after exposure to ozone.

In the present invention, the void-containing fine particle may have a size distribution, and the coefficient of variation thereof is preferably from 60 to 5%, more preferably from 50 to 10%. Also, two kinds or three or more kinds of particles differing in the average particle size may be mixed and used.

### [Surface Treatment Method of Inorganic Fine Particle]

The surface treatment method of the inorganic fine particle is described below by referring to a porous or hollow inorganic fine particle. In order to improve the dispersibility in the binder for the formation of low refractive index layer, the surface of the inorganic fine particle is preferably treated with a hydrolysate of the organosilane represented by the following formula (1) and/or a partial condensate thereof, and it is more preferred that either one or both of an acid catalyst and a metal chelate compound are used at the treatment.

### (Organosilane Compound)

The organosilane compound for use in the present invention is described in detail below.

(R¹⁰)ₐₗ—Si(X¹¹)₄₋ₐₗ Formula (1)

In formula (1), R¹⁰ represents a substituted or unsubstituted alkyl group or a substituted or unsubstituted aryl group. Examples of the alkyl group include a methyl group, an ethyl group, a propyl group, an i-propyl group, a hexyl group, a tert-butyl group, an s-butyl group, a hexyl group, a decyl group and a hexadecyl group. The alkyl group is preferably an alkyl group having a carbon number of 1 to 30, more preferably from 1 to 16, still more preferably from 1 to 6. Examples of the aryl group include a phenyl group and a naphthyl group, with a phenyl group being preferred.

X¹¹ represents a hydroxyl group or a hydrolyzable group. Examples of the hydrolyzable group include an alkoxy group (preferably an alkoxy group having a carbon number of 1 to 5, such as methoxy group and ethoxy group), a halogen atom (e.g., Cl, Br, I) and a group represented by R¹²COO (wherein R¹² is preferably a hydrogen atom or an alkyl group having a carbon number of 1 to 5; e.g., CH₃COO, C₂H₅COO). Among these, an alkoxy group is preferred, and a methoxy group and an ethoxy group are more preferred.

a1 represents an integer of 1 to 3 and is preferably 1 or 2, more preferably 1. When a plurality of R¹⁰'s or X¹¹'s are present, the plurality of R¹⁰'s or X¹¹'s may be the same or different.

The substituent contained in R¹⁰ is not particularly limited, but examples thereof include a halogen atom (e.g., fluorine, chlorine, bromine), a hydroxyl group, a mercapto group, a carboxyl group, an epoxy group, an alkyl group (e.g., methyl, ethyl, i-propyl, propyl, tert-butyl), an aryl group (e.g., phenyl, naphthyl), an aromatic hetero-cyclic group (e.g., furyl, pyrazolyl, pyridyl), an alkoxy group (e.g., methoxy, ethoxy, i-propoxy, hexyloxy), an aryloxy group (e.g., phenoxy), an alkylthio group (e.g., methylthio, ethylthio), an arylthio group (e.g., phenylthio), an alkenyl group (e.g., vinyl, 1-propenyl), an acyloxy group (e.g., acetoxy, acryloyloxy, methacryloyloxy), an alkoxycarbonyl group (e.g., methoxycarbonyl, ethoxycarbonyl), an aryloxycarbonyl group (e.g., phenoxycarbonyl), a carbamoyl group (e.g., carbamoyl, N-methylcarbamoyl, N,N-dimethylcarbamoyl, N-methyl-N-octylcarbamoyl) and an acylamino group (e.g., acetylamino, benzoylamino, acrylamino, methacrylamino). These substituents each may be further substituted. Incidentally, in the present invention, even when a single atom is substituted to the hydrogen atom, for the sake of convenience, this is referred to as a substituent.

When a plurality of R¹⁰'s are present, at least one is preferably a substituted alkyl group or a substituted aryl group. In particular, the substituted alkyl group or substituted aryl group preferably further has a vinyl polymerizable group. In this case, the compound represented by formula (1) may be expressed as a vinyl polymerizable substituent-containing organosilane compound represented by the following formula (1-2).

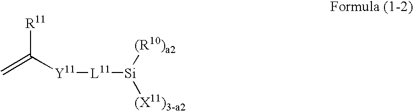

In formula (1-2), R¹¹ represents a hydrogen atom, a methyl group, a methoxy group, an alkoxycarbonyl group, a cyano group, a fluorine atom or a chlorine atom. Examples of the alkoxycarbonyl group include a methoxycarbonyl group and an ethoxycarbonyl group. R¹¹ is preferably a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, still more preferably a hydrogen atom or a methyl group.

Y¹¹ represents a single bond, an ester group, an amido group, an ether group or a urea group and is preferably a single bond, an ester group or an amido group, more preferably a single bond or an ester group, still more preferably an ester group.

L¹¹ represents a divalent linking chain and is specifically a substituted or unsubstituted alkylene group, a substituted or unsubstituted arylene group, a substituted or unsubstituted alkylene group having in the inside thereof a linking group (e.g., ether, ester, amido), or a substituted or unsubstituted arylene group having in the inside thereof a linking group, preferably a substituted or unsubstituted alkylene group having a carbon number of 2 to 10, a substituted or unsubstituted arylene group having a carbon number of 6 to 20, or an alkylene group having in the inside thereof a linking group and having a carbon number of 3 to 10, more preferably an unsubstituted alkylene group, an unsubstituted arylene group or an alkylene group having in the inside thereof an ether or ester linking group, still more preferably an unsubstituted alkylene group or an alkylene group having in the inside thereof an ether or ester linking group. Examples of the substituent include a halogen, a hydroxyl group, a mercapto group, a carboxyl group, an epoxy group, an alkyl group and an aryl group. These substituents each may be further substituted.

a2 represents 0 or 1. When a plurality of X¹¹'s are present, the plurality of X¹¹'s may be the same or different. a2 is preferably 0.

R¹⁰ has the same meaning as R¹⁰ in formula (1) and is preferably a substituted or unsubstituted alkyl group or an unsubstituted aryl group, more preferably an unsubstituted alkyl group or an unsubstituted aryl group. X¹¹ also has the same meaning as X¹¹ in formula (1) and is preferably a halogen, a hydroxyl group or an unsubstituted alkoxy group, more preferably chlorine, a hydroxyl group or an unsubstituted alkoxy group having a carbon number of 1 to 6, still more preferably a hydroxyl group or an alkoxy having a carbon number of 1 to 3, yet still more preferably a methoxy group.

The organosilane compound for use in the present invention is preferably an organosilane compound represented by the following formula (2).

(R_{f}−L²¹)_{b1}—Si(X²¹)_{b1-4} Formula (2)

In formula (2), R_{f} represents a linear, branched or cyclic fluorine-containing alkyl group having a carbon number of 1 to 20 or a fluorine-containing aromatic group having a carbon number of 6 to 14. Rf is preferably a linear, branched or cyclic fluoroalkyl group having a carbon number of 3 to 10, more preferably a linear fluoroalkyl group having a carbon number of 4 to 8. L²¹ represents a divalent linking group having a carbon number of 10 or less and is preferably an alkylene group having a carbon number of 1 to 10, more preferably an alkylene group having a carbon number of 1 to 5. The alkylene group is a linear or branched, substituted or unsubstituted alkylene group which may have a linking group (e.g., ether, ester, amido) in the inside. The alkylene group may have a substituent and in this case, preferred examples of the substituent include a halogen atom, a hydroxyl group, a mercapto group, a carboxyl group, an epoxy group, an alkyl group and an aryl group. X²¹ has the same meaning as X¹¹ in formula (1) and is preferably a halogen, a hydroxyl group or an unsubstituted alkoxy group, more preferably chlorine, a hydroxyl group or an unsubstituted alkoxy group having a carbon number of 1 to 6, still more preferably a hydroxyl group or an alkoxy group having a carbon number of 1 to 3, yet still more preferably a methoxy group.

b1 has the same meaning as al in formula (1) and represents an integer of 1 to 3. b1 is preferably 1 or 2, more preferably 1.

Among the fluorine-containing silane coupling agents represented by formula (2), preferred is a fluorine-containing silane coupling agent represented by the following formula (2-1):

CₙF₂ₙ₊ₗ—(CH₂)ₘ—Si(X²²)₃ Formula (2-1)

In formula (2-1), n represents an integer of 1 to 10, and m represents an integer of 1 to 5. n is preferably an integer of 4 to 10, and m is preferably an integer of 1 to 3. X²² represents a methoxy group, an ethoxy group or a chlorine atom.

Two or more kinds of the compounds represented by formulae (1), (1-2), (2) and (2-1) may be used in combination.

Specific examples of the compounds represented by formulae (1), (1-2), (2) and (2-1) are set forth below, but the present invention is not limited thereto.

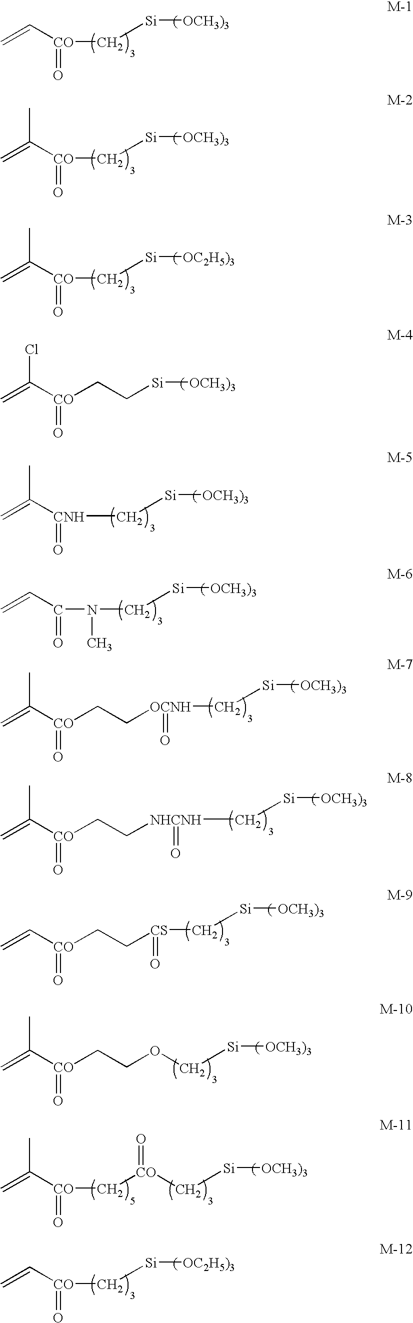

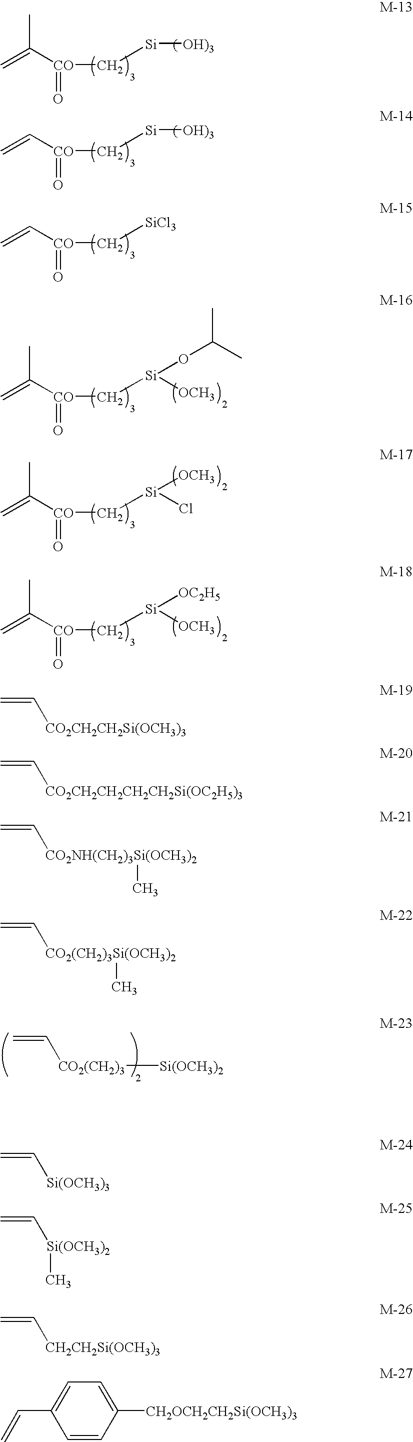

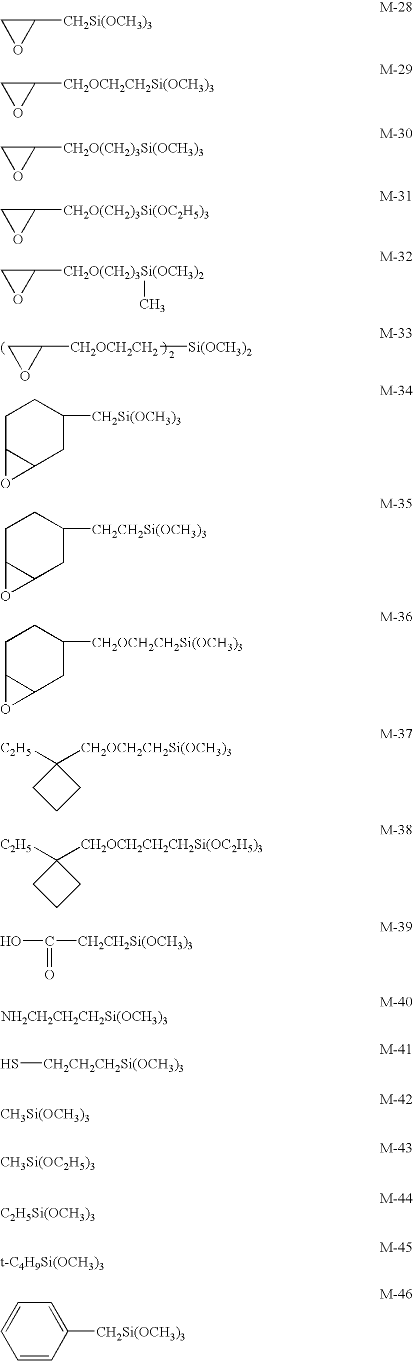

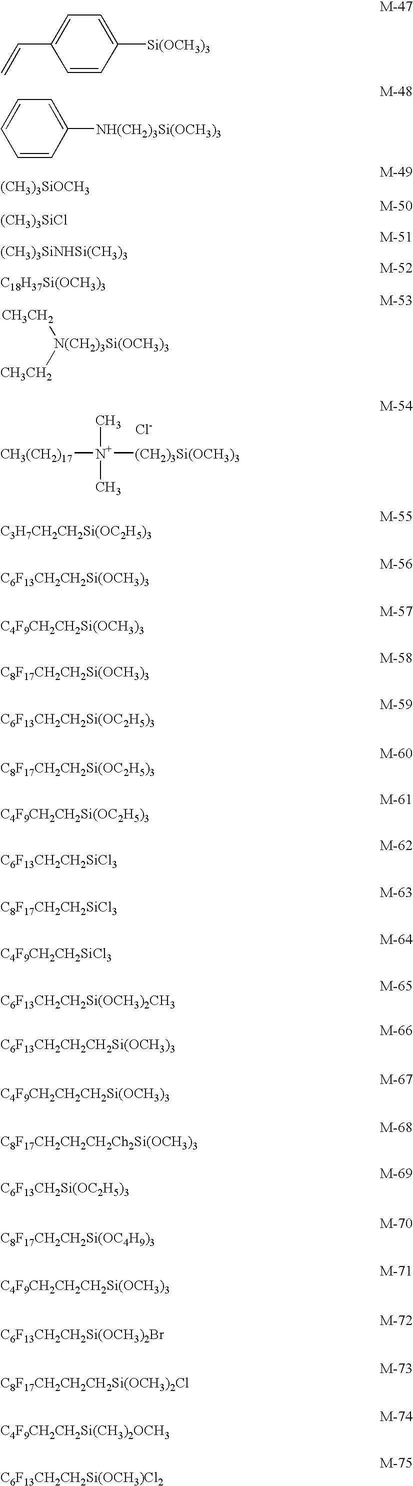

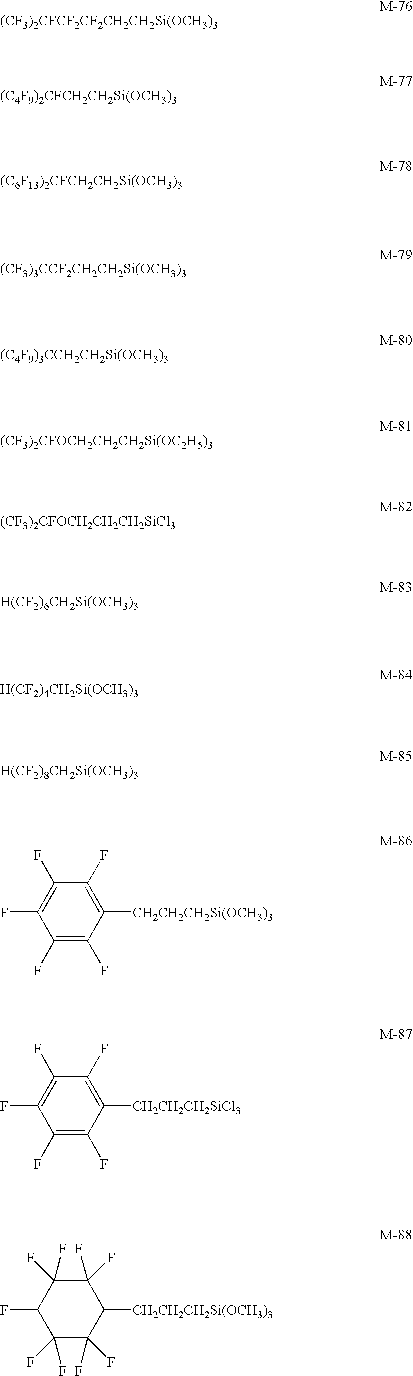

Among these compounds (M-1) to (M-88), preferred are (M-1), (M-2), (M-30), (M-35), (M-49), (M-51), (M-56) and (M-57). Also, Compounds A, B and C described in Reference Examples of Japanese Patent 3,474,330 are also preferred because of their excellent dispersion stability.

A disiloxane-based compound may also be used as the surface treating agent. Examples thereof include hexamethyldisiloxane, 1,3-dibutyltetramethyldisiloxane, 1,3-diphenyltetramethyldisiloxane, 1,3-divinyltetramethyldisiloxane, hexaethyldisiloxane and 3-glycidoxypropylpentamethyldisiloxane.

In the present invention, the amount used of the organosilane compound represented by formulae (1), (1-2), (2) and (2-1) is not particularly limited but is preferably from 1 to 300 mass %, more preferably from 3 to 100 mass %, and most preferably from 5 to 50 mass %, per the inorganic fine particle. Also, the amount used is preferably from 1 to 300 mol %, more preferably from 5 to 300 mol %, and most preferably from 10 to 200 mol %, per the hydroxyl group on the inorganic fine particle surface. When the amount of the organosilane compound used is within the above-described range, a satisfactory effect of stabilizing the liquid dispersion can be obtained and the film strength at the formation of a coating film increases. A plurality of organosilane compound species are preferably used in combination, and the plurality of compound species may be added at the same time or may be reacted by adding at different times. Also, when a plurality of compound species are previously formed into a partial condensate and the partial condensate is added, the control of reaction is facilitated and this is preferred.

### [Improvement of Dispersibility of Inorganic Fine Particle]

In the present invention, a hydrolysate of the above-described organosilane compound and/or a partial condensate of the hydrolysate is caused to act on the inorganic fine particle surface, whereby the dispersibility of the inorganic fine particle can be improved. The hydrolysis and condensation reaction of the organosilane compound is preferably performed by adding water in an amount of 0.3 to 2.0 mol, preferably from 0.5 to 1.0 mol, per mol of the hydrolyzable group (X¹¹, X²¹ or X²²) and stirring it at 15 to 100° C. in the presence of an acid catalyst or a metal chelate compound for use in the present invention.

### [Catalyst for Dispersibility Improving Treatment]

The dispersibility improving treatment with a hydrolysate of organosilane and/or a condensation reaction product thereof is preferably performed in the presence of a catalyst. Examples of the catalyst include inorganic acids such as hydrochloric acid, sulfuric acid and nitric acid; organic acids such as oxalic acid, acetic acid, formic acid, methanesulfonic acid and toluenesulfonic acid; inorganic bases such as sodium hydroxide, potassium hydroxide and ammonia; organic bases such as triethylamine and pyridine; and metal alkoxides such as triisopropoxyaluminum and tetrabutoxyzirconium. In view of the production stability or storage stability of the inorganic oxide fine particle solution, an acid catalyst (inorganic acids, organic acids) and/or a metal chelate compound is used in the present invention. As for the inorganic acid, a hydrochloric acid and a sulfuric acid are preferred, and as for the organic acid, an organic acid having an acid dissociation constant (pKa value (25° C.)) of 4.5 or less in water is preferred. In particular, a hydrochloric acid, a sulfuric acid and an organic acid having an acid dissociation constant of 3.0 or less in water are preferred, a hydrochloric acid, a sulfuric acid and an organic acid having an acid dissociation constant of 2.5 or less in water are more preferred, an organic acid having an acid dissociation constant of 2.5 or less in water is still more preferred. Among these, a methanesulfonic acid, an oxalic acid, a phthalic acid and a malonic acid are more preferred, and an oxalic acid is still more preferred.

In the case where the hydrolyzable group of the organosilane is an alkoxy group and the acid catalyst is an organic acid, the carboxyl group or sulfo group of the organic acid supplies a proton and therefore, the amount of water added can be decreased. The amount of water added is from 0 to 2 mol, preferably from 0 to 1.5 mol, more preferably from 0 to 1 mol, still more preferably from 0 to 0.5 mol, per mol of the alkoxide group of organosilane. In the case of using an alcohol as the solvent, an embodiment of adding substantially no water is also preferred.

### (Metal Chelate Compound)

In the present invention, the metal chelate compound used for the dispersibility improving treatment with a hydrolysate of organosilane and/or a condensation reaction product thereof is preferably at least one metal chelate compound where an alcohol represented by the following formula (3-1) and a compound represented by the following formula (3-2) are present as ligands and the center metal is a metal selected from Zr, Ti and Al. As long as the center metal is a metal selected from Zr, Ti and Al, the metal chelate compound can be suitably used without any particular limitation. Within this category, two or more kinds of metal chelate compounds may be used in combination.

R³¹OH Formula (3-1)

R³²COCH₂COR³³ Formula (3-2)

(wherein R³¹ and R³², which may be the same or different, each represents an alkyl group having a carbon number of 1 to 10, and R³³ represents an alkyl group having a carbon number of 1 to 10 or an alkoxy group having a carbon number of 1 to 10).

Specific examples of the metal chelate compound suitably used in the present invention include a zirconium chelate compound such as tri-n-butoxyethylacetoacetate zirconium, di-n-butoxybis(ethylacetoacetate)zirconium, n-butoxytris(ethylacetoacetate)zirconium, tetrakis(n-propylacetoacetate)zirconium, tetrakis(acetylacetoacetate)zirconium and tetrakis(ethylacetoacetate)zirconium; a titanium chelate compound such as diisopropoxy.bis(ethylacetoacetate)titanium, diisopropoxy.bis(acetylacetate)titanium and diisopropoxy.bis(acetylacetone)titanium; and an aluminum chelate compound such as diisopropoxyethylacetoacetate aluminum, diisopropoxyacetyl-acetonate aluminum, isopropoxybis(ethylacetoacetate)aluminum, isopropoxybis(acetylacetonate)aluminum, tris(ethylacetoacetate)aluminum, tris(acetylacetonate)aluminum and monoacetylacetonato.bis(ethylacetoacetate)aluminum.

Among these metal chelate compounds, preferred are tri-n-butoxyethylacetoacetate zirconium, diisopropoxy.bis(acetylacetonate)titanium, diisopropoxyethylacetoacetate aluminum and tris(ethylacetoacetate)aluminum. One of these metal chelate compounds may be used alone, or two or more species thereof may be mixed and used. Furthermore, a partial hydrolysate of such a metal chelate compound may also be used. The amount of the metal chelate compound is preferably from 0.1 to 10.0 mass %, more preferably from 0.5 to 5.0 mass %, and most preferably from 1.0 to 3.0 mass %, based on the organosilane compound.

### [Dispersant]

In the present invention, a dispersant may be used for preparing the inorganic oxide fine particle by dispersing its powder form in a solvent. Use of a dispersant having an anionic group is preferred in the present invention.

As for the anionic group, a group having an acidic proton, such as carboxyl group, sulfonic acid group (sulfo), phosphoric acid group (phosphono) and sulfonamide group, or a salt thereof is effective. In particular, a carboxyl group, a sulfonic acid group, a phosphoric acid group, and a salt thereof are preferred, and a carboxyl group and a phosphoric acid group are more preferred. For the purpose of more improving the dispersibility, a plurality of anionic groups may be contained. The average number of anionic groups is preferably 2 or more, more preferably 5 or more, still more preferably 10 or more. Also, in the dispersant, a plurality of kinds of anionic groups may be contained within one molecule.

The dispersant may further contain a crosslinking or polymerizable functional group. Examples of the crosslinking or polymerizable functional group include an ethylenically unsaturated group {e.g., (meth)acryloyl, allyl, styryl, vinyloxy} capable of undergoing addition reaction.polymerization reaction by the effect of a radical species; a cationic polymerizable group (e.g., epoxy, oxatanyl, vinyloxy); and a polycondensation reactive group (e.g., hydrolyzable silyl, N-methylol). Among these, a functional group having an ethylenically unsaturated group is preferred.

The amount of the dispersant used is preferably from 0.5 to 30 mass %, more preferably from 1 to 20 mass %, and most preferably from 2 to 15 mass %, based on the inorganic fine particle. Within this range, improvement of dispersibility is recognized and at the same time, a trouble such as reduction of coating film strength is advantageously not incurred.

### 1-(3) Compound Containing, within One Molecule, a Plurality of Functional Groups Capable of Forming a Chemical Bond [Constituent Component (D) of the Low Refractive Index Layer of the Present Invention]

The compound containing, within one molecule, a plurality of functional groups capable of forming a chemical bond, represented by (D), is described below. In the present invention, for the purpose of, for example, enhancing the coating film strength of the low refractive index layer or improving compatibility between the fine particle and the fluorine-containing compound used in combination, the coating composition preferably comprises a compound containing, within one molecule, a plurality of functional groups capable of forming a chemical bond. A compound having an ethylenically unsaturated group, a compound having a cationic polymerizable group and a compound capable of forming a chemical bond with a hydroxyl group are preferred.

### ((C) Compound having a (meth)acryloyl Group)

In combination with the fluorine polymer of the present invention, (C) a compound having a (meth)acryloyl group is preferably used. Particularly, a monomer having two or more (meth)acryloyl groups within one molecule is preferably used in combination. When the fluorine content of the polymer is increased to reduce the refractive index of the low refractive index layer, the crosslinking group density in the coating tends to decrease and in turn, the coating strength and scratch resistance are decreased. Also, in the case where a polymer having a high fluorine content and a silica-based particle containing a void in the inside are used in combination in the low refractive index layer so as to reduce the refractive index, the wettability on the particle surface is low due to great difference in the surface energy therebetween and when a coating solution containing a solvent is coated and dried to form the low refractive index layer, the fluorine polymer cannot cover the particle surface, as a result, the strength of the coating film after curing is liable to decrease. This phenomenon becomes more prominent as the fluorine content of the fluorine polymer or the particle content in the layer is increased. Particularly, the coating surface layer susceptible to polymerization inhibition by oxygen at the curing tends to be weakly cured. Then, the silicone compound in the coating surface layer having a role of expressing antifouling property cannot be immobilized and the antifouling property is worsened. In the present invention, it is presumed that by virtue of a small amount of the (C) compound having a (meth)acryloyl group used in combination, the affinity between the particle and the fluorine polymer is improved and not only the coating strength and in turn the scratch resistance can be enhanced but also the antifouling property can be enhanced.

Specific examples of the monomer having two or more (meth)acryloyl groups include (meth)acrylic acid diesters of alkylene glycol, such as neopentyl glycol acrylate, 1,6-hexanediol (meth)acrylate and propylene glycol di(meth)acrylate; (meth)acrylic acid diesters of polyoxyalkylene glycol, such as triethylene glycol di(meth)acrylate, dipropylene glycol di(meth)acrylate, polyethylene glycol di(meth)acrylate and polypropylene glycol di(meth)acrylate; (meth)acrylic acid diesters of polyhydric alcohol, such as pentaerythritol di(meth)acrylate; and (meth)acrylic acid diesters of ethylene oxide or propylene oxide adduct, such as 2,2-bis{4-(acryloxy.diethoxy)phenyl}propane and 2-2-bis{4-(acryloxy.polypropoxy)phenyl}propane.

Furthermore, epoxy (meth)acrylates, urethane (meth)acrylates and polyester (meth)acrylates may also be preferably used as the photopolymerizable polyfunctional monomer.

Among these, esters of a polyhydric alcohol with a (meth)acrylic acid are preferred, and a polyfunctional monomer having three or more (meth)acryloyl groups within one molecule is more preferred. Examples thereof include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate and caprolactone-modified tris(acryloxyethyl)isocyanurate.

Specific examples of the polyfunctional acrylate-based compounds having a (meth)acryloyl group include an esterification product of a polyol with a (meth)acrylic acid, such as KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60 and KAYARAD GPO-303 produced by Nippon Kayaku Co., Ltd., and V#3PA, V#400, V#36095D, V#1000 and V#1080 produced by Osaka Organic Chemical Industry Ltd. Furthermore, examples of the compound which can be also suitably used include a trifunctional or higher urethane acrylate compound such as SHIKO UV-1400B, SHIKO UV-1700B, SHIKO UV-6300B, SHIKO UV-7550B, SHIKO UV-7600B, SHIKO UV-7605B, SHIKO UV-7610B, SHIKO UV-7620EA, SHIKO UV-7630B, SHIKO UV-7640B, SHIKO UV-6630B, SHIKO UV-7000B, SHIKO UV-7510B, SHIKO UV-7461TE, SHIKO UV-3000B, SHIKO UV-3200B, SHIKO UV-3210EA, SHIKO UV-3310EA, SHIKO UV-3310B, SHIKO UV-3500BA, SHIKO UV-3520TL, SHIKO UV-3700B, SHIKO UV-6100B, SHIKO UV-6640B, SHIKO UV-2000B, SHIKO UV-2010B, SHIKO UV-2250EA, SHIKO UV-2750B (all produced by The Nippon Synthetic Chemical Industry Co., Ltd.), UL-503LN (produced by Kyoeisha Chemical Co., Ltd.), UNIDIC 17-806, UNIDIC 17-813, UNIDIC V-4030, UNIDIC V-4000BA (all produced by Dainippon Ink and Chemicals, Inc.), EB-1290K, EB-220, EB-5129, EB-1830, EB-4858 (all produced by Daicel-UCB Company Ltd.), Hi-Coap AU-2010, Hi-Coap AU-2020 (both produced by Tokushiki Co., Ltd.), ARONIX M-1960 (produced by Toagosei Co., Ltd.), ART-RESIN UN-3320HA, UN-3320HC, UN-3320HS, UN-904 and HDP-4T; and a trifunctional or higher polyester compound such as ARONIX M-8100, M-8030, M-9050 (all produced by Toagosei Co., Ltd.) and KRM-8307 (produced by DAICEL-CYTEC Company Ltd.).

Other examples include a resin having three or more (meth)acryloyl groups, such as a polyester, polyether, acrylic, epoxy, urethane, alkyd, spiroacetal, polybutadiene or polythiol polyene resin having a relatively low molecular weight; and an oligomer or prepolymer of a polyfunctional compound such as polyhydric alcohol.

As for the monomer binder, a dendrimer described, for example, in JP-A-2005-76005 and JP-A-2005-36105, or a norbornene ring-containing monomer described, for example, in JP-A-2005-60425 may also be used.

Two or more kinds of polyfunctional monomers may be used in combination.

The amount added of the (C) compound having a (meth)acryloyl group is preferably from 0.1 to 50 mass %, more preferably from 1 to 30 mass %, still more preferably from 3 to 20 mass %, based on the solid content forming the coating. When the amount of the compound used is in this range, increase in the hardness of the low refractive index layer itself, immobilization of the antifouling agent in the low refractive index layer, and improvement of the interface adhesion to an adjacent layer can be achieved.

### (Compound Having Cationic Polymerizable Group)

Examples of the cationic polymerizable group include an epoxy group, an oxetanyl group, an oxazolyl group and a vinyloxy group. The cationic polymerizable group is preferably a ring-opening polymerizable group, more preferably an epoxy group or an oxetanyl group, still more preferably an epoxy group. These groups each may have a substituent at a substitutable position.

A plurality of cationic polymerizable groups are preferably introduced per one molecule of the curing agent. The number of cationic polymerizable groups introduced per one molecule is more preferably from 2 to 20, still more preferably from 3 to 10.

Examples of the compound suitably used in the present invention include, as the commercial product, DENACOL EX314, DENACOL EX41 1, DENACOL EX421, DENACOL EX521, DENACOL EX61 1, DENACOL EX612 (all produced by Nagase Chemicals Ltd.), CELOXIDE GT301 and CELOXIDE GT401 (both produced by Daicel Chemical Industries, Ltd.). Other examples of the curing agent useful in the present invention are set forth below.

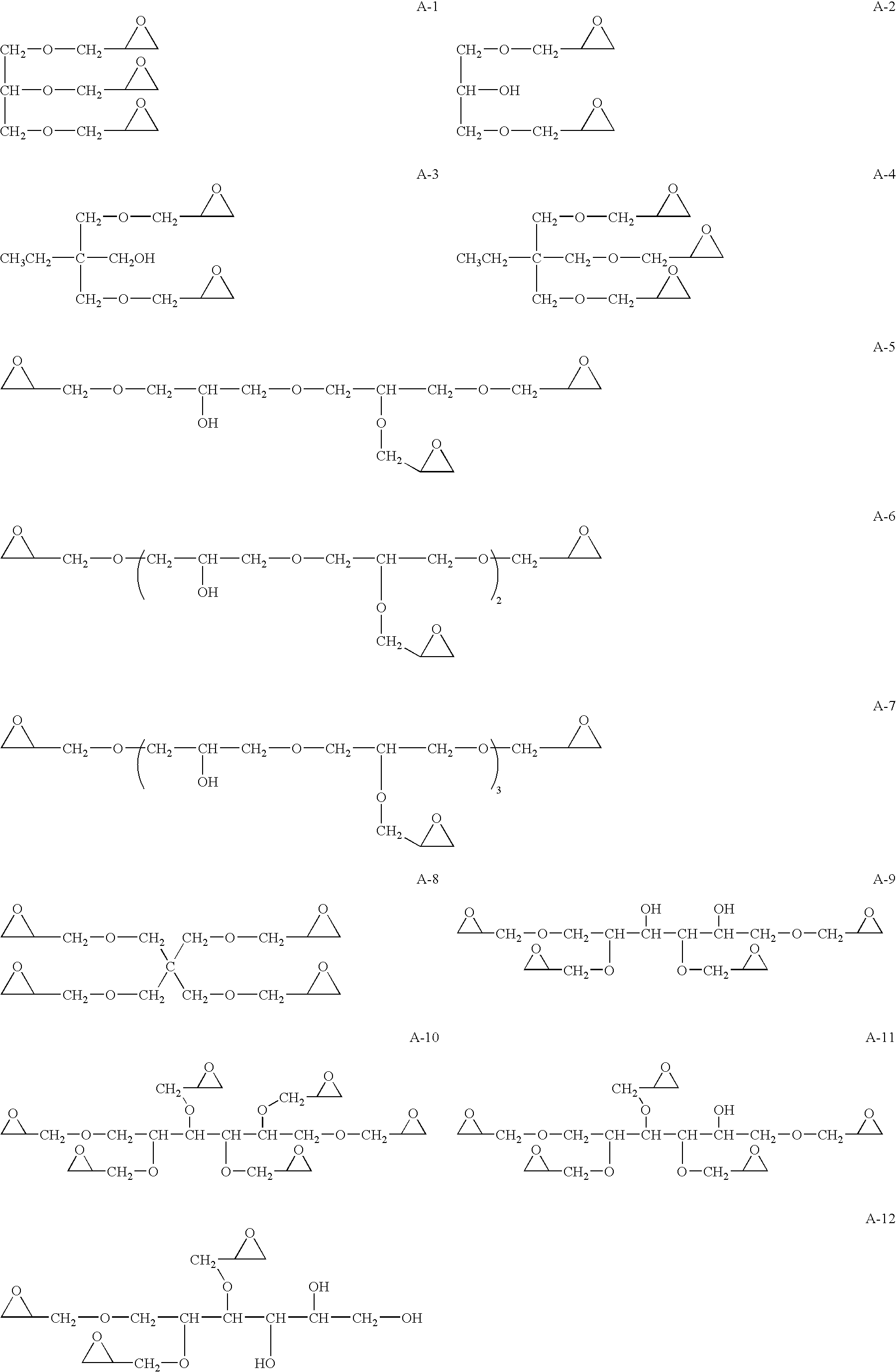

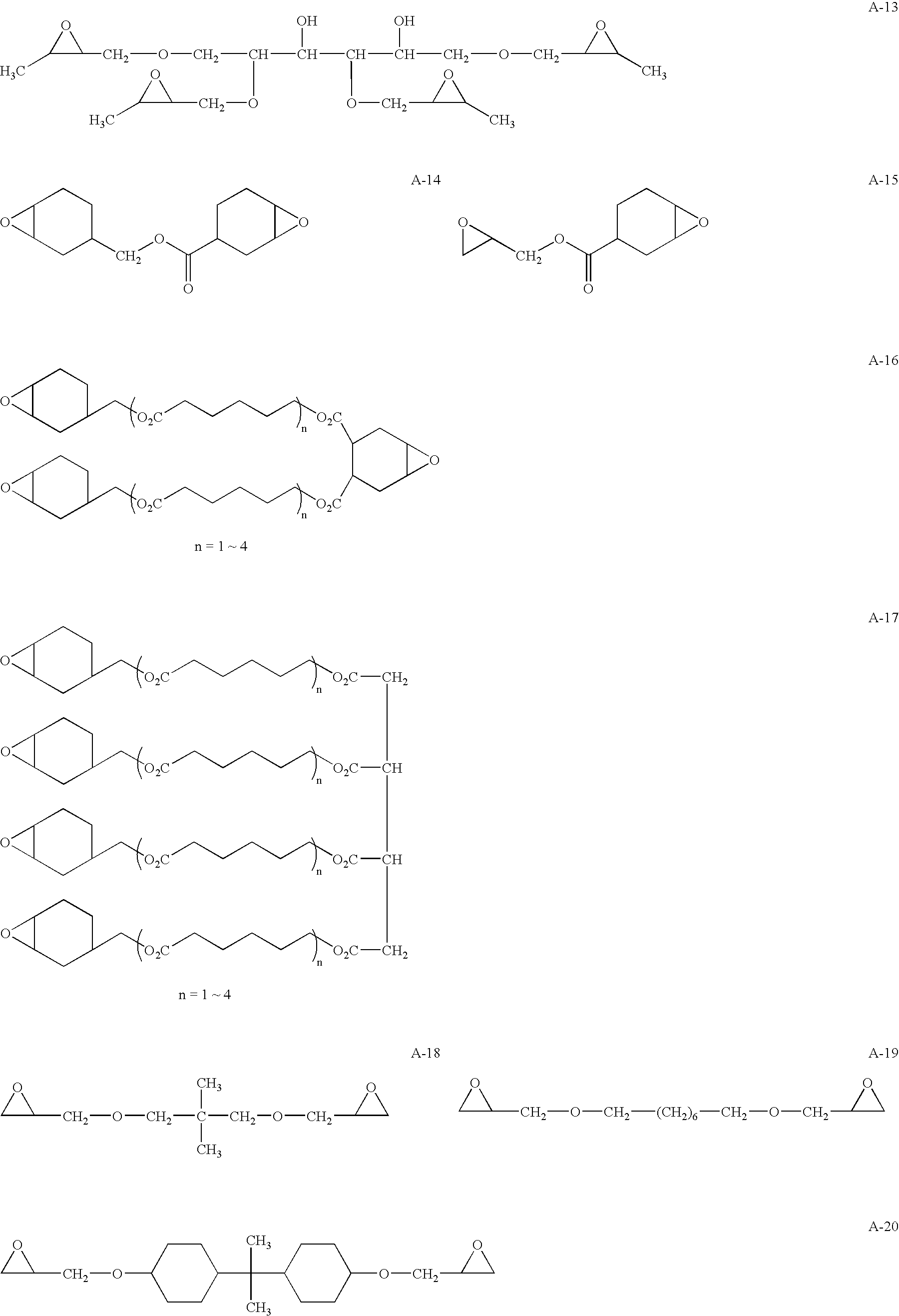

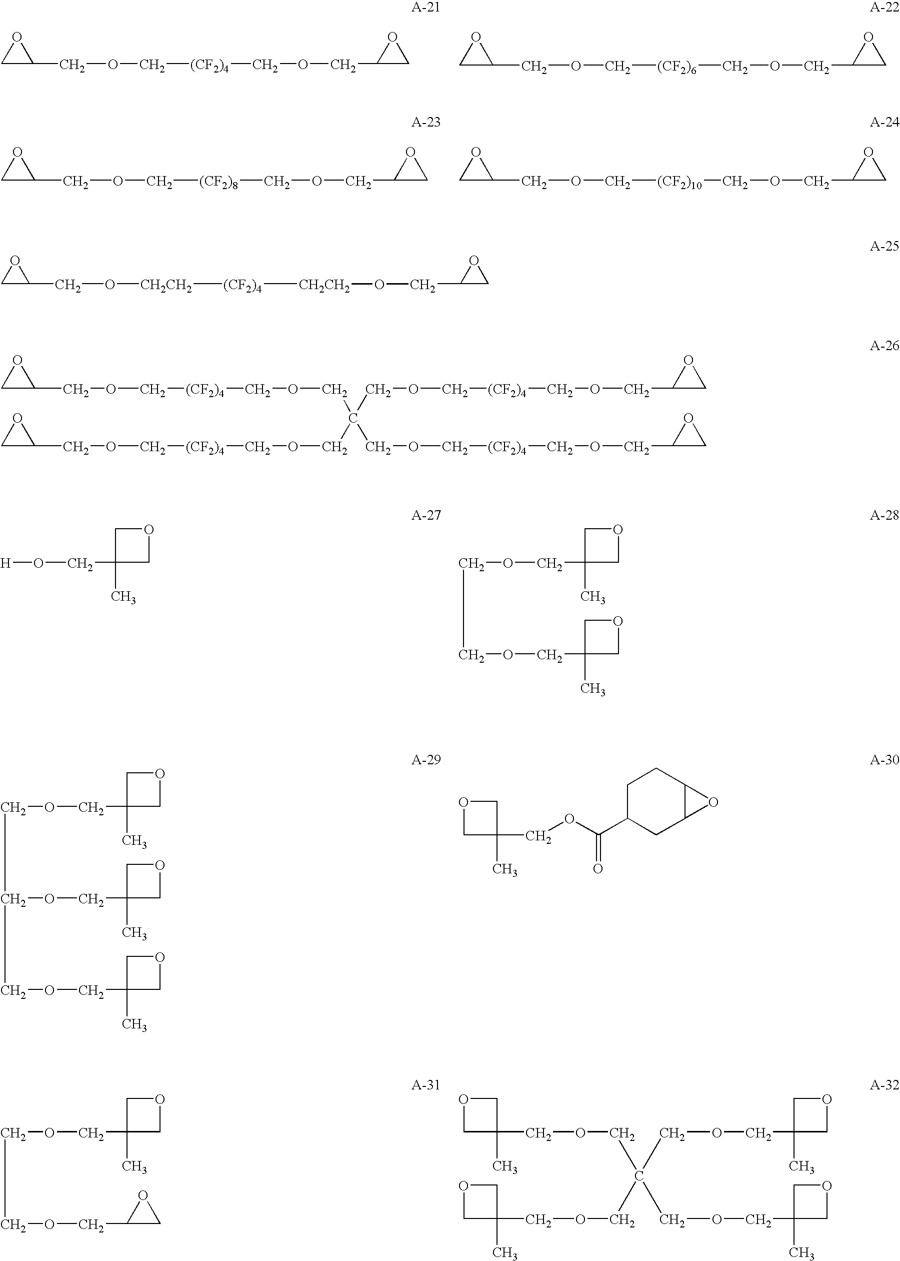

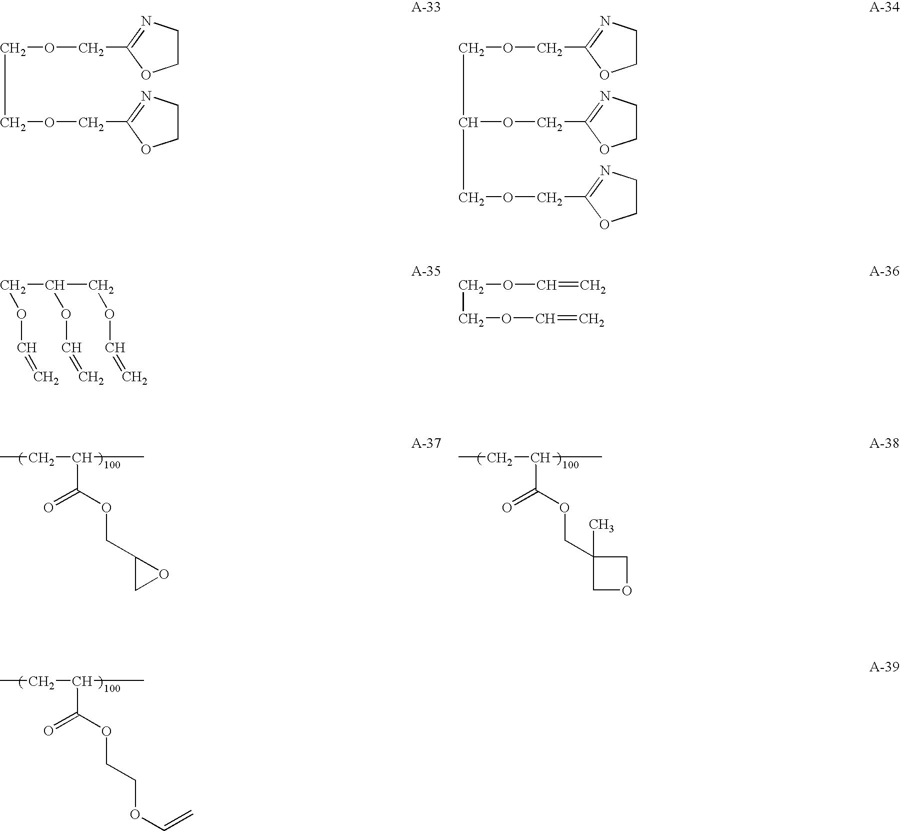

The amount added of the compound having a cationic polymerizable group is preferably from 0.1 to 50 mass %, more preferably from 1 to 30 mass %, still more preferably from 3 to 20 mass %, based on the solid content forming the film.

### (Compound Capable of Forming Chemical Bond with Hydroxyl Group)

The low refractive index layer for use in the present invention is preferably formed using a curable composition comprising a fluorine-containing polymer containing a hydroxyl group and a compound (curing agent) capable of reacting with a hydroxyl group in the fluorine-containing polymer, that is, a so-called curable resin composition. The curing agent preferably has two or more, more preferably four or more, sites capable of reacting with a hydroxyl group.

The structure of the curing agent is not particularly limited as long as it has several functional groups capable of reacting with a hydroxyl group, and examples of the curing agent include isocyanates, a partial condensate or multimer of isocyanate compound, an adduct with polyhydric alcohol or low molecular weight polyester film, a block polyisocyanate compound in which the isocyanate is blocked with a blocking agent such as phenol, aminoplasts, a polybasic acid or its anhydride.

In the present invention, from the standpoint of satisfying both stability during storage and activity in the crosslinking reaction and also in view of strength of the film formed, aminoplasts capable of undergoing a crosslinking reaction with a hydroxyl group-containing compound under an acidic condition are preferred. The aminoplasts are a compound containing an amino group capable of reacting with the hydroxyl group present in the fluorine-containing polymer, that is, a hydroxyalkylamino group or an alkoxyalkylamino group, or containing a carbon atom adjacent to a nitrogen atom and substituted by an alkoxy group. Specific examples thereof include a melamine-based compound, a urea-based compound and a benzoguanamine-based compound.

The melamine-based compound is generally known as a compound having a skeleton that a nitrogen atom is bonded to a triazine ring, and specific examples thereof include melamine, an alkylated melamine, methylolmelamine and an alkoxylated methylmelamine. In particular, a methylolated melamine obtained by reacting melamine and formaldehyde under a basic condition, an alkoxylated melamine, and a derivative thereof are preferred and in view of storage stability, an alkoxylated methylmelamine is more preferred. The methylolated melamine and alkoxylated methyl melamine are not particularly limited, and various resins obtained by the method described, for example, in Plastic Zairyo Koza (Plastic Material Lecture) [8] Urea-Melamine Jushi (Urea-Melamine Resin), Nikkan Kogyo Shinbun-Sha, can also be used.

The urea compound is, in addition to urea, preferably a polymethylolated urea, an alkoxylated methyl urea which is a derivative of the polymethylolated urea, or a compound having a glycoluril or 2-imidazolidinone skeleton which is a cyclic urea structure. Also as for the amino compound such as urea derivative described above, various resins described, for example, in Urea-Melamine Resin supra may be used.

Among the compounds suitably used as the crosslinking agent in the present invention, a melamine compound and a glycoluril compound are preferred in view of compatibility with the fluorine-containing polymer. Particularly, in consideration of reactivity, the crosslinking agent is preferably a compound containing a nitrogen atom in the molecule and further containing two or more carbon atoms adjacent to the nitrogen atom and substituted by an alkoxy group. The compound is more preferably a compound having a structure represented by the following (H-1) or (H-2), or a partial condensate thereof. In the formulae, R represents an alkyl group having a carbon number of 1 to 6 or a hydroxyl group.

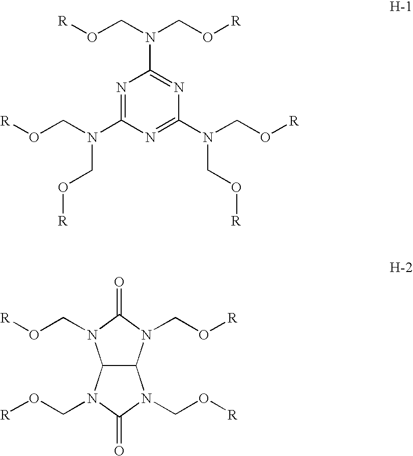

The amount of the aminoplast added to the fluorine-containing polymer is from 1 to 50 parts by mass, preferably from 3 to 40 parts by mass, more preferably from 5 to 30 parts by mass, per 100 parts by mass of the copolymer. When the amount added is 1 part by mass or more, the durability as a thin film, which is a characteristic feature of the present invention, can be sufficiently bought out, and when the amount added is 50 parts by mass or less, the low refractive index as a characteristic feature of the low refractive index layer in the present invention at the application to optical uses can be maintained and this is preferred. From the standpoint of keeping the refractive index low even when a curing agent is added, a curing agent of less increasing the refractive index when added is preferred. In this respect, out of the compounds described above, a compound having a skeleton represented by (H-2) is more preferred.

In the present invention, the hydroxyl group-containing polymer and the polyfunctional reactive compound may be previously partially bound before the formation of the coating composition and then used. This is effective particularly when the fluorine content is high as in the present invention, and brings increase in the hardness of the coating film or enhancement of the dispersion stability of a fine particle used in combination.

### (Molecular Weight of Compound Containing, within One Molecule, a Plurality of Functional Groups Capable of Forming a Chemical Bond)

The molecular weight of the above-described compound is not particularly limited but is preferably from 200 to 10,000, more preferably from 200 to 3,000, still more preferably from 400 to 1,500. If the molecular weight is too small, volatilization becomes a problem in the film forming process, whereas if it is excessively large, the compatibility with the fluorine-containing polymer worsens.

### 1-(4) Organosilane Compound [Constituent Component (C) of the Low Refractive Index Layer of the Present Invention]

In the film of the present invention, it is preferred in view of scratch resistance to contain, for example, an organosilane compound or a hydrolysate of the organosilane compound and/or a partial condensate of the hydrolysate (hereinafter, the obtained reaction solution is sometimes referred to as a “sol component”).

Such a compound functions as a binder when the curable composition is coated and a cured product is then formed through condensation during drying and heating. In the case of having a polyfunctional acrylate polymer, a binder having a three-dimensional structure is formed upon irradiation with actinic rays.

Specific examples of the compound which can be used include organosilane compounds (M-1) to (M-88) described above for the inorganic fine particle. Among these, (M-1), (M-2), (M-30) and (M-35) are preferred.

The amount blended of the organosilane compound or a hydrolysate thereof and/or a partial condensate of the hydrolysate is preferably from 0.1 to 50 mass %, more preferably from 0.5 to 30 mass %, and most preferably from 1 to 20 mass %, based on the entire solid content of he low refractive index layer.

The organosilane compound may be added directly to the curable composition (coating solution for antiglare layer, low refractive layer or the like), but it is preferred that the organosilane compound is previously treated in the presence of a catalyst to prepare a hydrolysate of the organosilane compound and/or a partial condensate of the hydrolysate and the curable composition is prepared using the obtained reaction solution (sol solution). In the present invention, the curable composition is preferably coated after preparing a composition containing a hydrolysate of the organosilane compound and/or a partial condensate of the hydrolysate and a metal chelate compound, adding a β-diketone compound and/or a β-ketoester compound thereto, and incorporating the resulting solution into at least one coating solution for antiglare layer or low refractive layer.

### 1-(5) Polymerization Initiator [Constituent Component (E) of the Low Refractive Index Layer of the Present Invention]

The polymerization initiator effective for the curing of the low refractive index layer of the present invention is described below. In the case where the constituent component of the low refractive index layer is a radical polymerizable compound, the polymerization of such a compound may be performed by the irradiation with ionizing radiation or under heating in the presence of a photoradical initiator or a thermal radical initiator.

### (Photoradical Initiator)

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes and coumarins.

Examples of the acetophenones include 2,2-dimethoxyacetophenone, 2,2-diethoxyacetophenone, p-dimethylacetophenone, 1-hydroxydimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)butanone, 4-phenoxydichloroacetophenone and 4-tert-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone) and 3,3′,4,4′-tetra(tert-butylperoxycarbonyl)benzophenone.

Examples of the phosphine oxides include 2,4,6-trimethylbenzoyldiphenylphosphine oxide. Examples of the active esters include 1,2-octanedione, 1-[4-(phenylthio)-2-(O-benzoyloxime)], sulfonic acid esters and cyclic active ester compounds. Specifically, Compounds 1 to 21 described in Examples of JP-A-2000-80068 are preferred.

Examples of the onium salts include an aromatic diazonium salt, an aromatic iodonium salt and an aromatic sulfonium salt. Examples of the borate salts include ion complexes with a cationic coloring matter.

The active halogens specifically include compounds described, for example, in Wakabayashi et al., Bull Chem. Soc. Japan, Vol. 42, page 2924 (1969), U.S. Pat. No. 3,905,815, JP-A-5-27830, and M. P. Hutt, Journal of Heterocyclic Chemistry, Vol. 1 (No. 3), (1970), particularly an oxazole compound substituted by a trihalomethyl group, and an s-triazine compound. An s-triazine derivative in which at least one mono-, di- or tri-halogen-substituted methyl group is bonded to the s-triazine ring, is more suitable. Specifically, S-triazine and oxathiazole compounds are known, and examples thereof include 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)aminophenyl-4,6-bis(trichloromethyl)-s-triazine and 2-trihalomethyl-5-(p-methoxyphenyl)-1,3,4-oxadiazole. Specific preferred examples thereof include compounds described at pp. 14-30 of JP-A-58-15503 and pp. 6-10 of JP-A-55-77742, compound Nos. 1 to 8 described at page 287 of JP-B-60-27673 (the term “JP-B” as used herein means an “examined Japanese patent publication”), compound Nos. 1 to 17 described at pp. 443-444 of JP-A-60-239736, and compound Nos. 1 to 19 described in U.S. Pat. No. 4,701,399.

Specific examples of the active halogens are as follows.

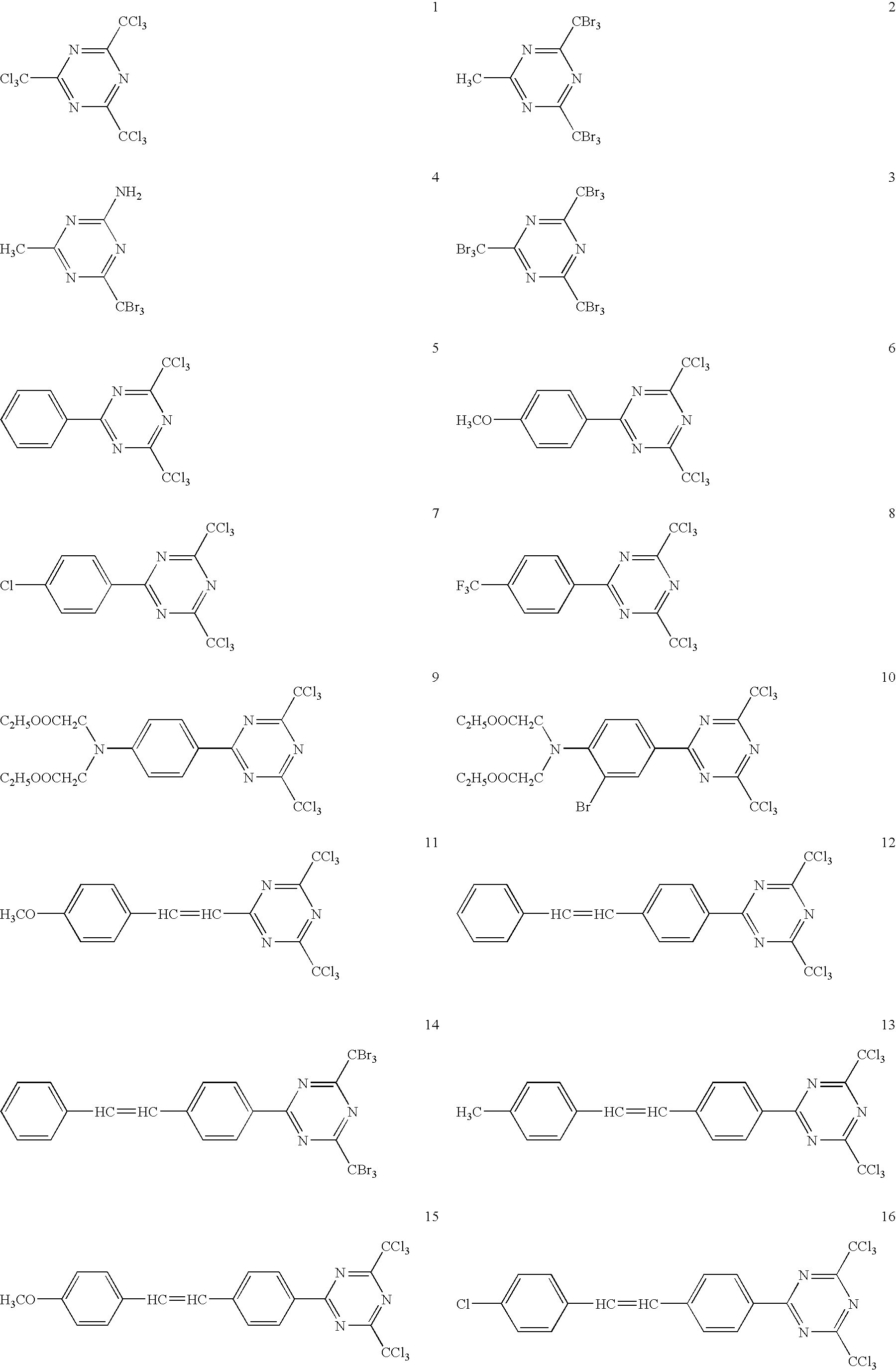

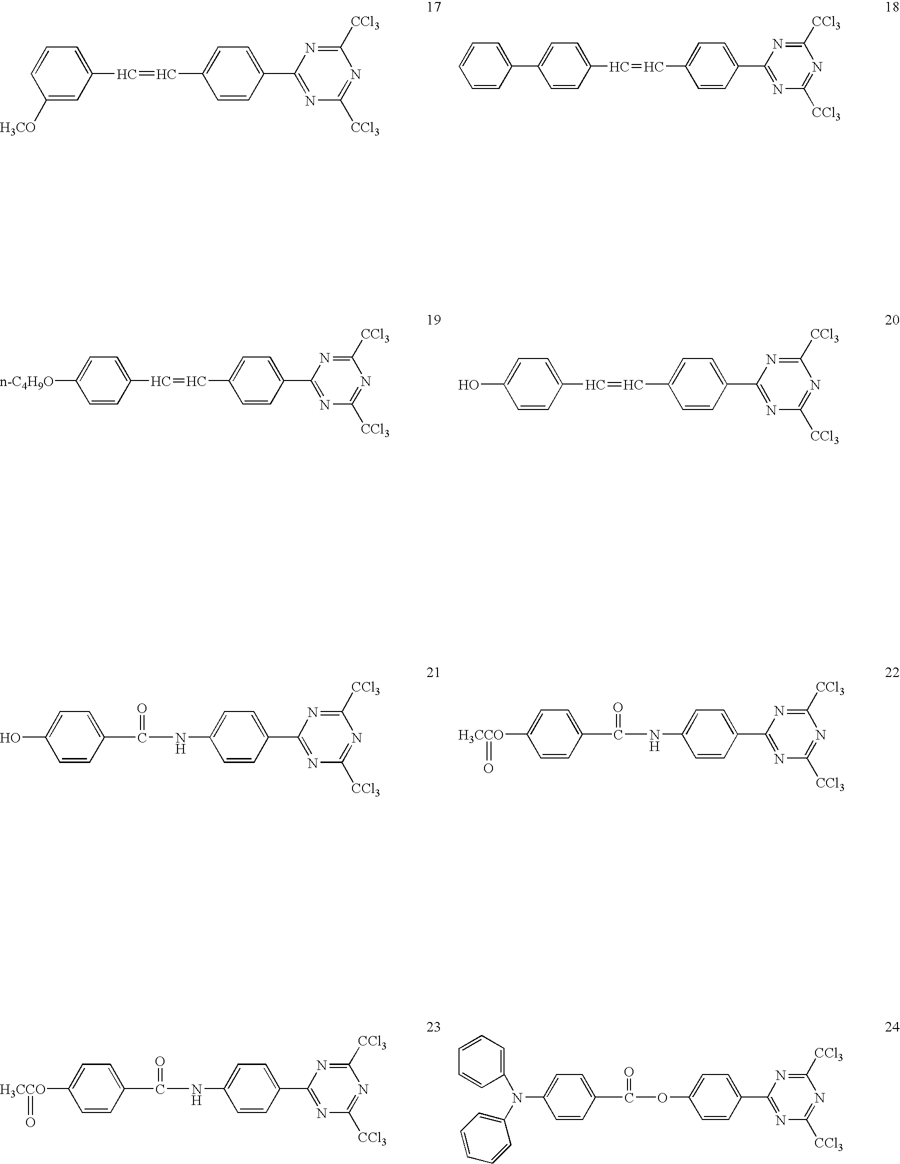

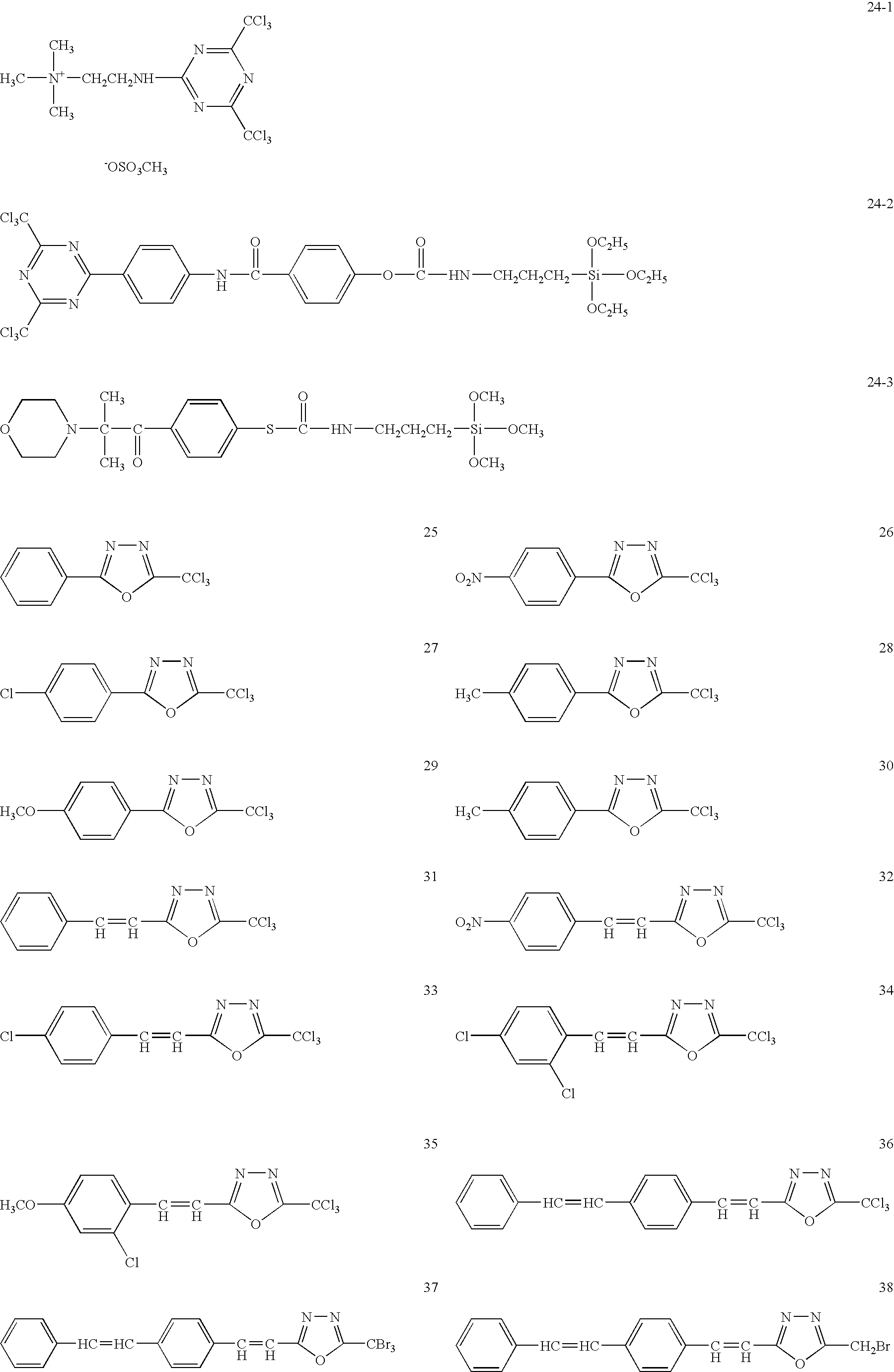

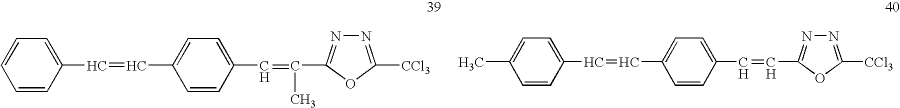

Examples of the inorganic complexes include bis-(η⁵-2,4-cyclopentadien-1-yl)-bis[2,6-difluoro-3-(1H-pyrrol-1-yl)-phenyl]titanium. Examples of the coumarins include 3-ketocoumarin.

These initiators may be used individually or as a mixture.

In the present invention, the compound having a high molecular weight and less volatilizable from the coating film is preferably an oligomer-type polymerization initiator. The oligomer-type radiation polymerization initiator is not particularly limited as long as it has a site which generates a photoradical upon irradiation with radiation. For preventing volatilization due to heat treatment, the molecular weight of the polymerization initiator is preferably from 250 to 10,000, more preferably from 280 to 10,000. Still more preferably, the mass average molecular weight is from 400 to 10,000. When the mass average molecular weight is 400 or more, the volatility is low and this is preferred, and when the mass average molecular weight is 10,000 or less, a cured film having sufficiently high hardness can be advantageously obtained. Specific examples of the oligomer-type radiation polymerization initiator include oligo[2-hydroxy-2-methyl-1-{4-(1-methylvinyl)phenyl}propanone] represented by the following formula (5).

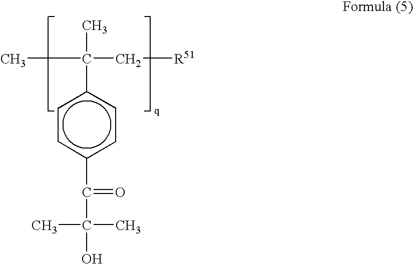

In formula (5), R⁵¹ represents a monovalent group, preferably a monovalent organic group, and q represents an integer of 2 to 45.

Examples of the commercial product for the oligo[2-hydroxy-2-methyl-1-{4-(1-methylvinyl)phenyl}propanone] represented by formula (5) include “Esacure KIP150” (CAS-No. 163702-01-0, q=4 to 6), “Esacure KIP65LT” (a mixture of “Esacure KIP150” and tripropylene glycol diacrylate), “Esacure KIP100F” (a mixture of “Esacure KIP150” and 2-hydroxy-2-methyl-1-phenylpropan-1-one), “Esacure KT37”, “Esacure KT55 (both a mixture of “Esacure KIP150” and a methyl benzophenone derivative), “Esacure KTO46 (a mixture of “Esacure KIP150”, a methyl benzophenone derivative and 2,4,6-trimethylbenzoyldiphenylphosphine oxide), and “Esacure KIP75/B” (a mixture of “Esacure KIP150” and 2,2-dimethoxy-1,2-diphenylethan-1-one), trade names, produced by Fratelli Lamberti.

Various examples are also described in Saishin UV Koka Gijutsu (Latest UV Curing Technologies), page 159, Technical Information Institute Co., Ltd. (1991), and Kiyomi Kato, Shigaisen Koka System (Ultraviolet Curing System), pp. 65-148, Sogo Gijutsu Center (1989), and these are useful in the present invention.

Preferred examples of the commercially available photoradical polymerization initiator of photo-cleavage type include “Irgacure 651”, “Irgacure 184”, “Irgacure 819”, “Irgacure 907”, “Irgacure 1870” (a 7/3 mixed initiator of CGI-403/Irg184), “Irgacure 500”, “Irgacure 369”, “Irgacure 1173”, “Irgacure 2959”, “Irgacure 4265”, “Irgacure 4263” and “OXE01” produced by Ciba Specialty Chemicals; “KAYACURE DETX-S”, “KAYACURE BP-100”, “KAYACURE BDMK”, “KAYACURE CTX”, “KAYACURE BMS”, “KAYACURE 2-EAQ”, “KAYACURE ABQ”, “KAYACURE CPTX”, “KAYACURE EPD”, “KAYACURE ITX”, “KAYACURE QTX”, “KAYACURE BTC” and “KAYACURE MCA” produced by Nippon Kayaku Co., Ltd.; “Esacure (KIP100F, KB1, EB3, BP, X33, KT046, KT37, KIP150, TZT)” produced by Sartomer Company, Inc.; and a mixture thereof.

The photopolymerization initiator is preferably used in an amount of 0.1 to 15 parts by mass, more preferably from 1 to 10 parts by mass, per 100 parts by mass of the binder.

In addition to the photopolymerization initiator, a photosensitizer may be used. Specific examples of the photosensitizer include n-butylamine, triethylamine, tri-n-butylphosphine, Michler's ketone and thioxanthone. Furthermore, one or more auxiliary agents such as azide compound, thiourea compound and mercapto compound may be used in combination.

Examples of the commercially available photosensitizer include “KAYACURE (DMBI, EPA)” produced by Nippon Kayaku Co., Ltd.

### (Thermal Radical Initiator)

As for the thermal radical initiator, an organic or inorganic peroxide, an organic azo or diazo compound, or the like may be used.

More specifically, examples of the organic peroxide include benzoyl peroxide, halogen benzoyl peroxide, lauroyl peroxide, acetyl peroxide, dibutyl peroxide, cumene hydroperoxide and butyl hydroperoxide; examples of the inorganic peroxide include hydrogen peroxide, ammonium persulfate and potassium persulfate; examples of the azo compound include 2,2′-azobis(isobutyronitrile), 2,2′-azobis(propionitrile) and 1,1′-azobis(cyclohexanecarbonitrile); and examples of the diazo compound include diazoaminobenzene and p-nitrobenzenediazonium.

The thermal radical initiator is preferably used in an amount of 0.1 to 15 parts by mass, more preferably from 1 to 10 parts by mass, per 100 parts by mass of the binder.

### (Cationic Polymerization Initiator)

Examples of the cationic polymerization initiator include a proton acid such as toluene sulfonic acid and methane sulfonic acid; a quaternary ammonium salt such as triethylbenzylammonium chloride and tetramethylammonium chloride; a tertiary amine such as benzyl dimethylamine, tributylamine and tris(dimethylamino)methylphenol; an imidazole compound such as 2-methyl-4-ethylimidazole and 2-methylimidazole; a compound capable of decomposing under heating to generate a proton acid, such as toluenesulfonic acid cyclohexyl ester and toluenesulfonic acid isopropyl ester; and various compounds capable of generating an acid catalyst under the action of light, which are described below. In the present invention, particularly from the standpoint of pot life of the film-forming composition, a compound capable of generating an acid under the action of light is preferred.

As for the compound capable of generating an acid under the action of light, various examples are described, for example, in Imaging-yo Yuki Zairyo (Organic Materials for Imaging), pp. 187-198, compiled by The Japanese Research Association for Organic Electronics Materials, Bunshin Shuppan, and JP-A-10-282644, and these known compounds may be used. Specific examples thereof include various onium salts such as diazonium salt, ammonium salt, phosphonium salt, iodonium salt, sulfonium salt, selenonium salt and arsonium salt, with the counter ion being RSO₃⁻ (wherein R represents an alkyl group or an aryl group), AsF₆⁻, SbF₆⁻, PF₆⁻, BF₄⁻ or the like; an organohalide such as oxadiazole and S-triazine derivatives substituted by a trihalomethyl group; o-nitrobenzyl, benzoin and imino esters of organic acid; and a disulfone compound. Among these, onium salts are preferred, and sulfonium salts and iodonium salts are more preferred.

In combination with the compound capable of generating an acid under the action of light, a sensitizing dye may be preferably used.

In general, the amount added of the compound capable of initiating cationic polymerization under the action of heat or light is, similarly to the radical initiator, from 0.1 to 15 mass %, more preferably from 0.5 to 10 mass %, still more preferably from 2 to 5 mass %, based on the entire solid content of the low refractive index layer-forming composition.

### 1-(6) Curing Catalyst

In the reaction of the fluorine-containing compound containing a hydroxyl group with the curing agent, a curing catalyst described below is preferably used. In this system, the curing is more accelerated by an acid and therefore, an acidic substance is preferably added to the curable resin composition. However, if a normal acid is added, the crosslinking reaction proceeds even in the coating solution and this give rise to a failure (e.g., unevenness, repelling). Accordingly, in order to satisfy both the storage stability and the curing activity in the thermal curing system, it is more preferred that a compound capable of generating an acid by the effect of heat is added as the curing catalyst.

The curing catalyst is preferably a salt comprising an acid and an organic base. Examples of the acid include an organic acid such as sulfonic acid, phosphonic acid and carboxylic acid, and an inorganic acid such as sulfuric acid and phosphoric acid. In view of compatibility with the polymer, an organic acid is more preferred, a sulfonic acid and a phosphonic acid are still more preferred, and a sulfonic acid is most preferred. Preferred examples of the sulfonic acid include p-toluenesulfonic acid (PTS), benzenesulfonic acid (BS), p-dodecylbenzenesulfonic acid (DBS), p-chlorobenzenesulfonic acid (CBS), 1,4-naphthalenedisulfonic acid (NDS), methanesulfonic acid (MsOH) and nonafluorobutane-1-sulfonic acid (NFBS), and these all are preferably used (abbreviations are shown in parentheses).

The curing catalyst greatly varies depending on the basicity and boiling point of the organic base combined with the acid. The curing catalyst preferably used in the present invention from respective standpoints is described below.

The acid generation efficiency at the heating is higher as the basicity of the organic base is lower, and this is preferred in view of curing activity, but if the basicity is too low, the storage stability becomes insufficient. Accordingly, an organic base having appropriate basicity is preferably used. When the basicity is expressed by using, as an index, pKa of the conjugated acid, the pKa of the organic base used in the present invention needs to be from 5.0 to 10.5 and is preferably from 6.0 to 10.0, more preferably from 6.5 to 10.0. As for the pKa value of the organic base, the values in an aqueous solution are described in Kagaku Binran (Chemical Handbook), Kiso-Hen (Basic Edition), 5th Rev. Ed., Vol. 2, pp. II-334-340, compiled by The Chemical Society of Japan, Maruzene (2004), and an organic base having an appropriate pKa can be selected therefrom. Even when not described in this publication, a compound estimated to have an appropriate pKa from its structure can also be preferably used. Compounds having an appropriate pKa described in the publication are shown in the Table below, but the compounds which can be preferably used in the present invention are not limited thereto.

TABLE 2
pKa

| | | |
|---|---|---|
| b-1 | N,N-dimethylaniline | 5.1 |
| b-2 | benzimidazole | 5.5 |
| b-3 | pyridine | 5.7 |
| b-4 | 3-methylpyridine | 5.8 |
| b-5 | 2,9-dimethyl-1,10-phenanthroline | 5.9 |
| b-6 | 4,7-dimethyl-1,10-phenanthroline | 5.9 |
| b-7 | 2-methylpyridine | 6.1 |
| b-8 | 4-methylpyridine | 6.1 |
| b-9 | 3-(N,N-dimethylamino)pyridine | 6.5 |
| b-10 | 2,6-dimethylpyridine | 7.0 |
| b-11 | imidazole | 7.0 |
| b-12 | 2-methylimidazole | 7.6 |
| b-13 | N-ethylmorpholine | 7.7 |
| b-14 | N-methylmorpholine | 7.8 |
| b-15 | bis(2-methoxyethyl)amine | 8.9 |
| b-16 | 2,2′-iminodiethanol | 9.1 |
| b-17 | N,N-dimethyl-2-aminoethanol | 9.5 |
| b-18 | trimethylamine | 9.9 |
| b-19 | triethylamine | 10.7 |

The acid generation efficiency at the heating is higher as the boiling point of the organic base is lower, and this is preferred in view of curing activity. Accordingly, an organic base having appropriate boiling point is preferably used. The boiling point of the base is preferably 120° C. or less, more preferably 80° C. or less, still more preferably 70° C. or less.

Examples of the organic base which can be preferably used in the present invention include, but are not limited to, the following compounds. The boiling points are shown in parentheses.

b-3: pyridine (115° C.), b-14: 4-methylmorpholine (115° C.), b-20: diallylmethylamine (111° C.), b-19: triethylamine (88.8° C.), b-21: tert-butylmethylamine (67 to 69° C.), b-22: dimethylisopropylamine (66° C.), b-23: diethylmethylamine (63 to 65° C.), b-24: dimethylethylamine (36 to 38° C.), and b-1 8: trimethylamine (3 to 5° C.).

The boiling point of the organic base for use in the present invention is from 35 to 85° C. If the boiling temperature exceeds this range, the scratch resistance may be worsened, whereas if it is less than 35° C., the coating solution become unstable. The boiling point is preferably from 45 to 80° C., and most preferably from 55 to 75° C.

In use as the acid catalyst of the present invention, a salt comprising the acid and the organic base may be isolated and used or after mixing the acid and the organic base to form a salt in a solution, the solution may be used. For both the acid and the organic base, one species may be used alone or a plurality of species may be mixed and used. In mixing the acid and the organic base, the equivalent ratio between the acid and the organic base mixed is preferably 1:0.9 to 1.5, more preferably 1:0.95 to 1.3, still more preferably 1:1.0 to 1.1.

The proportion of the acid catalyst used is preferably from 0.01 to 10 parts by mass, more preferably from 0.1 to 5 parts by mass, still more preferably from 0.2 to 3 parts by mass, per 100 parts by mass of the fluorine-containing polymer in the curable resin composition.

### <Photosensitive Acid Generator, Photoacid Generator>

In the present invention, in addition to the thermal acid generator, a compound capable of generating an acid upon irradiation with light, that is, a photosensitive acid generator may be further added. The photoacid generator which can be used in the present invention is described in detail below.

Examples of the photoacid generator include known compounds such as a photoinitiator for photocationic polymerization, a photo-decoloring agent for coloring matters, a photo-discoloring agent and known acid generators used for microresist or the like, and a mixture thereof. The photosensitive acid generator is a substance capable of imparting photosensitivity to a coating film of the curable resin composition and allowing the coating film to be photocured, for example, by irradiating radiation such as light. Examples of the photosensitive acid generator include (1) various onium salts such as iodonium salt, sulfonium salt, phosphonium salt, diazonium salt, ammonium salt, iminium salt, arsonium salt, selenonium salt and pyridinium salt; (2) sulfone compounds such as β-ketoester, β-sulfonylsulfone and their α-diazo compound; (3) sulfonic acid esters such as alkylsulfonic acid ester, haloalkylsulfonic acid ester, arylsulfonic acid ester and imino sulfonate; (4) sulfonimide compounds; and (5) diazomethane compounds, and these can be appropriately used. Among these, a diazonium salt, an iodonium salt, a sulfonium salt and an iminium salt are preferred in view of photosensitivity at the initiation of photopolymerization, material stability of the compound, and the like. Examples thereof include compounds described in paragraphs [0058] to [0059] of JP-A-2002-29162.

The photosensitive acid generators may be used individually or in combination of two or more thereof and may also be used in combination with the above-described thermal acid generator. The proportion of the photosensitive acid generator used is preferably from 0 to 20 parts by mass, more preferably from 0.1 to 10 parts by mass, per 100 parts by mass of the fluorine-containing polymer in the curable resin composition. When the proportion of the photosensitive acid generator is not more than the above-described upper limit, the cured film obtained can have excellent strength and good transparency and this is preferred.

The photosensitive acid generator can be used also in a layer other than the low refractive index layer, for example, in a hardcoat layer and at this time, the proportion of the photosensitive acid generator used is preferably 0.01 to 10 parts by mass, more preferably from 0.1 to 5 parts by mass, per 100 parts by mass of the curable resin composition.

As for specific compounds and use methods, those described, for example, in JP-A-2005-43876 can be used.

### 1-(7) Physical Properties of Low Refractive Index Layer

The refractive index of the low refractive index layer for use in the present invention is preferably from 1.20 to 1.35, more preferably from 1.25 to 1.35, and most preferably from 1.26 to 1.30. Within this refractive index range, both the low reflection and the scratch resistance can be satisfied.

The thickness of the low refractive index layer is preferably from 50 to 200 nm, more preferably from 70 to 110 nm. The haze of the low refractive index layer is preferably 3% or less, more preferably 2% or less, and most preferably 1% or less. The strength of the low refractive index layer is specifically, in the pencil hardness test with a load of 500 g, preferably H or more, more preferably 2H or more, and most preferably 3H or more.

In order to improve the antifouling performance of the optical film, the contact angle with water of the surface is preferably 90° or more, more preferably 95° or more, still more preferably 1000 or more.

### 1-(8) Curing Conditions of Low Refractive Index Layer

In the present invention, curing conditions suitable for the curable functional group of each component used in the low refractive index layer can be selected.

Preferred cases are described below.

### (A) System where a Fluorine-Containing Compound Containing a Hydroxyl Group and a Compound Capable of Reacting with the Hydroxy Group are Used in Combination

The curing temperature is preferably from 60 to 200° C., more preferably from 80 to 130° C., and most preferably from 80 to 110° C. In the case where the support is liable to deteriorate at high temperature, the curing temperature is preferably low. The time required for heat curing is preferably from 30 seconds to 60 minutes, more preferably from 1 to 20 minutes.

Particularly, in the case where the underlying surface is an optical film constituent layer containing ionizing radiation-curable (meth)acrylate group, the interface bonding can be strengthened by adding a (meth)acrylate group-containing compound to the low refractive index layer. Preferred curing conditions are described later together with those in the system (B) below.

### (B) System Using a Fluorine-Containing Compound Containing a (meth)acrylate Group

In the case where the fluorine-containing compound contains a (meth)acrylate group, from the standpoint of enhancing the strength of the coating film, a compound containing a (meth)acrylate group is preferably further used together in the low refractive index layer. It is effective to perform the curing by combining irradiation of ionizing radiation and a heat treatment before, simultaneous with or after the irradiation.

Several patterns of the production process are set forth below, but the present invention is not limited thereto.

| | Before Irradiation | Simultaneous with Irradiation | After Irradiation |
|---|---|---|---|
| (1) | heat treatment→ | ionizing radiation curing→ | — |
| (2) | heat treatment→ | ionizing radiation curing→ | heat treatment |
| (3) | — → | ionizing radiation curing→ | heat treatment |

(“—” indicates that heat treatment is not performed)

In addition, a process of performing a heat treatment simultaneously with the ionizing radiation curing is also preferred.

### (Heat Treatment)

In the present invention, as described above, a heat treatment is preferably performed in combination with irradiation of ionizing radiation. The heat treatment is not particularly limited as long as it does not impair the support and constituent layers including the low refractive index layer of the optical film, but is preferably from 60 to 200° C., more preferably from 80 to 130° C., and most preferably from 80 to 110° C.

By elevating the temperature, the orientation or distribution of each component in the coating film may be adjusted or the photocuring reaction may be controlled. Before curing by the irradiation of ionizing radiation or under heat, the components each is not immobilized and orientation of each component relatively swiftly occurs, whereas after the initiation of curing, the components each is immobilized and orientation occurs only partially. The time required for the heat treatment varies depending on the molecular weight of the component used, the interaction with other components, the viscosity and the like but is from 30 seconds to 24 hours, preferably from 60 seconds to 5 hours, and most preferably from 3 to 30 minutes.

The method for elevating the film surface temperature to the desired temperature is not particularly limited but, for example, a method of contacting the film with a heated roll, a method of blowing heated nitrogen, or a method of irradiating far infrared light or infrared light is preferred. A method of performing the heating by flowing warm water or steam in a rotating metal roll described in Japanese Patent 2523574 may also be used. On the other hand, in the case where the film surface temperature is elevated at the irradiation of ionizing radiation described blow, a method of contacting a cooled roll with the film may also be used.

### (Ionizing Radiation-Irradiating Conditions)

The film surface temperature at the irradiation of ionizing radiation is not particularly limited but in view of handling property and uniformity of performance in the plane, is generally from 20 to 200° C., preferably from 30 to 150° C., and most preferably from 40 to 120° C. When the film surface temperature is not more than the above-described upper limit, this is preferred because there is not caused a problem that the flowability of the low molecular component in the binder excessively increases to worsen the surface state or the support is damaged due to heat. Also, when the film surface temperature is not lower than the above-describe lower limit, this is preferred because the curing reaction proceeds satisfactorily and the film can have good scratch resistance.

The species of the ionizing radiation is not particularly limited and examples thereof include X-ray, electron beam, ultraviolet ray, visible light and near infrared ray. An ultraviolet ray is widely used. For example, in the case where the coating film is ultraviolet-curable, each layer is preferably cured by irradiating an ultraviolet ray at an irradiation dose of 10 to 1,000 mJ/cm² from an ultraviolet lamp. At the irradiation, of the above-described energy may be applied at a time or the light may be irradiated in parts. In view of reducing the fluctuation of performance in the plane of coating film, it is also preferred to irradiate the light approximately in 2 to 8 divided doses.

The time for which the film after irradiation of ionizing radiation is kept at the above-described temperature is preferably from 0.1 to 300 seconds, more preferably from 0.1 to 10 seconds. If the time for which the film surface temperature is kept at the above-described temperature is too short, the reaction of the coating composition for the formation of low refractive index layer cannot be promoted, whereas if it is too long, there arises a problem in view of production, such as large equipment.

### (Oxygen Concentration)

The oxygen concentration at the irradiation of ionizing radiation is preferably 3 vol % or less, more preferably 1 vol % or less, still more preferably 0.1 vol % or less. When a step of maintaining the film in an atmosphere having an oxygen concentration of 3 vol % or less is provided immediately before or immediately after the step of irradiating ionizing radiation at an oxygen concentration of 3 vol % or less, the curing of the film can be satisfactorily promoted and a film excellent in the physical strength and chemical resistance can be formed.

The heat treatment step before, simultaneous with or after the irradiation of ionizing radiation may be performed in an air atmosphere, but it is also preferred to perform the heat treatment by reducing the oxygen concentration similarly to that at the irradiation of ionizing radiation. In particular, when the thermal stability of a polymerization initiator, a polymerizable compound or the like is insufficient, the strength of the film after the completion of all curing steps can be kept high by performing the heat treatment after reducing the oxygen concentration.

As for the means to reduce the oxygen concentration, replacement of the atmospheric air (nitrogen concentration: about 79 vol %, oxygen concentration: about 21 vol %) with another gas is preferred, and replacement with nitrogen (nitrogen purging) is more preferred. When the film is transported in an atmosphere of low oxygen concentration before the step of irradiating ionizing radiation, the oxygen concentration on the surface and in the inside of the coating film and curing can be promoted. In the transportation step before irradiation of ionizing radiation, the oxygen concentration is preferably 3 vol % or less, more preferably 1 vol % or less, still more preferably 0.1 vol % or less.

### 1-(9) Layer Construction of Antireflection Film

The optical film of the present invention is not particularly limited in its usage but is preferably an antireflection film. The antireflection film has, if desired, a hardcoat layer described later on a transparent substrate (hereinafter sometimes referred to as a “support”) and further has an antistatic layer as one preferred constituent layer, and one or more antireflection layers are stacked thereon by taking into account the refractive index, film thickness, number of layers, order of layers, and the like so as to reduce the reflectance by the effect of optical interference.

Generally, the simplest layer construction of the antireflection film is a construction that only a low refractive index layer is provided by coating on a substrate. In order to more reduce the reflectance, the antireflection layer is preferably constituted by combining a high refractive index layer having a refractive index higher than that of the substrate and a low refractive index layer having a refractive index lower than that of the substrate. Examples of the construction include a two-layer construction of high refractive index layer/low refractive index layer from the substrate side, and a construction formed by stacking three layers differing in the refractive index in the order of a middle refractive index layer (a layer having a refractive index higher than that of the substrate or hardcoat layer but lower than that of the high refractive index layer)/a high refractive index layer/a low refractive index layer. Also, a construction where a larger number of antireflection layers are stacked has been proposed. In view of the durability, optical property, cost, productivity and the like, it is preferred to coat a middle refractive index layer/a high refractive index layer/a low refractive index layer in this order on a substrate having thereon a hardcoat layer.

Preferred examples of the layer construction of the antireflection film of the present invention include the followings. In the constructions below, the substrate film functions as a support. Also, in the following constructions, when (antistatic layer) is annexed, this means that the layer having other functions has an antistatic layer function in combination. By designing the antistatic layer to have a function other than the antistatic function, the number of layers formed can be decreased and therefore, this construction is assured of higher productivity and is preferred.

### (Preferred Layer Constructions of Antireflection Film of the Present Invention)

Substrate film/antistatic layer/low refractive index layer
Substrate film/low refractive index layer (antistatic layer)
Substrate film/antiglare layer (antistatic layer)/low refractive index layer
Substrate film/antiglare layer/antistatic layer/low refractive index layer
Substrate film/hardcoat layer/antiglare layer (antistatic layer)/low refractive index layer
Substrate film/hardcoat layer/antiglare layer/antistatic layer/low refractive index layer
Substrate film/hardcoat layer/antistatic layer/antiglare layer/low refractive index layer
Substrate film/hardcoat layer (antistatic layer)/antiglare layer/low refractive index layer
Substrate film/hardcoat layer/high refractive index layer/antistatic layer/low refractive index layer
Substrate film/hardcoat layer/high refractive index layer (antistatic layer)/low refractive index layer
Substrate film/hardcoat layer/antistatic layer/high refractive index layer/low refractive index layer
Substrate film/hardcoat layer/medium refractive index layer/high refractive index layer (antistatic layer)/low refractive index layer
Substrate film/hardcoat layer/medium refractive index layer (antistatic layer)/high refractive index layer/low refractive index layer
Substrate film/hardcoat layer (antistatic layer)/medium refractive index layer/high refractive index layer/low refractive index layer
Substrate film/antiglare layer/high refractive index layer (antistatic layer)/low refractive index layer
Substrate film/antiglare layer/medium refractive index layer (antistatic layer)/high refractive index layer/low refractive index layer
Substrate film/antistatic layer/hardcoat layer/medium refractive index layer/high refractive index layer/low refractive index layer
Antistatic layer/substrate film/hardcoat layer/medium refractive index layer/high refractive index layer/low refractive index layer
Substrate film/antistatic layer/antiglare layer/medium refractive index layer/high refractive index layer/low refractive index layer
Antistatic layer/substrate film/antiglare layer/medium refractive index layer/high refractive index layer/low refractive index layer
Antistatic layer/substrate film/antiglare layer/high refractive index layer/low refractive index layer/high refractive index layer/low refractive index layer

Insofar as the reflectance can be reduced by the optical interference, the layer construction is not particularly limited only to these layer constructions. The antistatic layer is preferably a layer containing an electrically conducting polymer particle or a metal oxide fine particle {for example, antimony-doped tin oxide (ATO) or a tin-doped indium oxide (ITO)} and can be provided by coating, atmospheric plasma treatment or the like.

### 2. Constituents of the Present Invention

Various compounds which can be used in the film of the present invention are described below.

### 2-(1) Binder

The film of the present invention can be formed by a crosslinking or polymerization reaction of an ionizing radiation-curable compound. That is, a coating composition containing an ionizing radiation-curable polyfunctional monomer or oligomer as a binder is coated on a transparent support, and a crosslinking or polymerization reaction of the polyfunctional monomer or oligomer is brought about, whereby the film of the present invention can be formed.

The functional group in the ionizing radiation-curable polyfunctional monomer or oligomer is preferably a photo-, electron beam- or radiation-polymerizable functional group, more preferably a photopolymerizable functional group.

Examples of the photopolymerizable functional group include an unsaturated polymerizable functional group such as (meth)acryloyl group, vinyl group, styryl group and allyl group, with a (meth)acryloyl group being preferred. In particular, the following compounds each containing two or more (meth)acryloyl groups within one molecule may be preferably used.

Specific examples of the photopolymerizable polyfunctional monomer having a photopolymerizable functional group include:

(meth)acrylic acid diesters of alkylene glycol, such as neopentyl glycol acrylate, 1,6-hexanediol (meth)acrylate and propylene glycol di(meth)acrylate;

(meth)acrylic acid diesters of polyoxyalkylene glycol, such as triethylene glycol di(meth)acrylate, dipropylene glycol di(meth)acrylate, polyethylene glycol di(meth)acrylate and polypropylene glycol di(meth)acrylate;

(meth)acrylic acid diesters of polyhydric alcohol, such as pentaerythritol di(meth)acrylate; and

(meth)acrylic acid diesters of ethylene oxide or propylene oxide adduct, such as 2,2-bis {4-(acryloxy.diethoxy)phenyl}propane and 2-2-bis{4-(acryloxy.poly-propoxy)phenyl}propane.

Furthermore, epoxy(meth)acrylates, urethane(meth)acrylates and polyester(meth)acrylates may also be preferably used as the photopolymerizable polyfunctional monomer.

Among these, esters of a polyhydric alcohol and a (meth)acrylic acid are preferred, and a polyfunctional monomer having three or more (meth)acryloyl groups within one molecule is more preferred. Specific examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentaacrylate, (di)pentaerythritol tetra(meth)acrylate, (di)pentaerythritol hexa(meth)acrylate, tripentaerythritol triacrylate and tripentaerythritol hexatriacrylate. The terms “(meth)acrylate”, “(meth)acrylic acid” and “(meth)acryloyl” as used in the present invention mean “acrylate or methacrylate”, “acrylic acid or methacrylic acid” and “acryloyl or methacryloyl”, respectively.

As for the monomer binder, monomers differing in the refractive index may be used for controlling the refractive index of each layer. In particular, examples of the high refractive index monomer include bis(4-methacryloylthiophenyl)sulfide, vinylnaphthalene, vinyl phenyl sulfide and 4-methacryloxyphenyl-4′-methoxyphenylthioether.

Furthermore, dendrimers described, for example, in JP-A-2005-76005 and JP-A-2005-36105, and norbornene ring-containing monomers described, for example, in JP-A-2005-60425 may also be used.

Two or more kinds of polyfunctional monomers may be used in combination.

The polymerization of such a monomer having an ethylenically unsaturated group may be performed by the irradiation of ionizing radiation or under heating, in the presence of a photoradical initiator or a thermal radical initiator.

In the polymerization reaction of the photopolymerizable polyfunctional monomer, a photopolymerization initiator is preferably used, and the photopolymerization initiator is preferably a photoradical polymerization initiator or a photocationic polymerization initiator, more preferably a photoradical polymerization initiator.

### 2-(2) Light-Transparent Particle

In the film of the present invention, particularly, in the antiglare layer or hardcoat layer, various light-transparent particles can be used so as impart antiglare property (surface scattering property) or internal scattering property. It is also preferred to use the light-transparent particle in a layer containing the electrically conducting particle with the particle inside being porous or hollow of the present invention.

The light-transparent particle may be an organic particle or an inorganic particle. As the particle size fluctuation is smaller, the scattering property less fluctuates and the design of haze value is more facilitated. The light-transparent particle is suitably a plastic bead, and those having high transparency and having a refractive index of which difference from the binder takes a numerical value described above are preferred.

Example of the organic particle which is used here include a polymethyl methacrylate particle (refractive index: 1.49), a crosslinked poly(acryl-styrene) copolymer particle (refractive index: 1.54), a melamine resin particle (refractive index: 1.57), a polycarbonate particle (refractive index: 1.57), a polystyrene particle (refractive index: 1.60), a crosslinked polystyrene particle (refractive index: 1.61), a polyvinyl chloride particle (refractive index: 1.60) and a benzoguanamine-melamine formaldehyde particle (refractive index: 1.68).

Examples of the inorganic particle include a silica particle (refractive index: 1.44), an alumina particle (refractive index: 1.63), a zirconia particle, a titania particle and an inorganic particle having a hollow or pores.

Among these, a crosslinked polystyrene particle, a crosslinked poly((meth)acrylate) particle and a crosslinked poly(acryl-styrene) particle are preferred. By adjusting the refractive index of the binder in accordance with the refractive index of the light-transparent particle selected from those particles, the internal haze, surface haze and centerline average roughness of the present invention can be achieved.

Furthermore, a combination of a binder (refractive index after curing: from 1.50 to 1.53) comprising a trifunctional or greater (meth)acrylate monomer as a main component and a light-transparent particle comprising a crosslinked poly(meth)acrylate polymer having an acryl content of 50 to 100 wt % is preferred, and a combination of the binder and a light-transparent particle (refractive index: from 1.48 to 1.54) comprising a crosslinked poly((meth)acryl) copolymer is more preferred.

In the present invention, the binder (light-transparent resin) and the light-transparent particle preferably have a refractive index of from 1.45 to 1.70, more preferably from 1.48 to 1.65. The refractive index may be adjusted to fall in this range by appropriately selecting the kind and amount ratio of the binder and light-transparent particle. How to select can be easily known by previously performing an experiment.

Also, in the present invention, the difference of refractive index between the binder and the light-transparent particle (refractive index of light-transparent fine particle—refractive index of binder) is preferably, in terms of the absolute value, from 0.001 to 0.030, more preferably from 0.001 to 0.020, still more preferably from 0.001 to 0.015. If this difference exceeds 0.030, there arises a problem such as film character burring, reduction of dark-room contrast, or surface clouding.

Here the refractive index of the binder can be quantitatively evaluated, for example, by directly measuring the refractive index with an Abbe refractometer or by measuring the spectral reflection spectrum or spectral ellipsometry. The refractive index of the light-transparent particle is determined as follows. The light-transparent particle is dispersed in an equal amount in solvents prepared by changing the mixing ratio of two kinds of solvents differing in the refractive index and thereby varying the refractive index, the turbidity is measured, and the refractive index of the solvent when the turbidity becomes minimum is measured by an Abbe refractometer.

In the case of the above-described light-transparent particle, the light-transparent particle is liable to precipitate in the binder and therefore, an inorganic filler such as silica may be added to prevent precipitation. The inorganic filler added in a larger amount is more effective to prevent precipitation of the light-transparent particle, but this adversely affects the transparency of the coating film. Therefore, an inorganic filler having a particle diameter of 0.5 μm or less is preferably added in an amount on the order of less than 0.1 mass % to the binder to an extent of not impairing the transparency of the coating film.

The average particle diameter of the light-transparent particle is preferably from 0.5 to 20 μm, more preferably from 2.0 to 15.0 μm. If the average particle diameter is less than 0.5 μm, the scattering angle distribution of light expands to the wide field of view and this disadvantageously brings about character blurring on the display, whereas if it exceeds 20 μm, the layer to which the light-transparent particle is added needs to have a large thickness and there arises a problem such as curling or cost rise.

Two or more kinds of light-transparent particles differing in the particle diameter may be used in combination. The light-transparent particle having a larger particle diameter can impart antiglare property and the light-transparent particle having a smaller particle diameter can reduce the roughened texture on the surface.

The light-transparent particle is blended to account for 3 to 30 mass %, preferably from 5 to 20 mass %, in the entire solid content of the layer to which the light-transparent particle is added. If the proportion is less than 3 mass %, the addition effect is insufficient, whereas if it exceeds 30 mass %, there arises a problem such as image blurring or surface clouding or glaring.

The density of the light-transparent particle is preferably from 10 to 1,000 mg/m², more preferably from 100 to 700 mg/m².

### <Preparation and Classification of Light-Transparent Particle>

Examples of the production method of the light-transparent particle for use in the present invention include a suspension polymerization method, an emulsion polymerization method, a soap-free emulsion polymerization method, a dispersion polymerization method and a seed polymerization method, and any of these production methods may be employed. These methods may be performed by referring to the methods described, for example, in Takayuki Ohtsu and Masaetsu Kinoshita, Kobunshi Gosei no Jikken Ho (Experimental Technique for the Synthesis of Polymer), page 130 and pages 146 to 147, Kagaku Dojin Sha, Gosei Kobunshi (Synthetic Polymer), Vol. 1, pp. 246-290, ibid., Vol. 3, pp. 1-108, U.S. Pat. Nos. 2,543,503, 3,508,304, 2,746,275, 3,521,560 and 3,580,320, JP-A-10-1561, JP-A-7-2908, JP-A-5-297506 and JP-A-2002-145919.

As for the particle size distribution of the light-transparent particle, a monodisperse particle is preferred in view of the control of haze value and diffusing property and the homogeneity of coated surface state. For example, when a particle having a particle diameter 20% or more larger than the average particle diameter is defined as a coarse particle, the percentage by number of this coarse particle in all particles is preferably 1% or less, more preferably 0.1% or less, still more preferably 0.01% or less. For obtaining a particle having such a particle size distribution, classification after preparation or synthesis reaction is effective and by increasing the number of classifications or elevating the level of classification, a particle having a preferred distribution can be obtained.

The classification is preferably performed using a method such as air classification, centrifugal classification, precipitation classification, filtration classification and electrostatic classification.

### 2-(3) Inorganic Particle

In the present invention, various inorganic particles can be used for enhancing physical properties such as hardness, or optical properties such as reflectance and scattering.

The inorganic particle comprises an oxide of at least one metal selected from silicon, zirconium, titanium, aluminum, indium, zinc, tin and antimony. Specific examples thereof include ZrO₂, TiO₂, Al₂O₃, In₂O₃, ZnO, SnO₂, Sb₂O₃ and ITO. Other examples include BaSO₄, CaCO₃, talc and kaolin.

The inorganic particle for use in the present invention is preferably dispersed in a dispersion medium to have a particle diameter as small as possible. The mass average diameter is from 1 to 200 nm, preferably from 5 to 150 nm, more preferably from 10 to 100 nm, still more preferably from 10 to 80 nm. By finely dispersing the inorganic particle to 100 nm or less, a film of which transparency is not impaired can be formed. The particle diameter of the inorganic particle can be measured by a light-scattering method or an electron micrograph.

The specific surface area of the inorganic particle is preferably from 10 to 400 m²/g, more preferably from 20 to 200 m²/g, and most preferably from 30 to 150 m²/g.

The inorganic particle for use in the present invention is preferably dispersed in a dispersion medium and added as a dispersion to the coating solution for the layer in which the inorganic particle is used.

The dispersion medium for the inorganic particle is preferably a liquid having a boiling point of 60 to 170° C. Examples of the dispersion medium include water, an alcohol (e.g., methanol, ethanol, isopropanol, butanol, benzyl alcohol), a ketone (e.g., acetone, methyl ethyl ketone, methyl isobutyl ketone, cyclohexanone), an ester (e.g., methyl acetate, ethyl acetate, propyl acetate, butyl acetate, methyl formate, ethyl formate, propyl formate, butyl formate), an aliphatic hydrocarbon (e.g., hexane, cyclohexane), a halogenated hydrocarbon (e.g., methylene chloride, chloroform, carbon tetrachloride), an aromatic hydrocarbon (e.g., benzene, toluene, xylene), an amide (e.g., dimethylformamide, dimethylacetamide, n-methylpyrrolidone), an ether (e.g., diethyl ether, dioxane, tetrahydrofuran) and an ether alcohol (e.g., 1-methoxy-2-propanol). Among these, preferred are toluene, xylene, methyl ethyl ketone, methyl isobutyl ketone, cyclohexanone and butanol.

The dispersion medium is more preferably methyl ethyl ketone, methyl isobutyl ketone or cyclohexanone.

The inorganic particle is dispersed by using a disperser. Examples of the disperser include a sand grinder mill (e.g., bead mill with pin), a high-speed impeller mill, a pebble mill, a roller mill, an attritor and a colloid mill. Among these, a sand grinder mill and a high-speed impeller mill are preferred. Also, a preliminary dispersion treatment may be performed. Examples of the disperser for use in the preliminary dispersion treatment include a ball mill, a three-roll mill, a kneader and an extruder.

### <High Refractive Index Particle>

For the purpose of elevating the refractive index of the layer constituting the present invention, a cured product of a composition prepared by dispersing a high refractive index inorganic particle in a monomer, an initiator and an organic substituted silicon compound is preferably used.

In view of refractive index, the inorganic particle used here is preferably ZrO₂ or TiO₂. A ZrO₂ fine particle is most preferred for elevating the refractive index of the hardcoat layer, and a TiO₂ fine particle is most preferred as a particle for the high refractive index layer and the medium refractive index layer.

The TiO₂ particle is preferably an inorganic particle comprising TiO₂ as a main component and containing at least one element selected from cobalt, aluminum and zirconium. The “main component” means a component of which content (mass %) is largest among the components constituting the particle.

The particle comprising TiO₂ as a main component, for use in the present invention, preferably has a refractive index of 1.90 to 2.80, more preferably from 2.10 to 2.80, and most preferably from 2.20 to 2.80.

The mass average primary particle diameter of the particle comprising TiO₂ as a main component is preferably from 1 to 200 nm, more preferably from 1 to 150 nm, still more preferably from 1 to 100 nm, yet still more preferably from 1 to 80 nm.

As for the crystal structure of the particle comprising TiO₂ as a main component, the main component is preferably a rutile, rutile/anatase mixed crystal, anatase or amorphous structure, more preferably a rutile structure. The “main component” means a component of which content (mass %) is largest among the components constituting the particle.

By virtue of incorporating at least one element selected from Co (cobalt), Al (aluminum) and Zr (zirconium) into the particle comprising TiO₂ as a main component, the photocatalytic activity of TiO₂ can be suppressed and the weather resistance of the film of the present invention can be improved.

The element is preferably Co (cobalt). It is also preferred to use two or more kinds of elements in combination.

The inorganic particle comprising TiO₂ as a main component of the present invention may be surface-treated to have a core/shell structure as described in JP-A-2001-166104.

The amount of the monomer or inorganic particle added in the layer is preferably from 10 to 90 mass %, more preferably from 20 to 80 mass %, based on the entire mass of the binder. Two or more kinds of inorganic particles may be used in the layer.

### 2-(4) Antifouling Agent

In the film of the present invention, particularly, in the uppermost layer of the film, an appropriate known silicon-based or fluorine-based antifouling agent, slipping agent or the like is preferably added for the purpose of imparting properties such as antifouling property, water resistance, chemical resistance and slipperiness.

In the case of adding such an additive, the additive is preferably added in an amount of 0.01 to 20 mass %, more preferably from 0.05 to 10 mass %, still more preferably from 0.1 to 5 mass %, based on the entire solid content of the low refractive index layer.

### [Compound Having Polysiloxane Structure]

The compound having a polysiloxane structure is described below.

In the present invention, a compound having a polysiloxane structure is used for the purpose of imparting slipperiness and thereby enhancing the scratch resistance and antifouling property. The compound is not limited in its structure and examples thereof include those having a substituent at the terminal and/or in the side chain of a compound chain containing a plurality of dimethylsilyloxy units as a repeating unit. In the compound chain containing dimethylsilyloxy as a repeating unit, a structural unit other than dimethylsilyloxy may be contained.

The molecular weight of the compound having a polysiloxane structure is not particularly limited but is preferably 100,000 or less, more preferably 50,000 or less, and most preferably from 3,000 to 30,000.

From the standpoint of preventing transfer, the compound preferably contains a hydroxyl group or a functional group capable of reacting with a hydroxyl group to form a bond. This bond-forming reaction preferably proceeds swiftly under hating condition and/or in the presence of a catalyst. Examples of such a substituent include an epoxy group and a carboxyl group. Preferred examples of the compound include, but are not limited to, the followings.

### (Compound Containing Hydroxyl Group)

“X-22-160AS”, “KF-6001”, “KF-6002”, “KF-6003”, “X-22-170DX”, “X-22-176DX”, “X-22-176D” and “X-22-176F” {all produced by Shin-Etsu Chemical Co., Ltd.}; “FM-4411”, “FM-4421”, “FM-4425”, “FM-0411”, “FM-0421”, “FM-0425”, “FM-DA11”, “FM-DA21” and “FM-DA25” {all produced by Chisso Corporation}; and “CMS-626” and “CMS-222” {both produced by Gelest}.

### (Compound Containing a Functional Group Capable of Reacting with a Hydroxyl Group)

“X-22-162C” and “KF-105 ” {both produced by Shin-Etsu Chemical Co., Ltd.}; and “FM-5511”, “FM-5521”, “FM-5525”, “FM-6611”, “FM-6621” and “FM-6625” {all produced by Chisso Corporation}.

In addition to the above-described polysiloxane-based compound, another polysiloxane-based compound may be further used in combination. Preferred examples thereof include those having a substituent at the terminal and/or in the side chain of a compound chain containing a plurality of dimethylsilyloxy units as a repeating unit. In the compound chain containing dimethylsilyloxy as a repeating unit, a structural unit other than dimethylsilyloxy may be contained. A plurality of substituents, which may be the same or different, are preferably present. Preferred examples of the substituent include an acryloyl group, a methacryloyl group, a vinyl group, an aryl group, a cinnamoyl group, an oxetanyl group, a fluoroalkyl group, a polyoxyalkylene group, a carboxyl group and an amino group. The molecular weight is not particularly limited but is preferably 100,000 or less, more preferably 50,000 or less, still more preferably from 3,000 to 30,000, and most preferably from 10,000 to 20,000. The silicone atom content of the silicone-based compound is not particularly limited but is preferably 18.0 mass % or more, more preferably from 25.0 to 37.0 mass %, and most preferably from 30.0 to 37.0 mass %. Preferred examples of the silicone-based compound include, but are not limited to, X-22-174DX, X-22-2426, X-22-164B, X-22-164C and X-22-1821 (all trade names) produced by Shin-Etsu Chemical Co., Ltd.; FM-0725, FM-7725, FM6621 and FM-1121 produced by Chisso Corporation; and DMS-U22, RMS-033, RMS-083, UMS-182, DMS-H21, DMS-H31, HMS-301, FMS121, FMS123, FMS131, FMS141 and FMS221 (all trade names) produced by Gelest.

The fluorine-based compound used as an antifouling agent is preferably a compound having a fluoroalkyl group. The fluoroalkyl group preferably has a carbon number of 1 to 20, more preferably from 1 to 10, and may be linear (e.g., —CF₂CF₃, —CH₂(CF₂)₄H, —CH₂(CF₂)₈CF₃, —CH₂CH₂(CF₂)₄H), may have a branched structure (e.g., CH(CF₃)₂, CH₂CF(CF₃)₂, CH(CH₃)CF₂CF₃, CH(CH₃)(CF₂)₅CF₂H) or an alicyclic structure (preferably a 5- or 6-membered ring, for example, a perfluorocyclohexyl group, a perfluorocyclopentyl group or an alkyl group substituted by such a group) or may have an ether bond (e.g., CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H). A plurality of the fluoroalkyl groups may be contained within the same molecule.

The fluorine-based compound preferably further has a substituent which contributes to the bond formation or compatibility with the low refractive index layer film. A plurality of substituents, which may be the same or different, are preferably present. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group and an amino group. The fluorine-based compound may be a polymer or oligomer with a compound containing no fluorine atom, and the molecular weight is not particularly limited. The fluorine atom content of the fluorine-based compound is not particularly limited but is preferably 20 mass % or more, more preferably from 30 to 70 mass %, and most preferably from 40 to 70 mass %. Preferred examples of the fluorine-based compound include, but are not limited to, R-2020, M-2020, R-3833 and M-3833 (all trade names) produced by Daikin Kogyo Co., Ltd.; and Megafac F-171, F-172, F-179A and DYFENSA MCF-300 (all trade names) produced by Dai-Nippon Ink & Chemicals, Inc.

For the purpose of imparting properties such as dust protection and antistatic property, a known dust inhibitor, antistatic agent or the like, such as cationic surfactant or polyoxyalkylene-based compound, may be appropriately added. A structural unit of such a dust inhibitor or antistatic agent may be contained as a part of the function in the above-described silicone-based compound or fluorine-based compound. In the case of adding such an additive, the additive is preferably added in an amount of 0.01 to 20 mass %, more preferably from 0.05 to 10 mass %, still more preferably from 0.1 to 5 mass %, based on the entire solid content of the low refractive index layer. Preferred examples of the compound include, but are not limited to, Megafac F-1 50 (trade name) produced by Dai-Nippon Ink & Chemicals, Inc.; and SH-3748 (trade name) produced by Toray Dow Coming.

### 2-(5) Surfactant

In the film of the present invention, the coating composition for forming the light-diffusing layer preferably contains either one or both of a fluorine-containing surfactant and a silicone-containing surfactant particularly for ensuring the surface uniformity free of coating unevenness, drying unevenness, point defect or the like. Of these, a fluorine-containing surfactant can be preferably used, because the effect of improving surface failures such as coating unevenness, drying unevenness and point defect can be brought out with a smaller amount of the surfactant added. Suitability for high-speed coating can be imparted while enhancing the surface uniformity, whereby the productivity can be elevated.

Preferred examples of the fluorine-containing surfactant include a fluoroaliphatic group-containing copolymer (sometimes simply referred to as a “fluorine-based polymer”). The useful fluorine-based polymer is a copolymer of an acrylic or methacrylic resin comprising a repeating unit corresponding to the monomer of (i) below or comprising a repeating unit corresponding to the monomer of (ii) below, and a vinyl-based monomer copolymerizable therewith.

(i) Fluoroaliphatic Group-Containing Monomer Represented by the Following Formula (a)

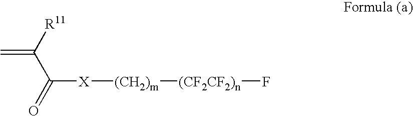

In formula (a), R¹¹ represents a hydrogen atom or a methyl group, X represents an oxygen atom, a sulfur atom, or —N(R¹²)—, m represents an integer of 1 to 6, and n represents an integer of 2 to 4. R¹² represents a hydrogen atom or an alkyl group having a carbon number of 1 to 4, specifically a methyl group, an ethyl group, a propyl group or a butyl group, and preferably a hydrogen atom or a methyl group. X is preferably an oxygen atom.

(ii) Monomer Represented by the Following Formula (b), which is Copolymerizable with Monomer of (i)

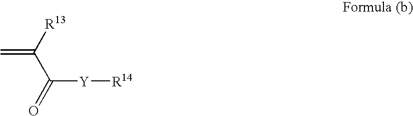

In formula (b), R¹³ represents a hydrogen atom or a methyl group, and Y represents an oxygen atom, a sulfur atom or —N(R¹⁵)—. R¹⁵ represents a hydrogen atom or an alkyl group having a carbon number of 1 to 4, specifically a methyl group, an ethyl group, a propyl group or a butyl group, and preferably a hydrogen atom or a methyl group. Y is preferably an oxygen atom, —N(H)— or —N(CH₃)—.

R¹⁴ represents a linear, branched or cyclic alkyl group having a carbon number of 4 to 20, which may have a substituent. Examples of the substituent of the alkyl group as R¹⁴ include, but are not limited to, a hydroxyl group, an alkylcarbonyl group, an arylcarbonyl group, a carboxyl group, an alkyl ether group, an aryl ether group, a halogen atom (e.g., fluorine, chlorine, bromine), a nitro group, a cyano group and an amino group. Suitable examples of the linear, branched or cyclic alkyl group having a carbon number of 4 to 20 include a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group and an eicosanyl group, which each may be linear or branched, and further include a monocyclic cycloalkyl group such as cyclohexyl group and cycloheptyl group, and a polycyclic cycloalkyl group such as bicycloheptyl group, bicyclodecyl group, tricycloundecyl group, tetracyclododecyl group, adamantyl group, norbornyl group and tetracyclodecyl group.

The amount of the fluoroaliphatic group-containing monomer represented by formula (a) used in the fluorine-based polymer for use in the present invention is 10 mol % or more, preferably from 15 to 70 mol %, more preferably 20 to 60 mol %, based on each monomer of the fluorine-based polymer.

The mass average molecular weight of the fluorine-based polymer for use in the present invention is preferably from 3,000 to 100,000, more preferably from 5,000 to 80,000.

Furthermore, the amount added of the fluorine-based polymer for use in the present invention is preferably from 0.001 to 5 mass %, more preferably from 0.005 to 3 mass %, still more preferably from 0.01 to 1 mass %, based on the coating solution. If the amount of the fluorine-based polymer added is less than 0.001 mass %, the effect is insufficient, whereas if it exceeds 5 mass %, the coating film may not be satisfactorily dried or the performance (e.g., reflectance, scratch resistance) as the coating film may be adversely affected.

### 2-(6) Thickening Agent

In the film of the present invention, a thickening agent may be used for adjusting the viscosity of the coating solution. The thickening agent as used herein means a substance capable of increasing the viscosity of a solution when added. The increment of viscosity of the coating solution, which is brought about by the addition, is preferably from 0.05 to 50 cP, more preferably from 0.1O to 20 cP, and most preferably from 0.10 to 10 cP.

Examples of the thickening agent include, but are not limited to, the followings:

poly-ε-caprolactone,

poly-ε-caprolactone diol,

poly-ε-caprolactone triol,

polyvinyl acetate,

poly(ethylene adipate),

poly(1,4-butylene adipate),

poly(1,4-butylene glutarate),

poly(1,4-butylene succinate),

poly(1,4-butylene terephthalate),

poly(ethylene terephthalate),

poly(2-methyl-1,3-propylene adipate),

poly(2-methyl-1,3-propylene glutarate),

poly(neopentyl glycol adipate),

poly(neopentyl glycol sebacate),

poly(1,3-propylene adipate),

poly(1,3-propylene glutarate),

polyvinylbutyral,

polyvinylformal,

polyvinylacetal,

polyvinylpropanal,

polyvinylhexanal,

polyvinylpyrrolidone,

polyacrylic acid ester,

polymethacrylic acid ester,

cellulose acetate,

cellulose propionate, and

cellulose acetate butyrate.

Other than these, a known viscosity adjusting agent or thixotropy imparting agent, such as smectite, fluorotetrasilicon mica, bentonite, silica, montmorillonite and sodium polyacrylate described in JP-A-8-325491, and ethyl cellulose, polyacrylic acid and organic clay described in JP-A-10-219136, may be used.

### 2-(7) Coating Solvent

As for the solvent used in the coating composition for forming each layer of the present invention, various solvents selected from the standpoint, for example, that the solvent can dissolve or disperse each component, readily provides a uniform surface state in the coating step and drying step, can ensure liquid storability or has an appropriate saturated vapor pressure, may be used.

Two or more kinds of solvents may be mixed and used. In view of the drying load, it is preferred that a solvent having a boiling point of 100° C. or less at room temperature under atmospheric pressure is used as the main component and a small amount of a solvent having a boiling point of 100° C. or more is contained for adjusting the drying speed.

Examples of the solvent having a boiling point of 100° C. or less include hydrocarbons such as hexane (boiling point: 68.7° C.), heptane (98.4° C.), cyclohexane (80.7° C.) and benzene (80.1° C.); halogenated hydrocarbons such as dichloromethane (39.8° C.), chloroform (61.2° C.), carbon tetrachloride (76.8° C.), 1,2-dichloroethane (83.5° C.) and trichloroethylene (87.2° C.); ethers such as diethyl ether (34.6° C.), diisopropyl ether (68.5° C.), dipropyl ether (90.5° C.) and tetrahydrofuran (66° C.); esters such as ethyl formate (54.2° C.), methyl acetate (57.8° C.), ethyl acetate (77.1° C.) and isopropyl acetate (89° C.); ketones such as acetone (56.1° C.) and 2-butanone (same as methyl ethyl ketone, 79.6° C.); alcohols such as methanol (64.5° C.), ethanol (78.3° C.), 2-propanol (82.4° C.) and 1-propanol (97.2° C.); cyano compounds such as acetonitrile (81.6° C.) and propionitrile (97.4° C.); and carbon disulfide (46.2° C.). Among these, ketones and esters are preferred, and ketones are more preferred. Out of ketones, 2-butanone is preferred.

Examples of the solvent having a boiling point of 100° C. or more include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (same as MIBK, 115.9° C.), 1-butanol (117.7° C.), N,N-dimethylformamide (153° C.), N,N-dimethylacetamide (166° C.) and dimethyl sulfoxide (189° C.). Among these, cyclohexanone and 2-methyl-4-pentanone are preferred.

### 2-(8) Others

In the film of the present invention, a resin, a coupling agent, a coloration inhibitor, a coloring agent (e.g., pigment, dye), a defoaming agent, a leveling agent, a flame retardant, an ultraviolet absorbent, an infrared absorbent, an adhesion-imparting agent, a polymerization inhibitor, an antioxidant, a surface modifier and the like may be added in addition to the components described above.

### 2-(9) Support

The support of the film of the present invention is not particularly limited and may be a transparent resin film, a transparent resin plate, a transparent resin sheet or a transparent glass. Examples of the transparent resin film which can be used include a cellulose acylate film (e.g., cellulose triacetate film (refractive index: 1.48), cellulose diacetate film, cellulose acetate butyrate film, cellulose acetate propionate film), a polyethylene terephthalate film, a polyethersulfone film, a polyacrylic resin film, a polyurethane-based resin film, a polyester film, a polycarbonate film, a polysulfone film, a polyether film, a polymethylpentene film, a polyether ketone film and a (meth)acrylonitrile film.

### <Cellulose Acylate Film>

Among these, a cellulose acylate film generally used as a protective film of polarizing plate is preferred because of high transparency, less optical birefringence and easy production. The thickness of the transparent support is usually on the order of 25 to 1,000 μm.

In the present invention, a cellulose acetate having an acetylation degree of 59.0 to 61.5% is preferably used for the cellulose acylate film.

The acetylation degree means the amount of acetic acid bonded per unit mass of cellulose. The acetylation degree is determined according to the measurement and calculation of acetylation degree in ASTM:D-8 17-91 (Test Method of Cellulose Acetate, etc.).

The viscosity average polymerization degree (DP) of the cellulose acylate is preferably 250 or more, more preferably 290 or more.

Also, in the cellulose acylate for use in the present invention, the Mw/Mn (Mw is the mass average molecular weight and Mn is the number average molecular weight) value by gel permeation chromatography is preferably close to 1.0, in other words, the molecular weight distribution is preferably narrow. Specifically, the Mw/Mn value is preferably from 1.0 to 1.7, more preferably from 1.3 to 1.65, and most preferably from 1.4 to 1.6.

In general, the hydroxyl groups at the 2-, 3- and 6-positions of the cellulose acylate are not equally ⅓ distributed, but the substitution degree of 6-position hydroxyl group tends to be small. In the present invention, the substitution degree of 6-position hydroxyl group of the cellulose acylate is preferably larger as compared with the 2- or 3-position.

The hydroxyl group at the 6-position is preferably substituted by an acyl group in a proportion of 32% or more, more preferably 33% or more, still more preferably 34% or more, based on the entire substitution degree. Furthermore, the substitution degree for the 6-position acyl group of cellulose acylate is preferably 0.88 or more. The 6-position hydroxyl group may be substituted, in addition to the acetyl group, by an acyl group having a carbon number of 3 or more, such as propionyl group, butyroyl group, valeroyl group, benzoyl group or acryloyl group. The substitution degree at each position can be measured by NMR.

As for the cellulose acylate used in the present invention, cellulose acetates synthesized by the methods disclosed in JP-A-11-5851, “Example” and “Synthesis Example 1” of paragraphs [0043] and [0044], “Synthesis Example 2” of paragraphs [0048] and [0049], and “Synthesis Example 3” of paragraphs [0051] and [0052], can be used.

### <Polyethylene Terephthalate Film>

In the present invention, a polyethylene terephthalate film may also be preferably used, because this is excellent in all of transparency, mechanical strength, flatness, chemical resistance and moisture resistance and moreover, is inexpensive.

The transparent plastic film is more preferably subjected to an easy adhesion treatment so as to further enhance the adhesion strength between the transparent plastic film and the hardcoat layer provided thereon.

Examples of the commercially available optical PET film with an easy adhesion layer include COSMOSHINE A4100 and A4300 produced by Toyobo Co., Ltd.

### 3. Layers Constituting Film

The film of the present invention is obtained by mixing various compounds described above and coating the solution, and the layers constituting the film of the present invention are described below.

### 3-(1) Antiglare Layer

The antiglare layer is formed for the purpose of giving the film an antiglare property by surface scattering specified in the present invention and a hardcoat property to enhance scratch resistance of the film.

As for the method of forming the antiglare layer, known examples thereof include a method of forming the antiglare layer by laminating a mat shaped film having fine irregularities on the surface described in JP-A-6-16851; a method of forming the antiglare layer by varying the irradiation dose of ionizing radiation and thereby bringing out curing shrinkage of an ionizing radiation-curable resin described in JP-A-2000-206317; a method of decreasing through drying the weight ratio of good solvent to light-transparent resin and thereby gelling and solidifying a light-transparent fine particle and a light-transparent resin to form irregularities on the coating film surface described in JP-A-2000-338310; and a method of imparting surface irregularities by applying an external pressure described in JP-A-2000-275404. These known methods can be utilized.

The antiglare layer which can be used in the present invention is preferably a layer containing, as essential components, a binder capable of imparting hardcoat property, a light-transparent particle for imparting antiglare property, and a solvent, in which surface irregularities are formed by protrusion of the light-transparent particle itself or protrusion formed by an aggregate of a plurality of particles.

The antiglare layer formed by the dispersion of mat particles comprises a binder and a light-transparent particle dispersed in the binder. The antiglare layer having antiglare property preferably has both antiglare property and hardcoat property.

Specific preferred examples of the mat particle include an inorganic compound particle such as silica particle and TiO₂ particle; and a resin particle such as acryl particle, crosslinked acryl particle, polystyrene particle, crosslinked styrene particle, melamine resin particle and benzoguanamine resin particle. Among these, a crosslinked styrene particle, a crosslinked acryl particle and a silica particle are more preferred.

The shape of the mat particle may be either spherical or amorphous.

The particle size distribution of the mat particle is measured by a Coulter counter method, and the measured distribution is converted into a particle number distribution.

By adjusting the refractive index of the light-transparent resin in accordance with the refractive index of the light-transparent particle selected from these particles, the internal haze and surface haze of the present invention can be achieved. More specifically, a combination of a light-transparent resin (refractive index after curing: from 1.55 to 1.70) mainly comprising a trifunctional or greater (meth)acrylate monomer described later, which is preferably used in the antiglare layer of the present invention, with a light-transparent particle comprising a crosslinked poly(meth)acrylate polymer having a styrene content of 50 to 100 mass % and/or a benzoguanamine particle is preferred, and a combination of the light-transparent resin and a light-transparent particle (refractive index: from 1.54 to 1.59) comprising a crosslinked poly(styrene-acrylate) copolymer having a styrene content of 50 to 100 mass % is more preferred.

The light-transparent particle is preferably blended to be contained in the antiglare layer formed at a proportion of 3 to 30 mass %, more preferably from 5 to 20 mass %, based on the entire solid content of the antiglare layer. If the proportion is less than 3 mass %, the antiglare property is insufficient, whereas if it exceeds 30 mass %, there arises a problem such as image blurring or surface clouding or glaring.

The density of the light-transparent particle is preferably from 10 to 1,000 mg/m², more preferably from 100 to 700 mg/m².

The absolute value of the difference between the refractive index of the light-transparent resin and the refractive index of the light-transparent particle is preferably 0.04 or less. The absolute value of the difference between the refractive index of the light-transparent resin and the refractive index of the light-transparent particle is preferably from 0.001 to 0.030, more preferably from 0.001 to 0.020, still more preferably from 0.001 to 0.015. If this difference exceeds 0.040, there arises a problem such as film character burring, reduction of dark-room contrast, or surface clouding.

The refractive index of the light-transparent resin can be quantitatively evaluated by directly measuring the refractive index with an Abbe refractometer or by measuring the spectral reflection spectrum or spectral ellipsometry. The refractive index of the light-transparent particle is determined as follows. The light-transparent particle is dispersed in an equal amount in solvents prepared by changing the mixing ratio of two kinds of solvents differing in the refractive index and thereby varying the refractive index, the turbidity is measured, and the refractive index of the solvent when the turbidity becomes minimum is measured by an Abbe refractometer.

Also, two or more kinds of mat particles differing in the particle diameter may be used in combination. The mat particle having a larger particle diameter can impart antiglare property and the mat particle having a smaller particle diameter can impart another optical property. For example, when an antiglare antireflection film is laminated on a high-definition display of 133 ppi or more, a trouble in view of display image grade, called “glaring”, is sometimes generated. The “glaring” is ascribable to loss of brightness uniformity resulting from enlargement or shrinkage of a pixel due to irregularities present on the antiglare antireflection film surface, but this can be greatly improved by using together a mat particle having a particle diameter smaller than that of the antiglare property-imparting mat particle and having a refractive index differing from that of the binder.

The film thickness of the antiglare layer is preferably from 1 to 10 μm, more preferably from 1.2 to 8 μm. If the thickness is too small, the hardcoat property is insufficient, whereas if it is excessively large, the curling or brittleness is worsened and the processing suitability may deteriorate. Therefore, the film thickness is preferably in the above-described range.

The centerline average roughness (Ra) of the antiglare layer is preferably from 0.10 to 0.40 μm. If the centerline average roughness exceeds 0.40 μm, there arises a problem such as glaring or surface whitening due to reflection of outside light. The transmitted image clarity is preferably from 5 to 60%.

The strength of the antiglare layer is preferably H or more, more preferably 2H or more, still more preferably 3H or more, in the pencil hardness test.

### 3-(2) Hardcoat Layer

In the film of the present invention, in addition to the antiglare layer, a hardcoat layer may be provided so as to impart physical strength to the film. A low refractive index layer is preferably provided thereon, and a medium refractive layer and a high refractive layer are more preferably provided between the hardcoat layer and the low refractive index layer, whereby an antireflection film is constituted. The hardcoat layer may be composed of a stack of two or more layers.

In the present invention, in view of optical design for obtaining an antireflection film, the refractive index of the hardcoat layer is preferably from 1.48 to 2.00, more preferably from 1.52 to 1.90, still more preferably from 1.55 to 1.80. In the present invention, at least one low refractive index is present on the hardcoat layer and therefore, if the refractive index is smaller than the above-described range, the antireflection property may decrease, whereas if it is excessively large, the color tint of reflected light tends to be intensified.

From the standpoint of imparting satisfactory durability and impact resistance to the film, the thickness of the hardcoat layer is usually on the order of 0.5 to 50 μm, preferably from 1 to 20 μm, more preferably from 2 to 10 μm, and most preferably from 3 to 7 μm.

The hardness of the hardcoat layer is preferably H or more, more preferably 2H or more, and most preferably 3H or more, in the pencil hardness test.

Furthermore, in the Taber test according to JIS K5400, the abrasion loss of the specimen between before and after test is preferably smaller.

The hardcoat layer is preferably formed through a crosslinking or polymerization reaction of an ionizing radiation-curable compound. For example, a coating composition containing an ionizing radiation-curable polyfunctional monomer or oligomer is coated on a transparent support, and a crosslinking or polymerization reaction of the polyfunctional monomer or oligomer is brought about, whereby the hardcoat layer can be formed.

The functional group in the ionizing radiation-curable polyfunctional monomer or oligomer is preferably a photo-, electron beam- or radiation-polymerizable functional group, more preferably a photopolymerizable functional group.

Examples of the photopolymerizable functional group include an unsaturated polymerizable functional group such as (meth)acryloyl group, vinyl group, styryl group and allyl group. Among these, a (meth)acryloyl group is preferred.

For the purpose of imparting internal scattering property, the hardcoat layer may contain a mat particle, for example, an inorganic compound particle or a resin particle, having an average particle diameter of 1.0 to 10.0 μm, preferably from 1.5 to 7.0 μm.

For the purpose of controlling the refractive index of the hardcoat layer, a high refractive index monomer or inorganic fine particle or both may be added to the binder of the hardcoat layer. The inorganic fine particle has an effect of suppressing curing shrinkage ascribable to the crosslinking reaction, in addition to the effect of controlling the refractive index. In the present invention, the binder is used including a polymer produced by the polymerization of the polyfunctional monomer and/or the high refractive index monomer or the like after the formation of the hardcoat layer, and the inorganic particle dispersed therein.

For the purpose of maintaining the sharpness of image, the transmitted image clarity is preferably adjusted in addition to the adjustment of surface irregularity shape. The transmitted image clarity of a clear antireflection film is preferably 60% or more. The transmitted image clarity is generally an index showing the degree of blurring of an image transmitted and projected on the film and as this value is larger, the image viewed through the film is clearer and better. The transmitted image clarity is preferably 70% or more, more preferably 80% or more.

### 3-(3) High Refractive Index Layer, Medium Refractive Index Layer

In the film of the present invention, a high refractive index layer and a medium refractive index layer may be provided to enhance the antireflection property.

In the following, these high refractive index layer and medium refractive index layer are sometimes collectively referred to as a high refractive index layer. Incidentally, in the present invention, the terms “high”, “medium” and “low” in the high refractive index layer, medium refractive index layer and low refractive index indicate the relative size of refractive index among layers. In terms of the relationship with the transparent support, the refractive index preferably satisfies the relationships of transparent support >low refractive index layer, and high refractive index layer> transparent support.

Also, in the present invention, the high refractive layer, medium refractive layer and low refractive index layer are sometimes collectively referred to as an antireflection layer.

For producing an antireflection film by forming a low refractive index layer on a high refractive index layer, the refractive index of the high refractive index layer is preferably from 1.55 to 2.40, more preferably from 1.60 to 2.20, still more preferably from 1.65 to 2.10, and most preferably from 1.80 to 2.00.

In the case of producing an antireflection film by providing a medium refractive index layer, a high refractive index layer and a low refractive index layer in this order from the support side, the refractive index of the high refractive index layer is preferably from 1.65 to 2.40, more preferably from 1.70 to 2.20. The refractive index of the medium refractive index layer is adjusted to a value between the refractive index of the low refractive index layer and the refractive index of the high refractive index layer. The refractive index of the medium refractive index layer is preferably from 1.55 to 1.80.

The inorganic particle comprising TiO₂ as a main component, for use in the high refractive index layer and the medium refractive index layer, is used in a dispersion state for the formation of the high refractive index layer and the medium refractive index layer.

At the dispersion, the inorganic particle is dispersed in a dispersion medium in the presence of a dispersant.

The high refractive index layer and the medium refractive index layer for use in the present invention each is preferably formed as follows. A coating composition for the formation of the high or medium refractive index layer is prepared by dispersing the inorganic particle in a dispersion medium and preferably further adding a binder precursor (for example, an ionizing radiation-curable polyfunctional monomer or oligomer described later) necessary for the matrix formation, a photopolymerization initiator and the like to the resulting liquid dispersion, and the obtained coating composition for the formation of the high or medium refractive index layer is coated on a transparent support and cured through a crosslinking or polymerization reaction of the ionizing radiation-curable compound (for example, a polyfunctional monomer or oligomer).

Simultaneously with or after the coating of the high or medium refractive index layer, the binder of the layer is preferably crosslinked or polymerized with the dispersant.

The binder of the thus-produced high or medium refractive index layer takes a form such that the anionic group of the dispersant is taken into the binder as a result of crosslinking or polymerization reaction between the above-described preferred dispersant and the ionizing radiation-curable polyfunctional monomer or oligomer. The anionic group taken into the binder of the high or medium refractive index layer has a function of maintaining the dispersed state of the inorganic fine particle, and the crosslinked or polymerized structure imparts a film-forming ability to the binder, whereby the high or medium refractive index layer containing the inorganic fine particle is improved in the physical strength, chemical resistance and weather resistance.

The binder of the high refractive index layer is added in an amount of 5 to 80 mass % based on the solid content of the coating composition for the layer.

The content of the inorganic particle in the high refractive index layer is preferably from 10 to 90 mass %, more preferably from 15 to 80 mass %, still more preferably from 15 to 75 mass %, based on the mass of the high refractive index layer. Two or more kinds of inorganic particles may be used in combination in the high refractive index layer.

In the case of having a low refractive index layer on the high refractive index layer, the refractive index of the high refractive index layer is preferably higher than the refractive index of the transparent support.

In the high refractive index layer, a binder obtained by a crosslinking or polymerization reaction of an aromatic ring-containing ionizing radiation-curable compound, an ionizing radiation-curable compound containing a halogen element (e.g., Br, I, Cl) except for fluorine, an ionizing radiation-curable compound containing an atom such as S, N and P, or the like may also be preferably used.

The film thickness of the high refractive index layer may be appropriately designed according to the usage. In the case of using the high refractive index layer as an optical interference layer described later, the film thickness is preferably from 30 to 200 nm, more preferably from 50 to 170 nm, still more preferably from 60 to 150 nm.

In the case of not containing an antiglare function-imparting particle, the haze of the high refractive index layer is preferably lower. The haze is preferably 5% or less, more preferably 3% or less, still more preferably 1% or less.

The high refractive index layer is preferably formed on the transparent layer directly or through another layer.

### 3-(4) Interference Unevenness (Rainbow Unevenness)-Preventing Layer

In the case where a substantial difference of refractive index (the difference of refractive index is 0.03 or more) is present between the transparent support and the hardcoat layer or between the transparent support and the antiglare layer, reflected light is generated on the transparent support/hardcoat layer interface or the transparent support/antiglare layer interface. This reflected light interferes with reflected light on the antireflection layer surface and sometimes brings about interference unevenness due to fine thickness unevenness of the hardcoat layer (or antiglare layer). In order to prevent such interference unevenness, for example, an interference unevenness-preventing layer having a medium refractive index n_{P} and having a film thickness d_{P} satisfying the following formula may be provided between the transparent support and the hardcoat layer (or antiglare layer).

d_{P}=(2N−1)×λ/(4n_{P})

wherein λ is the wavelength of visible light and is a value in the range from 450 to 650 nm, and N is a natural number.

In the case of laminating an antireflection film on an image display or the like, a self-adhesive layer (or an adhesive layer) is sometimes stacked on the transparent support on the side where the antireflection layer is not stacked. In such an embodiment, when a substantial difference of refractive index (0.03 or more) is present between the transparent support and the self-adhesive layer (or adhesive layer), reflected light is generated on the transparent support/self-adhesive layer (or adhesive layer) interface, and this reflected light interferes with reflected light on the antireflection layer surface and sometimes brings about interference unevenness similarly due to thickness unevenness of the support or hardcoat layer. For the purpose of preventing such interference unevenness, the same interference unevenness-preventing layer as above may be provided on the transparent support on the side where the antireflection layer is not stacked.

Such an interference unevenness-preventing layer is described in detail in JP-A-2004-345333, and the interference unevenness-preventing layer described in this publication may also be used in the present invention.

### 3-(5) Easy Adhesion Layer

In the film of the present invention, an easy adhesion layer may also be provided by coating. The easy adhesion layer is a layer imparting a function of facilitating adhesion, for example, between the protective film for polarizing plate and a layer adjacent thereto or between the hardcoat layer and the support.

Examples of the easy adhesion treatment include a treatment of providing an easy adhesion layer on a transparent plastic film by using an easy adhesive comprising a polyester, an acrylic acid ester, a polyurethane, a polyethyleneimine, a silane coupling agent or the like.

Examples of the easy adhesion layer preferably used in the present invention include a layer containing a polymer compound having a —COOM (M represents a hydrogen atom or a cation) group. In a more preferred embodiment, a layer containing a polymer compound having a —COOM group is provided on the film substrate side, and a layer mainly comprising a hydrophilic polymer compound is provided on the polarizing film side to come adjacent thereto. Examples of the polymer compound having a —COOM group include a styrene-maleic acid copolymer having a —COOM group, a vinyl acetate-maleic acid copolymer having a —COOM group, and a vinyl acetate-maleic acid-maleic anhydride copolymer. Among these, a vinyl acetate-maleic acid copolymer having a —COOM group is preferred. One of these polymer compounds may be used alone, or two or more species thereof may be used in combination. The mass average molecular weight is preferably on the order of 500 to 500,000. Particularly preferred examples of the polymer compound having a —COOM group include those described in JP-A-6-094915 and JP-A-7-333436.

Preferred examples of the hydrophilic polymer compound include a hydrophilic cellulose derivative (e.g., methyl cellulose, carboxymethyl cellulose, hydroxy cellulose), a polyvinyl alcohol derivative (e.g., polyvinyl alcohol, vinyl acetate-vinyl alcohol copolymer, polyvinyl acetal, polyvinyl formal, polyvinyl benzal), a natural polymer compound (e.g., gelatin, casein, gum arabic), a hydrophilic polyester derivative (e.g., partially sulfonated polyethylene terephthalate), and a hydrophilic polyvinyl derivative (e.g., poly-N-vinylpyrrolidone, polyacrylamide, polyvinyl indazole, polyvinyl pyrazole). One of these may be used alone, or two or more species thereof may be used in combination.

The thickness of the easy adhesion layer is preferably from 0.05 to 1.0 μm. If the thickness is less than 0.05 μm, satisfactory adhesive property can be hardly obtained, whereas if it exceeds 1.0 μm, the adhesive effect is saturated.

### 3-(6) Anti-Curl Layer

The film of the present invention may be subjected to anti-curl processing. The anti-curl processing is to impart a function of tending to curl up with the processed surface inside. By virtue of applying this processing, when some surface fabrication is applied to one surface of the transparent resin film and surface fabrication of different degree and type is applied to both surfaces, the fabricated surface can be prevented from curling with the surface inside.

The anti-curl layer includes an embodiment where the anti-curl layer is provided on the side opposite the substrate surface having an anti-glare or antireflection layer, and an embodiment where, for example, an easy adhesion layer is provided on one surface of the transparent resin film and the anti-curl layer is provided on the opposite surface.

Specific examples of the method for the anti-curl processing include a method of coating a solvent and a method of coating a solvent and a transparent resin layer such as cellulose triacetate, cellulose diacetate and cellulose acetate propionate. The method of coating a solvent is specifically performed by coating a composition containing a solvent that dissolves or swells the cellulose acylate film used as a protective film for polarizing plate. Accordingly, the coating solution for the layer having the anti-curl function preferably contains a ketone- or ester-based organic solvent. Preferred examples of the ketone-based organic solvent include acetone, methyl ethyl ketone, methyl isobutyl ketone, cyclohexanone, ethyl lactate, acetyl acetone, diacetone alcohol, isophorone, ethyl-n-butyl ketone, diisopropyl ketone, diethyl ketone, di-n-propyl ketone, methyl cyclohexanone, methyl-n-butyl ketone, methyl-n-propyl ketone, methyl-n-hexyl ketone and methyl-n-heptyl ketone. Preferred examples of the ester-based organic solvent include methyl acetate, ethyl acetate, butyl acetate, methyl lactate and ethyl lactate. However, as for the solvent used, a solvent incapable of dissolving the film is sometimes contained in addition to a mixture of a solvent capable of dissolving the film and/or a solvent capable of swelling the film. The coating is performed using a composition and a coating amount prepared and determined by mixing these solvents at an appropriate ratio according to the curl degree of the transparent resin film and the kind of the resin. Other than these, the anti-curl function can be brought out also by applying transparent hard processing or antistatic processing.

### 3-(7) Water-Absorbing Layer

In the film of the present invention, a water absorbent can be used. The water absorbent can be selected from compounds having a water-absorbing function, mainly from alkaline earth metals. Examples thereof include BaO, SrO, CaO and MgO. Furthermore, the water absorbent may also be selected from metal elements such as Ti, Mg, Ba and Ca. The particle size of the water absorbent used is preferably 100 nm or less, more preferably 50 nm or less.

The layer containing such a water absorbent may be formed by vacuum vapor deposition or the like similarly to the barrier layer above, or a nanoparticle formed by various methods may be used. The thickness of the layer is preferably from 1 to 100 nm, more preferably from 1 to 10 nm. The layer containing a water absorbent may be added between the support and the laminate (a laminate of barrier layer and organic layer), as the uppermost layer of the laminate, between laminates, or in the organic layer or barrier layer of the laminate. In the case of adding the water absorbent-containing layer to the barrier layer, a vapor co-deposition method is preferably used.

### 3-(8) Primer Layer/Inorganic Thin Film Layer

In the film of the present invention, the gas barrier property can be enhanced by disposing a known primer layer or inorganic thin film layer between the support and the laminate.

As for the primer layer, an acrylic resin, an epoxy resin, a urethane resin, a silicone resin or the like may be used, but in the present invention, the primer layer is preferably an organic-inorganic hybrid layer and the inorganic thin film layer is preferably an inorganic vapor-deposited layer or a dense inorganic coating thin film formed by a sol-gel method. The inorganic vapor-deposited layer is preferably a vapor-deposited layer of silica, zirconia, alumina or the like. The inorganic vapor-deposited layer can be formed, for example, by a vacuum vapor deposition method or a sputtering method.

### 4. Production Method

### 4-(1) Treatment Before Coating

The support for use in the present invention is preferably subjected to a surface treatment before the coating. The specific method therefor includes a corona discharge treatment, a glow discharge treatment, a flame treatment, an acid treatment, an alkali treatment and an ultraviolet irradiation treatment. It is also preferred to provide an undercoat layer as described in JP-A-7-333433.

Examples of the dedusting method for use in the dedusting step as a pre-step before coating include a dry dedusting method such as a method of pressing a nonwoven fabric, a blade or the like against the film surface described in JP-A-59-150571; a method of blowing air having high cleanliness at a high speed to separate attached matters from the film surface, and sucking these matters via a proximate suction port described in JP-A-10-309553; and a method of blowing compressed air under ultrasonic vibration to separate attached matters, and sucking these matters described in JP-A-7-333613 (for example, NEW ULTRA-CLEANER manufactured by Shinko Co., Ltd.).

Also, a wet dedusting method may be used, such as a method of introducing the film into a washing tank, and separating attached matters by using an ultrasonic vibrator; a method of supplying a cleaning solution to the film, and blowing air at a high speed, followed by sucking described in JP-B-49-13020; and a method of continuously rubbing the web with a liquid-moistened roll, and jetting a liquid onto the rubbed face, thereby cleaning the web described in JP-A-2001-38306. Among these dedusting methods, an ultrasonic dedusting method and a wet dedusting method are preferred in view of the dedusting effect.

Before performing such a dedusting step, the static electricity on the film support is preferably destaticized so as to elevate the dedusting efficiency and prevent attachment of dirt. As for the destaticizing method, an ionizer of corona discharge type, an ionizer of light irradiation type (e.g., UV, soft X-ray), and the like may be used. The voltage charged on the film support before and after dedusting and coating is preferably 1,000 V or less, more preferably 300 V or less, still more preferably 100 V or less.

From the standpoint of maintaining the flatness of the film, in these treatments, the temperature of the cellulose acylate film is preferably kept to be not more than Tg, specifically 150° C. or less.

In the case of bonding the cellulose acylate film to a polarizing film as in the case of using the film of the present invention as a protective film of a polarizing plate, in view of adhesive property to the polarizing film, an acid or alkali treatment, that is, a saponification treatment for cellulose acylate, is preferably performed.

In view of adhesive property, the surface energy of the cellulose acylate film is preferably 55 mN/m or more, more preferably from 60 to 75 mN/m. The surface energy can be adjusted by the above-described surface treatment.

### 4-(2) Coating

Each layer of the film of the present invention can be formed by the following coating methods, but the present invention is not limited thereto.

A known method such as dip coating method, air knife coating method, curtain coating method, roller coating method, wire bar coating method, gravure coating method, extrusion coating method (die coating method) (see, U.S. Pat. No. 2,681,294) and microgravure coating method, is used. Among these, a microgravure coating method and a die coating method are preferred.

The microgravure coating method for use in the present invention is a coating method characterized in that a gravure roll having a diameter of about 10 to 100 mm, preferably from about 20 to 50 mm, and having a gravure pattern engraved on the entire circumference is rotated below the support in the direction reverse to the support-transporting direction and at the same time, a surplus coating solution is scraped off from the surface of the gravure roll by a doctor blade, whereby a constant amount of the coating solution is transferred to and coated on the bottom surface of the support at the position where the top surface of the support is in a free state. A roll-form transparent support is continuously unrolled and on one side of the unrolled support, at least one layer of the hardcoat layer and the low refractive index layer containing a fluorine-containing olefin-based polymer can be coated by the microgravure coating method.

With respect to the conditions for the coating by the microgravure coating method, the number of lines in the gravure pattern engraved on the gravure roll is preferably from 50 to 800 lines/inch, more preferably from 100 to 300 lines/inch, the depth of the gravure pattern is preferably from 1 to 600 μm, more preferably from 5 to 200 μm, the rotation number of the gravure roll is preferably from 3 to 800 rpm, more preferably from 5 to 200 rpm, and the support transportation speed is preferably from 0.5 to 100 m/min, more preferably from 1 to 50 m/min.

In order to supply the film of the present invention with high productivity, an extrusion method (die coating method) is preferably used.

### 4-(3) Saponification Treatment

In producing a polarizing plate by using the film of the present invention for one film out of two surface protective films of the polarizing film, the surface on the side to be laminated with the polarizing film is preferably hydrophilized to improve the adhesive property on the adhesion surface.

a. Method by Dipping in Alkali Solution

This is a technique of dipping the film in an alkali solution under appropriate conditions to saponify all the surface having reactivity with an alkali on the entire film surface. This method requires no special equipment and is preferred in view of cost. The alkali solution is preferably an aqueous sodium hydroxide solution. The concentration is preferably from 0.5 to 3 mol/L, more preferably from 1 to 2 mol/L. The liquid temperature of the alkali solution is preferably from 30 to 75° C., more preferably from 40 to 60° C.

The combination of the saponification conditions is preferably a combination of relatively mild conditions but may be selected according to the material or constitution of the film or the objective contact angle.

The film after dipping in an alkali solution is preferably well washed with water or dipped in a dilute acid to neutralize the alkali component and thereby not allow the alkali component to remain in the film.

By applying the saponification treatment, the surface opposite the surface having the coated layer is hydrophilized. The protective film for polarizing plate is used by bonding the hydrophilized surface of the transparent support to the polarizing film.

The hydrophilized surface is effective for improving the adhesive property to the adhesive layer comprising polyvinyl alcohol as a main component.

As for the saponification treatment, the contact angle with water on the transparent support surface opposite the surface having the coated layer is preferably lower in view of adhesive property to the polarizing film, but, on the other hand, in the dipping method, the surface having the coated layer as well as the inside of the layer are damaged simultaneously by an alkali and therefore, it is important to select minimum necessary reaction conditions. Particularly, in the case where the transparent support is triacetyl cellulose, the contact angle with water of the transparent support surface on the opposite side, when used as an index for the damage of each layer by an alkali, is preferably from 10 to 50°, more preferably from 30 to 50°, still more preferably from 40 to 50°. If the contact angle exceeds 50°, there arises a problem in the adhesive property to the polarizing film and this is not preferred, whereas if the contact angle is less than 10°, the film is too much damaged and the physical strength is disadvantageously impaired.

b. Method by Coating of Alkali Solution

In order to avoid the damage of each film in the dipping method, an alkali solution coating method where an alkali solution is coated only on the surface opposite the surface having the coated layer under appropriate conditions and the coating is then heated, water-washed and dried, is preferably used. In this case, the “coating” means to contact an alkali solution or the like only with the surface to be saponified and includes spraying or contact with a belt or the like impregnated with the solution, other than coating. When such a method is employed, equipment and step for coating the alkali solution are separately required and therefore, this method is inferior to the dipping method of (1) in view of the cost. However, since the alkali solution comes into contact only with the surface to be saponified, the film may have, on the opposite surface, a layer using a material weak to an alkali solution. For example, a vapor deposition film or a sol-gel film is subject to various effects such as corrosion, dissolution and separation by an alkali solution and is not preferably provided in the case of dipping method, but in this coating method, such a film does not contact with the solution and therefore, can be used without problem.

The saponification methods a and b either can be performed after unrolling a roll-form support and forming respective layers and therefore, the treatment may be added after the film production step and performed in a series of operations. Furthermore, by continuously performing also the step of laminating the film to a polarizing plate comprising a support which is unrolled similarly, a polarizing plate can be produced with higher efficiency than in the case of performing the same operations in the sheet-fed manner.

c. Method of Performing Saponification with Protection by Laminate Film

Similarly to the method b above, when the coated layer is insufficient in the resistance against an alkali solution, a method where after a final layer is formed, a laminate film is laminated on the surface where the final layer is formed, the laminate is then dipped in an alkali solution to hydrophilize only the triacetyl cellulose surface opposite the surface where the final layer is formed, and the laminate film is thereafter peeled off, may be employed. Also in this method, a hydrophilizing treatment enough as a protective film of polarizing plate can be applied only to the triacetyl cellulose film surface opposite the surface where the final layer is formed, without damaging the coated layer. As compared with the method b, this method is advantageous in that a special apparatus for coating an alkali solution is not necessary, though the laminate film remains as a waste.

d. Method by Dipping in Alkali Solution After Formation up to Halfway Layer

In the case where the layers up to a lower layer have resistance against an alkali solution but a layer thereon is insufficient in the resistance against an alkali solution, a method of forming the layers up to the layer, then dipping the film in an alkali solution to hydrophilize both surfaces, and thereafter forming the layer thereon, may be employed. The production process becomes cumbersome but this method is advantageous in that, for example, in a film comprising an antiglare layer and a low refractive index layer formed of a fluorine-containing sol-gel film, when having a hydrophilic group, the interlayer adhesion between the antiglare layer and the low refractive index layer is enhanced.

e. Method of Forming Coated Layer on Previously Saponified Triacetyl Cellulose Film

After previously saponifying a triacetyl cellulose film, for example, by dipping it in an alkali solution, a coated layer may be formed on either one surface directly or through another layer. In the case of performing the saponification by dipping the film in an alkali solution, the interlayer adhesion to the triacetyl cellulose surface hydrophilized by the saponification is sometimes worsened. In such a case, the hydrophilized surface may be removed by applying, after the saponification, a treatment such as corona discharge or glow discharge only to the surface where the coated layer is to be formed, and then the coated layer may be formed, whereby the problem can be overcome. Also, when the coated layer has a hydrophilic group, good interlayer adhesion may be obtained.

### 4-(4) Production of Polarizing Film

The film of the present invention may be used as a protective film disposed on one side or both sides of a polarizing film, and the laminate can be used as a polarizing plate.

The film of the present invention is used as one protective film and as for the other protective film, a normal cellulose acetate film may be used, but a cellulose acetate film produced by the above-described solution film-forming method and stretched in the width direction in the case of a rolled film form at a draw ratio of 10 to 100% is preferably used.

Furthermore, in the polarizing plate of the present invention, it is preferred that one surface is an antireflection film and the other protective film is an optical compensation film having an optically anisotropic layer comprising a liquid crystalline compound.

The polarizing film includes an iodine-based polarizing film, a dye-based polarizing film using a dichroic dye, and a polyene-based polarizing film. The iodine-based polarizing film and the dye-based polarizing film are generally produced using a polyvinyl alcohol-based film.

The slow axis of the transparent support or cellulose acetate film of the antireflection film and the transmission axis of the polarizing film are arranged to run substantially in parallel.

The moisture permeability of the protective film is important for the productivity of the polarizing plate. The polarizing film and the protective film are laminated with an aqueous adhesive, and the solvent of this adhesive diffuses in the protective film and is thereby dried. As the moisture permeability of the protective film is higher, the drying rate and in turn the productivity are more elevated, but if the moisture permeability is excessively high, moisture enters into the polarizing film depending on the environment (at high humidity) where the liquid crystal display device is used, and the polarizing ability decreases.

The moisture permeability of the protective film is determined, for example, by the thickness of transparent support or polymer film (and polymerizable liquid crystal compound), the free volume or the hydrophilicity/hydrophobicity.

In the case where the film of the present invention is used as a protective film of the polarizing plate, the moisture permeability is preferably from 100 to 1,000 g/m².24 hrs, more preferably from 300 to 700 g/m².24 hrs.

In the film production, the thickness of the transparent support can be adjusted by the lip flow rate and the line speed or by stretching and compression. The moisture permeability varies depending on the main raw material used and therefore, can be adjusted to a preferred range by controlling the thickness.

In the film production, the free volume of the transparent support can be adjusted by the drying temperature and time.

Also in this case, the moisture permeability varies depending on the main raw material used and therefore, the moisture permeability can be adjusted to a preferred range by controlling the free volume.

The hydrophilicity/hydrophobicity of the transparent support can be adjusted by an additive. The moisture permeability is elevated by adding a hydrophilic additive with the above-described free volume, and conversely, the moisture permeability can be lowered by adding a hydrophobic additive.

A polarizing plate having an optically compensating ability can be produced with high productivity at a low cost by independently controlling the moisture permeability.

The polarizing film may be a known polarizing film, or a polarizing film cut out from a lengthy polarizing film with the absorption axis of the polarizing film being neither parallel nor perpendicular to the longitudinal direction may be used. The lengthy polarizing film with the absorption axis of the polarizing film being neither parallel nor perpendicular to the longitudinal direction is produced by the following method.

This is a polarizing film obtained by stretching a continuously fed polymer film while holding its both edges with holding means and applying a tension and can be produced by a stretching method of stretching the film to from 1.1 to 20.0 times at least in the film width direction, moving the holding devices at both edges of the film to create a difference in the travelling speed of 3% or less in the longitudinal direction, and bending the film travelling direction in the state of the film being held at both edges such that the angle made by the film travelling direction at the outlet in the step of holding both edges of the film and the substantial stretching direction of the film is inclined at 20 to 70°. Particularly, a polarizing film produced with an inclination angle of 45° is preferred in view of productivity.

The stretching method of a polymer film is described in detail in JP-A-2002-86554 (paragraphs [0020] to [0030]).

It is also preferred that out of two protective films of a polarizer, the film other than the antireflection film is an optical compensation film having an optical compensation layer comprising an optically anisotropic layer. The optical compensation film (retardation film) can improve the viewing angle properties on a liquid crystal display screen.

The optical compensation film may be a known optical compensation film, but from the standpoint of enlarging the viewing angle, the optical compensation film described in JP-A-200 1-100042 is preferred.

### 5. Usage Mode of the Present Invention

### 5-(1) Polarizing Plate

The polarizing plate of the present invention is a polarizing plate having a polarizing film and protective films provided on both sides of the polarizing film, wherein at least one protective film is the optical film (preferably antireflection film) of the present invention. In the protective film, as described above, the contact angle with water on the surface of the transparent support opposite the side having the light-scattering layer or antireflection layer, that is, on the surface laminated with the polarizing film, is preferably from 10 to 50°. For example, the optical film of the present invention can be disposed on the outermost surface of a display by providing a self-adhesive layer on one surface of the film. The optical film of the present invention is preferably used for at least one protective film out of two protective films sandwiching the polarizing film from both sides in the polarizing plate.

### 5-(2) Image Display Device

The optical film or polarizing plate of the present invention can be applied to an image display device such as liquid crystal display (LCD), plasma display panel (PDP), electroluminescent display (ELD) and cathode ray tube display (CRT). The optical film or polarizing plate of the present invention is preferably used on the viewing side of the display screen of the image display device.

### 5-(3) Liquid Crystal Display Device

Particularly, the optical film or polarizing plate of the present invention is preferably used as the outermost layer of a display such as liquid crystal display device. The liquid crystal display device comprises a liquid crystal cell and two sheets of polarizing plates disposed on both sides thereof, and the liquid crystal cell carries a liquid crystal between two sheets of electrode substrates. Furthermore, one sheet of optically anisotropic layer is disposed between the liquid crystal cell and one polarizing plate, or two sheets of optically anisotropic layer are sometimes disposed, that is, one between the liquid crystal cell and one polarizing plate and another between the liquid crystal cell and another polarizing plate.

The liquid crystal cell is preferably a TN mode, a VA mode, an OCB mode, an IPS mode or an ECB mode.

### <TN Mode>

In the TN-mode liquid crystal cell, rod-like liquid crystalline molecules are oriented substantially in the horizontal alignment at the time of not applying a voltage and furthermore, twisted at an angle of 60 to 120°.

The TN-mode liquid crystal cell is most frequently utilized in a color TFT liquid crystal display device and described in a large number of publications.

### <VA Mode>

In the VA-mode liquid crystal cell, rod-like liquid crystalline molecules are oriented substantially in the vertical alignment at the time of not applying a voltage.

The VA-mode liquid crystal cell includes (1) a VA-mode liquid crystal cell in a narrow sense where rod-like liquid crystalline molecules are oriented substantially in the vertical alignment at the time of not applying a voltage and oriented substantially in the horizontal alignment at the time of applying a voltage (described in JP-A-2-176625); (2) a (MVA-mode) liquid crystal cell where the VA mode is modified to a multi-domain system for enlarging the viewing angle (described in SID97, Digest of Tech. Papers (preprints), 28, 845 (1997)); (3) a (n-ASM-mode) liquid crystal cell where rod-like liquid crystalline molecules are oriented substantially in the vertical alignment at the time of not applying a voltage and oriented in the twisted multi-domain alignment at the time of applying a voltage (described in preprints of Nippon Ekisho Toronkai (Liquid Crystal Forum of Japan), 58-59 (1998)); and (4) a SURVAIVAL-mode liquid crystal cell (reported in LCD International 98).

### <OCB Mode>

The OCB-mode liquid crystal cell is a liquid crystal cell of bend orientation mode where rod-like liquid crystalline molecules are oriented substantially in the reverse direction (symmetrically) between upper portion and lower portion of the liquid crystal cell, and this is described in U.S. Pat. Nos. 4,583,825 and 5,410,422. Since rod-like liquid crystalline molecules are symmetrically oriented between upper portion and lower portion of the liquid crystal cell, the liquid crystal cell of bend orientation mode has a self-optically compensating ability. Accordingly, this liquid crystal mode is called an OCB (optically compensatory bend) liquid crystal mode. A liquid crystal display device of bend orientation mode is advantageous in that the response speed is fast.

### <IPS Mode>

The IPS-mode liquid crystal cell employs a system of switching the nematic liquid crystal by applying a transverse electric field thereto, and this is described in detail in Proc. IDRC (Asia Display '95), pp. 577-580 and ibid., pp. 707-710.

### <ECB Mode>

In the ECB-mode liquid crystal cell, rod-like liquid crystalline molecules are oriented substantially in the horizontal alignment at the time of not applying a voltage. The ECB mode is one of liquid crystal display modes having a simplest structure and is described in detail, for example, in JP-A-5-203946.

### 5-(4) Display Other than Liquid Crystal Display Device

### <PDP>

The plasma display panel (PDP) is generally composed of a gas, a glass substrate, an electrode, an electrode lead material, a thick print material and a fluorescent material. As for the glass substrate, two sheets of front glass substrate and rear glass substrate are used. An electrode and an insulating layer are formed on the two glass substrates, and a fluorescent layer is further formed on the rear glass substrate. The two glass substrates are assembled, and a gas is sealed therebetween.

The plasma display panel (PDP) is already available on the market. The plasma display panel is described in JP-A-5-205643 and JP-A-9-306366.

In some cases, a front panel is disposed on the front surface of the plasma display panel. The front panel preferably has sufficiently high strength for protecting the plasma display panel. The front panel may be spaced from the plasma display panel or may be laminated directly to the plasma display body.

In an image display like the plasma display panel, the optical filter can be laminated directly to the display surface. In the case where a front panel is provided in front of the display, the optical filter may also be laminated to the front side (outer side) or rear side (display side) of the front panel.

### <Touch Panel>

The film of the present invention can be applied to a touch panel or the like described, for example, in JP-A-5-127822 and JP-A-2002-48913.

### <Organic EL Device>

The film of the present invention can be used as a substrate (substrate film) or protective film of an organic EL device or the like.

In the case of using the film of the present invention for an organic EL device or the like, the contents described, for example, in JP-A-11-335661, JP-A-11-335368, JP-A-2001-192651, JP-A-2001-192652, JP-A-2001-192653, JP-A-2001-335776, JP-A-2001-247859, JP-A-2001-181616, JP-A-2001-181617, JP-A-2002-181816, JP-A-2002-181617 and JP-A-2002-056976 may be applied. Furthermore, the contents described in JP-A-2001-148291, JP-A-2001-221916 and JP-A-2001-231443 are preferably used in combination.

### 6. Various Characteristic Values

Various measuring methods for use in the present invention and preferred characteristic values are described below.

### 6-(1) Reflectance

The specular reflectance and color tint are measured as follows. After loading an adapter “ARV-474” in a spectrophotometer “V-550” [manufactured by JASCO Corp.], a specular reflectance for the outgoing angle of −5° at an incident angle of 5° is measured in the wavelength region of 380 to 780 nm and an average reflectance at 450 to 650 nm is calculated, whereby the antireflection property can be evaluated.

The antireflection film of the present invention is preferably designed to have a specular reflectance of 2.0% or less and a transmittance of 90% or more, because the reflection of outside light can be suppressed and the visibility is enhanced. The specular reflectance is more preferably 1.5% or less.

### 6-(2) Scratch Resistance

### <Evaluation of Steel Wool Scratch Resistance>

The result of a rubbing test performed using a rubbing tester under the following conditions can be used as the index for scratch resistance. Environmental conditions of evaluation: 25° C. and 60% RH

### Rubbing Material:

A steel wool (Grade No. 0000, manufactured by Nippon Steel Wool K.K.) is wound around the rubbing tip (1 cm×1 cm) of the tester, which comes into contact with the sample, and fixed by a band not to move.
Moving distance (one way): 13 cm
Rubbing speed: 13 cm/sec
Load: 500 g/cm²
Contact area of tip: 1 cm×1 cm
Number of rubbings: 10 or 15 reciprocations

An oily black ink is applied to the back side of the rubbed sample, scratches in the rubbed portion are observed by reflected light with an eye, and the steel wool scratch resistance is evaluated by the difference from the reflected light quantity in the portions other than the rubbed portion.

### <Evaluation of Steel Wool Scratch Resistance after Exposure to Ozone>

The scratch resistance after aging can be evaluated by a steel wool rubbing test of the antireflection film surface exposed to 10 ppm of ozone for 192 hours.

Each sample fabricated into a polarizing plate is stored in an environment of 10 ppm of ozone, 30° C. and 60% RH for 192 hours (8 days) and then taken out into an air. These samples are evaluated according to the above-described evaluation of steel wool scratch resistance.

### 6-(3) Test of Antifouling Property

### <Marker Wiping Durability>

The film is fixed on a glass surface with a pressure-sensitive adhesive, and a circle having a diameter of 5 mm is written thereon in three turns with a pen tip (fine) of a black marker, “Macky Gokuboso” (trade name, produced by ZEBRA Co.), under the conditions of 25° C. and 60% RH and after 5 seconds, wiped off with a 10-ply folded and bundled Bencot (trade name, produced by Asahi Kasei Corp.) by moving back and forth the bundle 20 times under a load large enough to make a dent in the Bencot bundle. The writing and wiping are repeated under the above-described conditions until the marker stain cannot be eliminated by the wiping, and the antifouling property can be evaluated by the number of repetitions where the marker stain can be wiped off.

The number of repetitions until the marker stain cannot be eliminated is preferably 5 or more, more preferably 10 or more.

As for the black marker, the evaluation can also be performed by drawing a circle having a diameter of 1 cm with Magic Ink No. 700 (M700-T1 Black) Gokuboso, blacking out the circle, allowing the sample to stand 24 hours, rubbing it with Bencot (produced by Asahi Kasei Corp.), and checking whether the marker can be wiped off.

### <Evaluation of Surface Profile>

The surface profile of the optical film can be evaluated by measuring the arithmetic average roughness (Ra) of surface irregularities and the average distance (Sm) of surface irregularities according to JIS B-0601-1994 by means of a two-dimensional roughness meter, Model “SJ-400”, manufactured by Mitutoyo Corp. The Ra value is preferably from 0.01 to 0.30 μm, more preferably from 0.01 to 0.20 μm, still more preferably from 0.01 to 0.15 μm, and most preferably from 0.01 to 0.10 μm. The Sm value is preferably from 30 to 200 μm, more preferably from 50 to 150 μm. If Ra exceeds 0.30, there arises a problem such as glaring or surface whitening due to reflection of outside light.

### (Haze)

The surface haze and internal haze for use in the present invention are described in detail below.

[1] The entire haze value (H) of the film obtained is measured according to JIS-K7136.

[2] After adding several silicone oil drops on the front and back surfaces of the optical film, the film is sandwiched from front and back by two 1 mm-thick glass plates (Microslide Glass No. S 9111, produced by Matsunami K.K.), the two glass plates and the film obtained are put into optically complete contact to provide a surface haze-removed state, and the haze is measured. From this value, the haze separately measured by interposing only the silicone oil between two glass plates is subtracted, and the value obtained is calculated as the internal haze (Hi).

[3] The internal haze (Hi) calculated in [2] above is subtracted from the entire haze (H) measured in [1] above, and the value obtained is calculated as the surface haze (Hs).

The haze attributable to surface scattering of the optical film of the present invention (hereinafter referred to as “surface haze”) is preferably 10% or less, more preferably 6% or less, still more preferably 3% or less.

### EXAMPLES

The present invention is described in greater detail below by referring to Examples, but the present invention should not be construed as being limited thereto. In the following Examples and Synthesis Examples, unless otherwise indicated, the “%” indicates “mass % (weight%)”.

### (Preparation of Sol Solution A)

In a reaction vessel equipped with a stirrer and a reflux condenser, 120 parts of methyl ethyl ketone, 100 parts of acryloyloxypropyltrimethoxysilane (KBM-5103, produced by Shin-Etsu Chemical Co., Ltd.) and 3 parts of diisopropoxyaluminum ethyl acetate were added and mixed and after adding 30 parts of ion-exchanged water, the reaction was allowed to proceed at 60° C. for 4 hours. The reaction solution was cooled to room temperature to obtain Sol Solution a. The mass average molecular weight was 1,600 and out of the oligomer or higher components, the proportion of the components having a molecular weight of 1,000 to 20,000 was 100%. Also, the gas chromatography analysis revealed that the raw material acryloyloxypropyl-trimethoxysilane was not remaining at all. The solid content concentration was adjusted to 29% with methyl ethyl ketone, and the resulting solution was used as Sol Solution a.

### (Preparation of Sol Solution B)

In a reaction vessel equipped with a stirrer and a reflux condenser, 80 parts of acryloyloxypropyltrimethoxysilane, 20 parts of methyltrimethoxysilane (KBM-13, produced by Shin-Etsu Chemical Co., Ltd.) and 3 parts of diisopropoxyaluminum ethyl acetate were added and mixed and after adding 3 parts of ion-exchanged water, the reaction was allowed to proceed at 40° C. for 60 minutes. The mass average molecular weight was 800 and out of the oligomer or higher components, the proportion of the components having a molecular weight of 1,000 to 20,000 was 30%. Also, the gas chromatography analysis revealed that the residual ratio of raw materials acryloyloxypropyltrimethoxysilane and methyltrimethoxysilane was 10% or less.

### [Preparation of Particle Having Void in the Inside]

### (Preparation of Liquid Dispersion B-1)

A silica fine particle having a cavity in the inside was produced by changing the preparation conditions in Preparation Example 4 of JP-A-2002-79616. In the final step, the solvent was replaced with methanol from the water dispersion state to prepare a 20% silica liquid dispersion and a particle having an average particle diameter of 45 nm, a shell thickness of about 7 nm and a refractive index of shell particle of 1.30 was obtained. This is designated as Liquid dispersion (A-1).

15 Parts of acryloyloxypropyltrimethoxysilane and 1.5 parts of diisopropoxyaluminum ethyl acetate were added to and mixed with 500 parts of Liquid Dispersion (A-1) and after adding 9 parts of ion-exchanged water, the reaction was allowed to proceed at 60° C. for 8 hours. Thereafter, the reaction solution was cooled to room temperature and 1.8 parts of acetylacetone was added thereto. Subsequently, the solvent was replaced by distillation under reduced pressure while adding MEK to make nearly constant the total liquid amount. Finally, the solid content was adjusted to 20% to prepare Liquid Dispersion B-1.

### (Preparation of Liquid Dispersion B-2)

A silica fine particle having a cavity in the inside was produced by changing the preparation conditions of Liquid Dispersion (A-1). In the final step, the solvent was replaced with methanol from the water dispersion state to prepare a 20% silica liquid dispersion and a particle having an average particle diameter of 80 nm, a shell thickness of about 7 nm and a refractive index of silica particle of 1.19 was obtained. This is designated as Liquid Dispersion (A-2).

15 Parts of acryloyloxypropyltrimethoxysilane and 1.5 parts of diisopropoxyaluminum ethyl acetate were added to and mixed with 500 parts of Liquid Dispersion (A-2) and after adding 9 parts of ion-exchanged water, the reaction was allowed to proceed at 60° C. for 8 hours. Thereafter, the reaction solution was cooled to room temperature and 1.8 parts of acetylacetone was added thereto. Subsequently, the solvent was replaced by distillation under reduced pressure while adding MEK to make nearly constant the total liquid amount. Finally, the solid content was adjusted to 20% to prepare Liquid Dispersion B-2.

### (Preparation of Liquid Dispersion B-3)

A silica fine particle having a cavity in the inside was produced by changing the preparation conditions of Liquid Dispersion (A-1). In the final step, the solvent was replaced with methanol from the water dispersion state to prepare a 20% silica liquid dispersion and a particle having an average particle diameter of 35 nm, a shell thickness of about 6 nm and a refractive index of silica particle of 1.33 was obtained. This is designated as Liquid Dispersion (A-3).

15 Parts of acryloyloxypropyltrimethoxysilane and 1.5 parts of diisopropoxyaluminum ethyl acetate were added to and mixed with 500 parts of Liquid Dispersion (A-3) and after adding 9 parts of ion-exchanged water, the reaction was allowed to proceed at 60° C. for 8 hours. Thereafter, the reaction solution was cooled to room temperature and 1.8 parts of acetylacetone was added thereto. Subsequently, the solvent was replaced by distillation under reduced pressure while adding MEK to make nearly constant the total liquid amount. Finally, the solid content was adjusted to 20% to prepare Liquid Dispersion B-3

### Example 1

### [Production of Antireflection Film]

### [Preparation of Coating Solutions (Ln-1 to Ln-22) for Low Refractive Index Layer]

Respective components were mixed as shown in the Table and dissolved in MEK to prepare a coating solution for low refractive index layer having a solid content of 6%.

TABLE 3

| | Fluorine-Containing | | | Polyfunctional | | | | | | |
|---|---|---|---|---|---|---|---|---|---|---|
| | Polymer | | | Compound | | Curing Catalyst | | Photoinitiator | | |
| Coating | | Amount | Fluorine | | Amount | | Amount | | Amount | |
| Solution No. | Kind | Used | Content % | Kind | Used | Kind | Used | Kind | Used | Remarks |
| Ln-1 | P-4 | 40.0 | 60.4 | Cymel 303 | 8.0 | Catalyst 4050 | 1.0 | PM980M | 0.4 | Invention |
| Ln-2 | ″ | 44.0 | 60.4 | ″ | 8.0 | ″ | 1.0 | ″ | 0.4 | Invention |
| Ln-3 | ″ | 48.0 | 60.4 | ″ | 8.0 | ″ | 1.0 | ″ | 0.4 | Invention |
| Ln-4 | ″ | 48.0 | 60.4 | ″ | 8.0 | ″ | 1.0 | — | 0.0 | Invention |
| Ln-5 | ″ | 55.0 | 60.4 | ″ | 8.0 | ″ | 1.0 | PM980M | 0.4 | Invention |
| Ln-6 | ″ | 84.0 | 60.4 | ″ | 8.0 | ″ | 1.0 | ″ | 0.4 | Comparison |
| Ln-7 | ″ | 92.0 | 60.4 | ″ | 8.0 | ″ | 1.0 | — | 0.0 | Comparison |
| Ln-8 | ″ | 54.0 | 60.4 | ″ | 8.0 | ″ | 1.0 | PM980M | 0.4 | Comparison |
| Ln-9 | ″ | 39.0 | 60.4 | ″ | 8.0 | ″ | 1.0 | ″ | 0.4 | Invention |
| Ln-10 | ″ | 39.0 | 60.4 | ″ | 8.0 | ″ | 1.0 | ″ | 0.4 | Invention |
| Ln-11 | ″ | 40.0 | 60.4 | ″ | 8.0 | ″ | 1.0 | — | 0.0 | Invention |
| Ln-12 | ″ | 44.0 | 60.4 | ″ | 8.0 | ″ | 1.0 | PM980M | 0.4 | Invention |
| Ln-13 | compound for | 40.0 | 38.9 | ″ | 8.0 | ″ | 1.0 | ″ | 0.4 | Comparison |
| | comparison | | | | | | | | | |
| Ln-14 | compound for | 29.0 | 38.9 | ″ | 8.0 | ″ | 1.0 | ″ | 0.4 | Comparison |
| | comparison | | | | | | | | | |
| Ln-15 | P-2 | 40.0 | 49.9 | ″ | 8.0 | ″ | 1.0 | ″ | 0.4 | Invention |
| Ln-16 | P-11 | 40.0 | 47.3 | ″ | 8.0 | ″ | 1.0 | ″ | 0.4 | Invention |
| Ln-17 | P-13 | 46.0 | 56.8 | DPHA | 5.0 | — | — | IRG369 | 3.0 | Invention |
| Ln-18 | ″ | 45.0 | 56.8 | ″ | 5.0 | — | — | ″ | 3.0 | Invention |
| Ln-19 | P-14 | 46.0 | 51.2 | ″ | 5.0 | — | — | ″ | 3.0 | Invention |
| Ln-20 | P-18 | 46.0 | 51.2 | ″ | 5.0 | — | — | ″ | 3.0 | Invention |
| Ln-21 | P-21 | 46.0 | 46.0 | ″ | 5.0 | — | — | ″ | 3.0 | Invention |
| Ln-22 | P-23 | 46.0 | 42.7 | ″ | 5.0 | — | — | ″ | 3.0 | Invention |

| | Organosilane | | | | | | |
|---|---|---|---|---|---|---|---|
| Coating | Compound | | Particle | | | | |
| Solution | | Amount | Amount Used | | | | |
| No. | Kind | Used | Liquid Dispersion B-1 | Liquid Dispersion B-2 | Liquid Dispersion B-3 | MEK-ST-L | Remarks |
| Ln-1 | Sol Solution a | 8.0 | 35 | | | 9 | Invention |
| Ln-2 | ″ | 4.0 | 35 | | | 9 | Invention |
| Ln-3 | — | 0.0 | 35 | | | 9 | Invention |
| Ln-4 | — | 0.0 | 35 | | | 9 | Invention |
| Ln-5 | Sol Solution a | 8.0 | 20 | | | 9 | Invention |
| Ln-6 | ″ | 8.0 | 0 | | | 0 | Comparison |
| Ln-7 | — | 0.0 | 0 | | | 0 | Comparison |
| Ln-8 | Sol Solution a | 8.0 | 0 | | | 30 | Comparison |
| Ln-9 | ″ | 8.0 | 0 | | 45 | 0 | Invention |
| Ln-10 | ″ | 8.0 | 45 | | | 0 | Invention |
| Ln-11 | ″ | 8.0 | 35 | | | 9 | Invention |
| Ln-12 | ″ | 8.0 | 0 | 35 | | 5 | Invention |
| Ln-13 | ″ | 8.0 | 35 | | | 9 | Comparison |
| Ln-14 | ″ | 8.0 | 50 | | | 5 | Comparison |
| Ln-15 | ″ | 8.0 | 35 | | | 9 | Invention |
| Ln-16 | ″ | 8.0 | 35 | | | 9 | Invention |
| Ln-17 | ″ | 5.0 | 35 | | | 9 | Invention |
| Ln-18 | ″ | 5.0 | 0 | 45 | | 0 | Invention |
| Ln-19 | ″ | 5.0 | 35 | | | 9 | Invention |
| Ln-20 | ″ | 5.0 | 35 | | | 9 | Invention |
| Ln-21 | ″ | 5.0 | 35 | | | 9 | Invention |
| Ln-22 | ″ | 5.0 | 35 | | | 9 | Invention |

Material names, product names and the like in the Table above are as follows. In the Table, the numerical value denotes the parts by mass as solid content of each component.

Compound for comparison: (a fluorine-containing compound, a 50/20/30 (by mol) copolymer of (M1-1)/(MA-33)/EVE, containing 2.7 mass % of VPS-1001, mass average molecular weight: 30,000)

“MEK-ST-L”: colloidal silica, produced by Nissan Chemicals Industries, Ltd., average particle diameter: about 50 nm; “CYMEL 303”: methylolated melamine, produced by Nihon Cytec Industries Inc.; “CATALYST 4050”: a curing catalyst, produced by Nihon Cytec Industries Inc.; “I1”: Compound 1; PM980M: (a photoradical generator, polymerization initiator PM980M, produced by Wako Pure Chemical Industries, Ltd.); “IRG369”: a photoradical generator, produced by Ciba Specialty Chemicals Corp.

### (Preparation of Coating Solution (HCL-1) for Hardcoat Layer)

10 Parts by mass of cyclohexanone, 85 parts by mass of partially caprolactone-modified polyfunctional acrylate (DPCA-20, produced by Nippon Kayaku Co., Ltd.), 10 parts by mass of KBM-5103 (silane coupling agent, produced by Shin-Etsu Chemical Co., Ltd.) and 5 parts by mass of a photopolymerization initiator (Irgacure 184, produced by Ciba Specialty Chemicals Corp.) were added to 90 parts by mass of MEK and stirred. The resulting mixture was filtered through a polypropylene-made filter having a pore size of 0.4 μm to prepare Coating Solution (HCL-1) for Hardcoat Layer.

### [Production of Antireflection Film Sample 1]

A 80 μm-thick triacetyl cellulose film “TAC-TD80U” {produced by Fuji Photo Film Co., Ltd.} in a roll form was unrolled, and Coating Solution (HCL-1) for Hardcoat Layer was coated directly thereon by using a doctor blade and a microgravure roll having a diameter of 50 mm and having a gravure pattern with a line number of 180 lines/inch and a depth of 40 μm under the conditions of a gravure roll rotation number of 30 rpm and a transportation speed of 30 m/min. After drying at 60° C. for 150 seconds, the coated layer was cured by irradiating thereon an ultraviolet ray at a radiation illuminance of 400 mW/cm² and an irradiation dose of 50 mJ/cm² with use of “Air-Cooled Metal Halide Lamp” {manufactured by Eye Graphics Co., Ltd.} of 160 W/cm under nitrogen purging to give an oxygen concentration of 0.1 vol %, thereby forming a layer having a thickness of 5.0 μm. The resulting film was taken up. In this way, Hardcoat Layer (HC-1) was obtained.

On the thus-obtained Hardcoat Layer (HC-1), Coating solution Ln-1 for Low Refractive Index Layer was coated by a microgravure coating system under control to give a low refractive index layer thickness of 95 nm, whereby Antireflection Film Sample 1 was produced.

The curing conditions at the formation of the low refractive index layer are shown below.

(1) Drying: 80° C.-120 seconds

(2) Curing: 110° C.-10 minutes

(3) UV Curing:

60° C.-1 minute; the curing was performed at an illuminance of 120 mW/cm² and an irradiation dose of 480 mJ/cm² by using Air-Cooled Metal Halide Lamp (manufactured by Eye Graphics Co., Ltd.) of 240 W/cm under nitrogen purging to give an atmosphere having an oxygen concentration of 0.01 vol %.

### [Production of Antireflection Films 2 to 22]

In the production of antireflection film, when the coating solution for low refractive index layer had a composition of (Ln-2) to (Ln-16), the curing was performed under the same curing conditions as those for Antireflection Film Sample 1 produced using Coating Solution (Ln-1) for Low Refractive Index Layer. When the coating solution for low refractive index layer had a composition of (Ln-17) to (Ln-22), the curing was performed under the following curing conditions.

The curing conditions at the formation of the low refractive index layer are shown below.

(1) Drying: 80° C.-120 seconds

(2) UV Curing:

60° C.-1 minute; the curing was performed at an illuminance of 120 mW/cm² and an irradiation dose of 480 mJ/cm² by using Air-Cooled Metal Halide Lamp (manufactured by Eye Graphics Co., Ltd.) of 240 W/cm under nitrogen purging to give an atmosphere having an oxygen concentration of 0.01 vol %.

### [Saponification Treatment of Antireflection Film]

The obtained antireflection film was treated under the following saponification standard conditions and dried.

### Alkali Bath:

an aqueous 1.5 mol/dm³ sodium hydroxide solution, at 55° C. for 120 seconds. First water-washing bath: tap water, 60 seconds.

### Neutralization Bath:

0.05 mol/dm³ sulfuric acid, 30° C.-20 seconds.
Second water-washing bath: tap water, 60 seconds.
Drying: 120° C., 60 seconds.

### [Evaluation of Antireflection Film]

Using the saponified antireflection films obtained in this way, the following evaluations were performed.

### (Evaluation 1) Measurement of Average Reflectance

The average reflectance in the region of 450 to 650 nm was measured by the method described above and used. As for samples not fabricated into a polarizing plate, those in the form of a polarizing plate were used as it is and in the case of a film itself or a display device not using a polarizing plate, after the back surface of the antireflection film was subjected to a roughening treatment and then to a light absorption treatment (transmittance at 380 to 780 nm is less than 10%) with black ink, the reflectance was measured on a black table.

### (Evaluation 2) Evaluation of Steel Wool Scratch Resistance

After a test was performed by the method described above, an oily black ink was applied to the back side of the rubbed sample and scratches in the rubbed portion were observed by reflected light with an eye and evaluated according to the following criteria. The load was 500 g/cm² and the number of rubbings was 10 reciprocations.

A: Scratches were not recognized at all even when very carefully observed.

B: Faint scratches were slightly recognized when very carefully observed.

C: Faint scratches were recognized.

D: Medium scratches were recognized.

E: Scratches recognizable at the first glance were present.

### (Evaluation 3) Marker Wiping Durability

A test was performed by the method described above and the number of repetitions until the marker stain was not eliminated, was determined. The number of repetitions until the marker stain cannot be eliminated is preferably 5 or more, more preferably 10 or more.

### (Evaluation 4) Evaluation of SW Scratch Resistance After Exposure to Ozone

In order to evaluate the scratch resistance after aging, the following test was performed. Each sample fabricated into a polarizing plate was stored in an environment of 10 ppm of ozone, 30° C. and 60% RH for 192 hours (8 days) and then taken out into an air. These samples were subjected to the steel wool scratch resistance test described above, and scratches in the rubbed portion were observed by reflected light with an eye and evaluated according to the following criteria. The load was 500 g/cm² and the number of rubbings was 10 reciprocations.

A: Scratches were not recognized at all even when very carefully observed.

B: Faint scratches were slightly recognized when very carefully observed.

C: Faint scratches were recognized.

D: Medium scratches were recognized.

E: Scratches recognizable at the first glance were present.

The evaluation results are shown in the Table below.

TABLE 4

| | Coating Solution | | | | | | |
|---|---|---|---|---|---|---|---|
| | for Low | | | | Marker | SW Scratch | |
| Sample | Refractive | Refractive Index of Low | Average | SW Scratch | Wiping | Resistance after | |
| No. | Index Layer | Refractive Index Layer | Reflectance (%) | Resistance | Durability | Exposure to Ozone | Remarks |
| 1 | Ln1 | 1.372 | 1.26 | A | 15 | A | Invention |
| 2 | Ln2 | 1.364 | 1.15 | A | 12 | B | Invention |
| 3 | Ln3 | 1.357 | 1.05 | B | 9 | C | Invention |
| 4 | Ln4 | 1.357 | 1.05 | B | 8 | C | Invention |
| 5 | Ln5 | 1.376 | 1.32 | A | 14 | A | Invention |
| 6 | Ln6 | 1.372 | 1.26 | D | 4 | E | Comparison |
| 7 | Ln7 | 1.357 | 1.05 | D | 3 | E | Comparison |
| 8 | Ln8 | 1.407 | 1.85 | A | 14 | A | Comparison |
| 9 | Ln9 | 1.367 | 1.17 | B | 9 | C | Invention |
| 10 | Ln10 | 1.358 | 1.07 | B | 10 | B | Invention |
| 11 | Ln11 | 1.372 | 1.26 | A | 11 | B | Invention |
| 12 | Ln12 | 1.319 | 0.64 | A | 14 | A | Invention |
| 13 | Ln13 | 1.395 | 1.63 | A | 9 | A | Comparison |
| 14 | Ln14 | 1.379 | 1.37 | C | 6 | D | Comparison |
| 15 | Ln15 | 1.383 | 1.42 | A | 12 | A | Invention |
| 16 | Ln16 | 1.370 | 1.23 | A | 11 | A | Invention |
| 17 | Ln17 | 1.359 | 1.08 | A | 14 | A | Invention |
| 18 | Ln18 | 1.295 | 0.44 | A | 13 | A | Invention |
| 19 | Ln19 | 1.369 | 1.22 | A | 12 | A | Invention |
| 20 | Ln20 | 1.369 | 1.22 | A | 13 | A | Invention |
| 21 | Ln21 | 1.372 | 1.26 | A | 11 | A | Invention |
| 22 | Ln22 | 1.377 | 1.34 | A | 11 | A | Invention |

As apparent from these Examples, the antireflection film using the polymer of the present invention having a fluorine content in excess of 40%, a (meth)acryloyl group-containing compound and an inorganic fine particle and containing the constituent components of the present invention is assured of low refractive index and low reflectance and excellent in the SW scratch resistance, marker wiping durability and scratch resistance after exposure to ozone.

In the antireflection film having a low refractive index layer containing a fluorine compound, the refractive index and reflectance are decreased as the fluorine content increases and when a compound having a fluorine content of less than 40% is used, the refractive index exceeds the upper limit (comparison of Samples 1, 11, 13 and 14). Also, it is seen that the marker wiping durability and scratch resistance after exposure to ozone are improved by using a fine particle in combination and when a (meth)acryloyl group-containing compound and a photoinitiator are used in combination, this is more effective (comparison of Samples 1 to 7). Furthermore, it is seen that when a fluorine polymer having a fluorine content of 40% or more and a fine particle having a void in the inside are used in combination, the antireflection performance is greatly enhanced (comparison of Samples 1 to 5, 9 to 14 and 8).

### Example 2

Coating Solutions Ln23, Ln24 and Ln25 for Low Refractive Index Layer were prepared in the same manner as Coating solution Ln1 for Low Refractive Index Layer except for changing the kind of the photoinitiator to Irg184, Irg907 and Irg369, respectively. After a low refractive index was coated on HC-1 by using Coating Solutions Ln1, Ln23, Ln24 and Ln25 under the same conditions as in Antireflection Film 1, saponification was performed to obtain Antireflection Films 23 to 26.

Also, Antireflection Films 27 and 28 were obtained by performing the curing and saponification under the same conditions as in the production of Antireflection Film 1 using Coating Solution Ln1 for Low Refractive Index Layer of Example 1 except for changing the temperature at the UV curing to 30° C. and 90° C.

### [Evaluation of Antireflection Film]

Using the saponified antireflection films obtained in this way, the average reflectance, steel wool scratch resistance, marker wiping durability and SW scratch resistance after exposure to ozone were evaluated in the same manner as in Example 1. As for the SW scratch resistance after exposure to ozone, an evaluation for the number of rubbings being 15 reciprocations was also performed. The evaluation results are shown in the Table below.

TABLE 5

| | | | | | Refractive | |
|---|---|---|---|---|---|---|
| Sample | Coating Solution for Low | Photoinitiator | Molecular Weight of | Temperature at UV | Index of Low | |
| No. | Refractive Index Layer | Species | Photoinitiator | Curing (° C.) | Refractive Index Layer | Remarks |
| 23 | Ln1 | PM980M | 527 | 60 | 1.372 | Invention |
| 24 | Ln23 | Irg184 | 204 | 60 | 1.372 | Invention |
| 25 | Ln24 | Irg907 | 279 | 60 | 1.372 | Invention |
| 26 | Ln25 | Irg369 | 366 | 60 | 1.372 | Invention |
| 27 | Ln1 | PM980M | 527 | 30 | 1.372 | Invention |
| 28 | Ln1 | PM980M | 527 | 90 | 1.372 | Invention |

| Sample | Average | SW Scratch | Marker Wiping | SW Scratch Resistance after | SW Scratch Resistance after | |
|---|---|---|---|---|---|---|
| No. | Reflectance (%) | Resistance | Durability | Exposure to Ozone | Exposure to Ozone | Remarks |
| 23 | 1.26 | A | 15 | A | B | Invention |
| 24 | 1.26 | A | 13 | A | D | Invention |
| 25 | 1.26 | A | 13 | A | C | Invention |
| 26 | 1.26 | A | 15 | A | B | Invention |
| 27 | 1.26 | A | 14 | A | C | Invention |
| 28 | 1.26 | A | 17 | A | A | Invention |

As seen from comparison of Samples 23 to 26 of these Examples, the scratch resistance is improved by using a photoinitiator having a large molecular weight. Also, as seen from comparison of Samples 23, 27 and 28, when the temperature at the photocuring is elevated, the film strength can be more increased and the scratch resistance is enhanced.

### Example 3

### Preparation of Coating Solution for HC Layer:

(Composition of Coating Solution HCL-2 for Hardcoat Layer)

| PETA | 40 wt % |
|---|---|
| DPHA | 35 wt % |
| Irgacure 184 | 3 wt % |
| MX-600 | 12 wt % |
| KBM-5103 | 10 wt % |
| Solid content concentration | 30 wt % |
| MIBK/MEK | 90/10 |

(Composition of Coating Solution HCL-3 for Hardcoat Layer)

| PETA | 40 wt % |
|---|---|
| DPHA | 38.5 wt % |
| Irgacure 184 | 3 wt % |
| SX-350 | 5.5 wt % |
| Crosslinked acryl-styrene particle | 3 wt % |
| KBM-5103 | 10 wt % |
| Solid content concentration | 30 wt % |
| MIBK/MEK | 90/10 |

(Composition of Coating Solution HCL-4 for Hardcoat Layer)

| PETA | 40 wt % |
|---|---|
| DPHA | 31 wt % |
| Irgacure 184 | 3 wt % |
| SX-350 | 10 wt % |
| Crosslinked acryl-styrene particle | 5.5 wt % |
| KBM-5103 | 10 wt % |
| Solid content concentration | 30 wt % |
| MIBK/MEK | 90/10 |

The constituent components above are shown by the mass percentage of the solid content. Details of the compounds used are as follows.

### PETA:

A mixture of pentaerythritol triacrylate and pentaerythritol tetraacrylate, produced by Nippon Kayaku Co., Ltd.

### DPHA:

A mixture of dipentaerythritol pentaacrylate and dipentaerythritol hexaacrylate, produced by Nippon Kayaku Co., Ltd.

### KBM-5103:

An organosilane compound, produced by Shin-Etsu Chemical Co., Ltd. Irgacure 184:

A polymerization initiator, produced by Ciba-Geigy Corp.

### SX-350:

A crosslinked polystyrene particle of 3.5 μm, produced by The Soken Chemical & Engineering Co., Ltd.

### Crosslinked Acryl-Styrene Particle:,

A crosslinked acryl-styrene particle of 3.5 μm, produced by The Soken Chemical & Engineering Co., Ltd.

### MX-600:

A PMMA particle of 6 μm, produced by The Soken Chemical & Engineering Co., Ltd.

### MIBK: Methyl Isobutyl Ketone

### MEK: Methyl Ethyl Ketone

Hardcoats (HC-2) to (HC-4) were produced in the same manner as in the production of Hardcoat (HC-1) of Example 1 except for changing Coating Solution (HCL-1) for Hardcoat Layer to Coating Solutions (HCL-2) to (HCL-4) for Hardcoat Layers, respectively. On each of Hardcoats (HC-1) to (HC-4), Coating Solution (Ln-1) or (Ln-17) for Low Refractive Index Layer of Example 1 was coated. Subsequently, curing and saponification were performed in the same manner as in the production of Antireflection Film 1 of Example 1 to produce antireflection films.

### [Evaluation of Antireflection Film]

Using the saponified antireflection films obtained in this way, the following evaluations were performed.

### (Evaluation 1) Measurement of Average Reflectance

The average reflectance was measured in the same manner as in Example 1.

### (Evaluation 2) Evaluation of Surface Profile

As for the surface profile of the film obtained, the arithmetic average roughness (Ra) of surface irregularities was evaluated according to JIS B-0601-1994 by means of a two-dimensional roughness meter, Model “SJ-400”, manufactured by Mitutoyo Corp. Here, Ra was measured by setting the measurement length to 4 μm.

### (Evaluation 3) Haze

The entire haze (H), internal haze (Hi) and surface haze (Hs) of the obtained film were determined by the following measurements.

[1] The entire haze value (H) of the film obtained was measured according to JIS-K7136.

[2] After adding several silicone oil drops on the front and back surfaces of the optical film obtained, the film was sandwiched from front and back by two 1 mm-thick glass plates (Microslide Glass No. S 9111, produced by Matsunami K.K.), the two glass plates and the film obtained were put into optically complete contact to provide a surface haze-removed state, and the haze was measured. From this value, the haze separately measured by interposing only the silicone oil between two glass plates was subtracted, and the value obtained was calculated as the internal haze (Hi).

[3] The internal haze (Hi) calculated in [2] above was subtracted from the entire haze (H) measured in [1] above, and the value obtained was calculated as the surface haze (Hs).

### (Evaluation 4) Reflection

A polarizing plate having smooth surface was laminated on front and back surfaces of a 1 mm-thick glass plate (Microslide Glass No. S 9111, produced by Matsunami K.K.) to give a cross-Nicol state. The support surface of the optical film of the present invention was laminated to one surface of the glass plate by using a self-adhesive sheet to produce a sample piece for measurement. An inspector peered into this sample piece at a distance of about 30 cm from an angle of 0° in a bright room, and the level of reflection of the inspector's face was evaluated according to the following criteria.

A: The inspector's face was not reflected at all.

B: The inspector's face was slightly reflected but not annoying.

D: The inspector's face was reflected, annoying.

E: The inspector's face was strongly reflected.

### (Evaluation 5) Dense Blackness

A sample was produced by laminating a polarizing plate and the film obtained on a glass plate in the same manner as in the measurement of reflection of (Evaluation 4). A bare fluorescent lamp without louver (8,000 cd/m²) was reflected on the sample from an angle of 60° above in a dark room, and the black-looking state (dense blackness) of the entire surface when observed from the front was evaluated according to the following criteria.

A: Very good dense blackness.

B: Good dense blackness.

D: Slightly poor dense blackness.

E: Bad dense blackness.

TABLE 6

| | | Thickness of | Coating Solution for | | | Average | | | |
|---|---|---|---|---|---|---|---|---|---|
| Sample | Coating Solution for | HC Film | Low Refractive Index | Surface | Ra | Reflectance | | Dense | |
| No. | Light-Diffusing Layer | (μm) | Layer | Haze | (μm) | (%) | Reflection | Blackness | Remarks |
| 29 | HCL1 | 5 | Ln1 | 0.0 | 0.02 | 1.23 | B | A | Invention |
| 30 | HCL2 | 15 | Ln1 | 0.7 | 0.07 | 0.81 | A | A | Invention |
| 31 | HCL3 | 5 | Ln1 | 3.0 | 0.14 | 0.69 | A | B | Invention |
| 32 | HCL4 | 5 | Ln1 | 7.8 | 0.22 | 0.61 | A | B | Invention |
| 33 | HCL1 | 5 | Ln17 | 0.0 | 0.02 | 1.08 | B | A | Invention |
| 34 | HCL2 | 15 | Ln17 | 0.7 | 0.07 | 0.73 | A | A | Invention |
| 35 | HCL3 | 5 | Ln17 | 3.0 | 0.14 | 0.59 | A | B | Invention |
| 36 | HCL4 | 5 | Ln17 | 7.8 | 0.22 | 0.52 | A | B | Invention |

As seen from the results shown in the Table above, the antireflection film obtained according to the present invention is excellent in the performance of preventing reflection of an image due to reflection of outside light, free from white-reflective state (white blurring) of the entire surface due to surface scattering of the film, and assured of excellent dense blackness. Particularly, in Samples 30 and 34, both reflection-preventing performance and dense blackness are very excellent.

### Example 4

An antireflection film obtained by changing the film thickness of the support in the sample of Example 1 to 40μ, and an antireflection film using an optical PET film with an easy adhesion layer, COSMOSHINE A4300, produced by Toyobo Co., Ltd., were produced. After evaluations performed according to Example 1, almost the same results as in Example 1 were obtained.

### Example 5

An antireflection film was produced by adding a radical polymerizable silicone, RMS-033 (trade name, produced by Gelest), in an amount of 1 mass % based on the solid content of the low refractive index layer in Antireflection Film (19) of Example 1. Also, an antireflection film was produced by adding a hydroxyl group-containing silicone, Silaplane FM-4425 (trade name, produced by Chisso Corp.), was added in an amount of 1 mass % based on the solid content of the low refractive index layer in Antireflection Film (1) of Example 1. These antireflection films were evaluated, as a result, it was confirmed and found that the film has low reflection and excellent scratch resistance, the attachment of fingerprint is reduced and the wiping property of fingerprint mark is improved.

### Example 6

### [Mounting Evaluation of Antireflection Film]

The surface protective film of each of transmissive liquid crystal display devices of TN, IPS, VA, OCB and ECB modes was removed and the saponified antireflection film of Example 1 or 2 was laminated thereto. The thus-produced liquid crystal image display devices were evaluated, as a result, it was confirmed that a display device assured of low reflection and excellent in the visibility and scratch resistance can be produced.

### Example 7

The antireflection film samples of Examples 1 to 3 each was laminated to the glass plate on the surface of an organic EL display device through a pressure-sensitive adhesive, as a result, the reflection on the glass surface was suppressed and a display device with high visibility was obtained.

### Example 8

### [Production of Antireflection Film]

### [Preparation of Coating Solutions (Ln-26 to Ln-38) for Low Refractive Index Layer]

Respective components were mixed as shown in Table 7 and dissolved in MEK to prepare a coating solution for low refractive index layer having a solid content of 6%.

Each of these coating solutions (Ln-26 to Ln-38) was coated on Hardcoat Layer (HC-1) of Example I by a microgravure coating method under control to form a low refractive index layer having a thickness of 95 nm. In this way, Antireflection Film Samples 37 to 49 were produced. The same curing conditions as those for Antireflection Films 17 to 22 were employed except for setting the irradiation dose of UV light to 120 mJ/cm².

The evaluation results are shown in Table 8 below.

TABLE 7

| | Fluorine- | | | | | | | | | | |
|---|---|---|---|---|---|---|---|---|---|---|---|
| | Containing | | | Polyfunctional | | | | Particle | | | |
| Coating | Polymer | | | Compound | | Photoinitiator | | Amount Used | | | |
| Solution | | Amount | Fluorine | | Amount | | Amount | Liquid | Liquid | MEK- | |
| No. | Kind | Used | Content % | Kind | Used | Kind | Used | Dispersion B-1 | Dispersion B-2 | ST-L | Remarks |
| Ln26 | P-23 | 55.0 | 42.7 | — | — | IRG369 | 3.0 | 45 | 0 | 0 | Invention |
| Ln27 | P-13 | 80.0 | 56.8 | — | — | ″ | 3.0 | 20 | 0 | 0 | Invention |
| Ln28 | P-13 | 55.0 | 56.8 | — | — | ″ | 3.0 | 45 | 0 | 0 | Invention |
| Ln29 | P-13 | 50.0 | 56.8 | DPHA | 5.0 | ″ | 3.0 | 45 | 0 | 0 | Invention |
| Ln30 | P-13 | 45.0 | 56.8 | DPHA | 10.0 | ″ | 3.0 | 45 | 0 | 0 | Invention |
| Ln31 | P-13 | 45.0 | 56.8 | PETA | 10.0 | ″ | 3.0 | 45 | 0 | 0 | Invention |
| Ln32 | P-13 | 45.0 | 56.8 | V#1000 | 10.0 | ″ | 3.0 | 45 | 0 | 0 | Invention |
| Ln33 | P-13 | 45.0 | 56.8 | M-8030 | 10.0 | ″ | 3.0 | 45 | 0 | 0 | Invention |
| Ln34 | P-13 | 45.0 | 56.8 | EB-5129 | 10.0 | ″ | 3.0 | 45 | 0 | 0 | Invention |
| Ln35 | P-13 | 45.0 | 56.8 | UN-3320HS | 10.0 | ″ | 3.0 | 45 | 0 | 0 | Invention |
| Ln36 | P-14 | 45.0 | 51.2 | DPHA | 10.0 | ″ | 3.0 | 45 | 0 | 0 | Invention |
| Ln37 | P-18 | 45.0 | 51.2 | ″ | 10.0 | ″ | 3.0 | 45 | 0 | 0 | Invention |
| Ln38 | P-13 | 45.0 | 56.8 | ″ | 10.0 | ″ | 3.0 | 0 | 45 | 0 | Invention |

TABLE 8

| | Coating Solution | | | | | | |
|---|---|---|---|---|---|---|---|
| | for Low | | | | Marker | SW Scratch | |
| Sample | Refractive | Refractive Index of Low | Average | SW Scratch | Wiping | Resistance after | |
| No. | Index Layer | Refractive Index Layer | Reflectance (%) | Resistance | Durability | Exposure to Ozone | Remarks |
| 37 | Ln26 | 1.375 | 1.30 | B | 6 | B | Invention |
| 38 | Ln27 | 1.369 | 1.22 | B | 6 | C | Invention |
| 39 | Ln28 | 1.355 | 0.98 | C | 5 | C | Invention |
| 40 | Ln29 | 1.357 | 1.02 | B | 13 | B | Invention |
| 41 | Ln30 | 1.359 | 1.08 | A | 17 | A | Invention |
| 42 | Ln31 | 1.359 | 1.08 | A | 14 | B | Invention |
| 43 | Ln32 | 1.359 | 1.08 | A | 17 | A | Invention |
| 44 | Ln33 | 1.359 | 1.08 | A | 17 | A | Invention |
| 45 | Ln34 | 1.359 | 1.08 | A | 17 | A | Invention |
| 46 | Ln35 | 1.359 | 1.08 | A | 17 | A | Invention |
| 47 | Ln36 | 1.368 | 1.20 | A | 14 | A | Invention |
| 48 | Ln37 | 1.368 | 1.20 | A | 15 | A | Invention |
| 49 | Ln38 | 1.301 | 0.50 | A | 15 | A | Invention |

In Table 7, V#1000, M-8030, EB-5129, and UN-3320HS are shown as specific examples of the polyfunctional acrylate-based compounds having a (meth)acryloyl group include an esterification product of a polyol with a (meth)acrylic acid as above described.

As apparent from these Examples, when the component (C) of the present invention is further used in combination with the polymer having a high fluorine content and the hollow silica, not only the scratch resistance is improved but also the antifouling property is greatly enhanced.

This application is based on Japanese Patent application JP 2006-104093, filed Apr. 5, 2006, the entire content of which is hereby incorporated by reference, the same as if set forth at length.

What is claimed is:

1. An optical film comprising: a support; and a layer provided by applying a coating composition as an outermost layer, wherein the coating composition comprises the following (A) and (B), and the outermost layer has a refractive index of from 1.20 to 1.38:
(A) a fluorine-containing compound having a fluorine content of 40% by weight or more, and
(B) a particle having a particle size of from 5 to 120 nm.

2. The optical film of claim 1, wherein the compound (A) has a hydroxyl group.

3. The optical film of claim 1, wherein the compound (A) has a (meth)acrylate group.

4. The optical film of claim 1, wherein the fluorine content of the compound (A) is 45% by weight or more.

5. The optical film of claim 1, wherein at least one of the particle (B) has a particle size of from 40 to 100 nm.

6. The optical film of claim 1, wherein at least one of the particle (B) has a refractive index of from 1.15 to 1.30.

7. The optical film of claim 1, wherein at least one of the particle (B) has a void in an inside of the particle.

8. The optical film of claim 1, wherein the coating composition further comprises: (C) a compound having a (meth)acryloyl group.

9. The optical film of claim 8, wherein the compound (C) has a plurality of (meth)acryloyl groups within one molecule.

10. The optical film of claim 8, wherein the compound (C) has an organosiloxane structure.

11. The optical film of claim 8, wherein the compound (C) has fluorine.

12. The optical film of claim 1, wherein the coating composition further comprises: (D) a compound containing, within one molecule, a plurality of functional groups capable of forming a chemical bond with the compound (A).

13. The optical film of claim 12, wherein the compound (D) is aminoplasts.

14. The optical film of claim 1, wherein the coating composition further comprises: (E) a polymerization initiator.

15. The optical film of claim 14, wherein the polymerization initiator (E) has a molecular weight of 280 or more.

16. The optical film of claim 1, wherein the outermost layer has a refractive index of from 1.20 to 1.35.

17. The optical film of claim 1, which has a surface haze value of 10% or less.

18. A polarizing plate comprising two protective films and a polarizing film provided between the protective films, wherein at least one of the protective films is the optical film of claim 1.

19. An image display device comprising the optical film of claim 1.

20. An image display device comprising the polarizing plate of claim 18.
